(19) United States
(12) Patent Application Publication
(10) Pub. No.: US 2023/0206367 A1
(43) Pub. Date: Jun. 29, 2023

(54) SMART INTELLIGENT LIEN DISPUTE MEDIATION SYSTEM

(71) Applicant: Norman Reginald Nelson, Hollis, NY (US)

(72) Inventor: Norman Reginald Nelson, Hollis, NY (US)

(21) Appl. No.: 18/173,095

(22) Filed: Feb. 23, 2023

Related U.S. Application Data
(60) Provisional application No. 63/268,444, filed on Feb. 24, 2022.

(51) Int. Cl. G06Q 50/18

(52) U.S. Cl. CPC G06Q 50/182

(57) ABSTRACT

A system (100) and a method (200) for mediating lien disputes is described. The system (100) includes a processor (108) and a memory (110). The processor (108) is configured to retrieve a user data related to one or more types of lien cases from the memory (110). The processor (108) is configured to process the user data to identify and prioritize the one or more types of lien cases based on case factors. The processor (108) is configured to process the identified one or more types of lien cases as a training data to a machine learning model (112) to train the machine learning model (112). The training data includes inputs and one or more predictive outputs derived from the machine learning model's processing of the inputs. Thereafter, the machine learning model (112) is a smart intelligent system which determines each lien cases metric of resolution, collectability, and resolution time parameters.

### TECHNICAL FIELD

The invention relates to a system and a method relating to lien disputes, and more particularly relates to a method and a system for mediating lien disputes.

### BACKGROUND

The subject matter discussed in this background section should not be assumed to be prior art merely as a result of its mention herein. Similarly, any problems mentioned in this background section or associated with the subject matter of this background section should not be assumed to have been previously recognized in the prior art. The subject matter as disclosed in this background section merely represents different approaches related to mediating lien disputes, wherein such approaches related to mediating lien disputes, themselves may also correspond to implementations of the claimed technology and invention.

In the construction industry, when a job or a portion of a construction contract is completed, there are often disputes as to the final amount to be paid to the contractor. These disputes arise from a variety of causes. Sometimes a beneficiary of the construction contract asserts that the work called for under the contract was not done completely, or was not done in a professional and workman-like manner. Alternatively, the beneficiary of a construction contract (e.g., a building owner, a tenant in possession of premises, or a general contractor managing a construction project) may assert that there are a number of charge-backs, or credits, against the remaining outstanding balance of the construction contract, due to the contractor having left unfinished items or portions of the contract or having not done something properly, which requires engaging another firm to complete the work properly. In one example, beneficiaries of contracts may feel that they had been overcharged from the outset, but had no choice except to agree. Therefore, when the time comes to pay the remaining balance on a construction contract, they are simply looking for a discount which, in their minds, they feel is only “right.”

In another example, the construction contracts have certain ministerial or administrative conditions which need to be fulfilled, such as submission of hours worked for all employees of the contractor who worked on the job in order to qualify for certain payments. Often, documentation is sloppy, or incomplete, and beneficiaries of the construction contracts exploit this situation, either because they do not trust that all the hours were performed, or because they see an opening to shave some costs off of the construction project, and refuse to pay.

In another example, issues involving change orders often create disputes in construction contracts. The change orders are additional jobs, or a portion of a job, or item of work requested by the beneficiary of the construction contract after the construction contract has been signed, which exceeds the original scope of the construction contract. Sometimes there is a dispute as to whether a change order does exceed the original scope, or was intended to be included. Other times it is clear that the change order did exceed the original scope, but because the parties did not fully document the requested and agreed-upon change order, although the contractor did the work, the beneficiary refuses to pay. In either scenario, the contractor seeks to be paid a final balance inclusive of all change orders, the beneficiary refuses, and a dispute emerges as to what change orders were agreed to and what were the agreed-upon additional fees for performing the additional work.

Each of the above-described scenarios may result in a dispute. Further, when construction personnel end up in disputes with the contract beneficiaries, for example, general contractors, building owners, construction managers working for a long-term tenant at the site, etc., tempers may flare and emotions may run high. Tradesmen often take great pride in their work, and they are reticent to hear that there is some problem with work quality or completeness. Alternatively, building owners and others sometimes have a perception that contractors and tradesmen charge for work that's not done, or overcharge for the work that is done, and they are seeking to pay less. This posturing of stereotypes, assumptions, and emotions may often result in shouting matches and standoffs, and a substantial unpaid balance on the construction contract at the end of a job.

Prior art, for various aspects contained there within, relevant to this disclosure includes U.S. Pat. No. 2007/0055637 to Nelson, U.S. Pat. Publication No 2019/0102848 to Egenthal, and U.S. Pat. No. 6,330,551 to Brofman. In each of these prior art references, different systems and method are provided for resolving disputes based on constructional claims. The art still begs for an ideal solution of mediating lien disputes by constantly tracking, reviewing and updating status of each lien dispute.

Reference to '637, Nelson discloses a system and a method for mediating construction claims. The system comprises an interface module, a data processing module connected to the interface module, a case management module connected the interface module and the data processing module, and a database module, connected to each of the interface, data processing and case management modules. The data processing and case management modules have intelligence to assist a mediator in fully investigating the details and context of an unpaid construction claim, determining the actual causes of the lack of payment, determining the key parties and the available leverage that can be used to achieve resolution; and engaging the key parties and applying the leverage to reach settlement. However, unlike the subject matter of the disclosed invention, Nelson does not provide a medium to review incoming leads and convert them to contracts and therefore does not provide an ideal solution of mediating lien disputes by constantly tracking, reviewing and updating status of each lien dispute.

Reference to '848, Egenthal discloses a semi-automatic system and a method for crowd-source based mediation/litigation management. The semi-automatic conflict resolution management and communication system comprises a means for hosting a mediation and management application on a network cloud, a means for presenting a digital conflict input interface to at least one of a smart device and computer to a complainant, a means for receiving information of the complainant's identification data from the complainant, conflict incident data from the complainant, and defendant identification data from the complainant. The input information presents a case for an impending law suit. Further, Egenthal discloses that the system further comprises a means for receiving at least one of a time period or date from the complainant for automatically e-filing the case into a court's server by the application, a means for uploading the input information to the one or more cloud-networked servers, a means for providing notice of the impending law suit to the defendant and at least one of the time period or date of the e-filing, and digitally presenting an option to have the impending law suit mediated through the application, if the mediation option is selected by the defendant, then means for inputting response information by the defendant, means for uploading the response information into the one or more cloud-networked servers, means for presenting a counter-claim option against the complainant, means for providing a summary of the uploaded information, wherein mediators can electronically review at least the summary and complete facts of the case, means for selecting a case by a mediator, and means for communication between the mediator and the complainant and between the mediator and the defendant on their respective devices, to facilitate a settlement between parties. The communication between the complainant and defendant is not permitted through the application. However, unlike the subject matter of the disclosed invention, Egenthal does not provide a medium to review incoming leads and convert them to contracts, and does not allow sales team to track and manage their follow-ups, the add In-person and telephonic meetings and the post status updates.

Reference to '551, Brofman discloses a computer executable method for dispute resolution, operative to control a computer and stored on at least one computer readable medium. The method when executed comprises, receiving a plurality of demands from a first party for a claim, receiving a plurality of settlement offers from a second party for the claim, preventing disclosure of the demands to the second party, and preventing disclosure of the settlement offers to the first party, calculating differences between the demands and the settlement offers in rounds, each of the differences being calculated in a round using one demand and one settlement offer, the one demand and the one settlement offer being unequal in value, determining whether any of the differences fall within at least one predetermined criterion. In one case, if any of the differences fall within the at least one predetermined criterion, transmitting a message to the first party and the second party that the claim is resolved. In another case, if the differences do not fall within the at least one predetermined criterion, transmitting a message that the claim has not been resolved. However, unlike the subject matter of the disclosed invention, Brofman does not provide a medium to review incoming leads and convert them to contracts, and does not allow sales team to track and manage their follow-ups, the add In-person and telephonic meetings and the post status updates.

Conventionally, there are various remedies available to the contractor or subcontractor desiring to be paid on a disputed construction contract. One alternative is to file a construction lien. In a world of construction claims, there is a legal security device known as a “contractor's lien” or a “mechanic's or materialman's lien.” These devices give a contractor of, or a supplier of materials to, a construction project, a right to place a lien upon the real estate where the project is located to secure the payment of his claim. In most states, there is a time limit in which a mechanic's or materialman's lien must be filed, which is measured from the last day that work was performed under the contract and a second-time limit in which a filed lien must be foreclosed by judicial procedure. If either time limit is exceeded the lien right is lost. When a construction claim disputes emerge, if the parties reach a standoff, the contractor, having effectively no one to talk to on the other side, often sees little choice but to file a lien himself, or to hire an attorney to file it and then proceed to foreclose it.

Alternatively, there are situations where a contractor or subcontractor has given up the right to place a lien upon the property ab initio. In such cases, the building owner, the construction manager, or the general contractor has made it a condition of the contract that a lien release is filed by all subcontractors and suppliers, or, perhaps, the contractor has not given a lien release but does not meet the statutory requirements in his locale for filing a construction lien, such as, for example, required notice to an owner before beginning work, which is often a prerequisite to filing a mechanic's or materialman's lien in many jurisdictions. In this situation, if negotiations have reached a standoff, and no lines of communication remain open between the contractor and the beneficiary of the contract, an aggrieved contractor may forward his claim to a collection agency for collection, or may forward it to an attorney to commence a lawsuit.

Such conventional methods are often the least efficient to resolve an outstanding construction claim. Once an attorney takes legal action, such as the filing of a lawsuit or the filing of a construction lien, the other side generally goes into an aggressive defense mode. The same course of events usually occurs if an aggrieved contractor hires a collection agency to attempt to collect the claim. Because collection attorneys and collection agencies often work on contingency and are often jaded by the plethora of excuses and stories that they hear each day from debtors, they tend not to be receptive to compromise and tend to reject the idea that there may be some valid setoffs or charge-backs on the other side of the construction contract. Needless to say, meaningful negotiation towards resolution rarely occurs, and legal and/or collection fees and costs often consume a significant portion of any ultimate recovery.

Additionally, even if open to reaching a reasonable compromise, collection companies or other collection personnel tend to find themselves completely out of options once a construction lien has been filed, demand has been made for payment to the obligor on the construction contract and said obligor has refused payment. At such juncture, the conventional approach is simply to declare the matter at a standoff and recommend litigation.

Therefore, there is a need for a system and a method for investigation, mediation, and collection of mechanic's liens and large balance construction claims that gets the parties engaged in a dialogue towards resolution back together or musters necessary leverage to convince the parties, without taking legal action, that it is in everyone's best interest to resolve a construction claim, without the high costs, delay, and aggravation generally associated with legal action and/or collection agency activity.

### SUMMARY

In an aspect of the present disclosure, described herein is a system for mediating lien disputes. The system comprises a user device communicatively coupled to a server over a cloud. It can be noted that the user device is an end user interface to display information related to mediating lien disputes. Further, the server comprises at least one processor and a memory to store a set of instructions configuring the at least one processor to perform operations. The at least one processor is configured to retrieve user data related to one or more types of lien cases from the memory. Further, the at least one processor is configured to process the user data to identify and prioritize the one or more types of lien cases based at least on one or more case factors. Furthermore, the at least one processor is configured to process the identified one or more types of lien cases for training the machine learning model. The machine learning model is trained based at least on training data. The training data comprises one or more inputs and or more predictive outputs derived from the machine learning mode's processing of the one or more inputs. The machine learning model determines each lien case metric of resolution, collectability, and resolution time parameters, using the trained machine learning model. Further, each lien cases metric of resolution, collectability, and resolution time parameters are determined by the one or more predictive outputs derived by the machine learning model.

In an embodiment, the at least one processor is configured to determine a nature of lien dispute. The nature of lien dispute includes delay in payments, change orders, job not completed, job un-satisfaction, and project timeline extension. Further, the at least one processor is configured to calculate, percentage completion of job changes orders, based on the determination of the nature of lien dispute. Further, the at least one processor is configured to identify other subcontractor and their job completion. Moreover, the at least one processor is configured to identify incomplete punch list items for proposing timeline for completion of all items, wherein the incomplete punch list items are identified based on punch list items calculated by a mediation manager while performing pre-legal mediation project walkthrough.

In an embodiment, the one or more types of lien cases are identified and prioritized by performing a lien collectability assessment using a lien mediation data and a lien collectability data. The lien mediation data and the lien collectability data is based on lien mediation algorithm and the lien collectability algorithm. The lien collectability assessment categories each lien case's collectability into a high category, a medium category, and a low category.

In an embodiment, the one or more case factors include, a ratio of the amount pending to amount received, a percentage of completion of job, a number of jobs previously done with the same employer, years of association with the same employer, a project type, a property size, a property owner, a financial entity, end-user client, availability of documentation, and a real estate value of a property location. The one or more types of lien cases include mechanic's lien, public improvement liens, bond claims, and construction claims.

In an embodiment, the one or more types of lien cases include mechanic's lien, public improvement liens, bond claims, and construction claims. In an embodiment, the one or more inputs include, the total contract, change order, and retention balance of lien amount in relation to the percentage of project completion, end-user corporate client data rating, project type, and, contract start date and project termination date.

In an embodiment, the one or more predictive outputs include, calculation of total contract, progress payment received, lien percentage of the total contract, percentage of the project completed, type of construction lien or claim, contract start date, length (completion date), early termination date, current filed lien status, field lien date, discharge bond filed date, lien law demand filed to date, demand letter lien removal date, and lien foreclosure action filed date.

In an embodiment, the one or more predictive outputs are utilized by the machine learning model to create a case study, a knowledge base summary, predictable sequential steps, an artificial intelligence summary, a machine learning efficiencies summary, and a combinational optimization sequential step summary. The machine learning model implements predictable sequential varied non-obvious and unique sequential varied steps during lien resolution process. The machine learning model includes one or more machine learning algorithms based on at least one of support vector machine, K Means, Neural Networks, Decision Trees, Linear Regression, and Random Forest Regression. In an embodiment, the at least one processor is configured to perform project financing entity investigation by checking property details on at least one website.

In another aspect of the present disclosure, described herein is a method for mediating lien disputes. The method includes retrieving the user data related the to one or more lien cases. Further, the method includes processing the user data to identify and prioritize the one or more types of lien cases based on the one or more case factors. Furthermore, the method includes processing the identified the one or more types of lien cases as the training data to the machine learning model to train the machine learning model. The training model includes the one or more inputs and the one or more predictive outputs derived from the machine learning model's processing of the one or more inputs. The machine learning model determines each lien case metric of resolution, collectability, and resolution time parameters based on the training. Further, each lien cases metric of resolution, collectability, and resolution time parameters are determined by the one or more predictive outputs derived by the machine learning model.

In another aspect of the present invention, described herein is a non-transitory computer-readable medium including instructions for causing a processor (108) to perform functions including retrieving user data relating to one or more types of lien cases; processing the user data for identifying and prioritizing the one or more types of lien cases, based on one or more case factors; and processing the identified one or more types of lien cases for training machine learning model. The machine learning model is trained based at least on training data. The training data comprising one or more inputs and one or more predictive outputs derived from the machine learning model's processing of the one or more inputs, and determining each lien cases metric of resolution, collectability, and resolution time parameters, using the trained machine learning model.

To the accomplishment of the foregoing and related ends, one or more aspects comprise the features hereinafter fully described and particularly pointed out in the claims. The following description and the annexed drawings outlined in detail certain illustrative aspects and are indicative of but a few of the various ways in which the principles of the aspects may be employed. Other advantages and novel features will become apparent from the following detailed description when considered in conjunction with the drawings and the disclosed aspects are intended to include such aspects and their equivalents.

### BRIEF DESCRIPTION OF THE DRAWINGS

Further embodiments, details, advantages, and modifications of the present example embodiments will become apparent from the following detailed description of the embodiments, which is to be taken in conjunction with the accompanying drawings, wherein

While the specification concludes with claims particularly pointing out and distinctly claiming particular embodiments of the present disclosure, various embodiments of the present disclosure may be more readily understood and appreciated from the following descriptions of various embodiments of the present disclosure when read in conjunction with the accompanying drawings, in which:

FIG. 1 illustrates a system for mediating lien disputes, according to an embodiment of the present disclosure;

FIG. 2 illustrates a flow chart showing a method for mediating the lien disputes, according to an embodiment of the present disclosure;

FIG. 3A illustrates a detailed architecture for mediating the lien disputes, according to an embodiment of the present disclosure;

FIG. 3B illustrates high-level application modules for mediating the lien disputes, according to an embodiment of the present disclosure;

FIG. 3C illustrates an application design for mediating the lien disputes, according to an embodiment of the present disclosure;

FIGS. 4A-4D illustrate a detailed methodology for mediating the lien disputes, according to an embodiment of the present disclosure;

FIG. 5A illustrates an exemplary dashboard showing a process of a lead management application, according to an embodiment of the present disclosure;

FIG. 5B illustrates an exemplary dashboard showing a process followed by reports module of the lead management application, according to an embodiment of the present disclosure;

FIG. 5C illustrates an exemplary dashboard showing an export approval workflow of the reports module, according to an embodiment of the present disclosure;

FIG. 6A illustrates an exemplary dashboard showing a process of a case management application, according to an embodiment of the present disclosure;

FIG. 6B illustrates an exemplary dashboard showing a process followed by reports module of the case management application, according to an embodiment of the present disclosure;

FIGS. 7A-7W illustrate an exemplary model for mediating the lien disputes, according to an embodiment of the present disclosure;

FIG. 8A illustrates a login page for a case management system, according to an embodiment of the present disclosure;

FIG. 8B illustrates a mediation manager page showing user listing within the case management system, according to an embodiment of the present disclosure;

FIG. 8C illustrates the mediation manager page showing add users within the case management system, according to an embodiment of the present disclosure;

FIG. 8D illustrates the mediation manager page showing clients listing within the case management system, according to an embodiment of the present disclosure;

FIG. 8E illustrates the mediation manager page showing contract listing within the case management system, according to an embodiment of the present disclosure;

FIG. 8F illustrates the mediation manager page showing configuration page within the case management system, according to an embodiment of the present disclosure;

FIG. 8G illustrates the mediation manager page for configuring a document type within the case management system, according to an embodiment of the present disclosure;

FIG. 8H illustrates the mediation manager page showing case listing within the case management system, according to an embodiment of the present disclosure;

FIG. 9A illustrates a case dashboard within the case management system, according to an embodiment of the present disclosure;

FIG. 9B illustrates the case dashboard showing case documents within the case management system, according to an embodiment of the present disclosure;

FIG. 9C illustrates the case dashboard showing document identification within the case management system, according to an embodiment of the present disclosure;

FIG. 9D illustrates the case dashboard showing datapoint identification of the case documents within the case management system, according to an embodiment of the present disclosure;

FIG. 9E illustrates the case dashboard showing stakeholder identification of the case documents inside the case management system, according to an embodiment of the present disclosure;

FIG. 9F illustrates the case dashboard showing progress in a mediation step within the case management system, according to an embodiment of the present disclosure;

FIG. 9G illustrates a case overview within the case management system, according to an embodiment of the present disclosure;

FIG. 9H illustrates the job details page within the case management system, according to an embodiment of the present disclosure;

FIG. 9I illustrates a case activity page within the case management system, according to an embodiment of the present disclosure;

FIG. 9J illustrates the case activity page depicting a new call feature within the case management system, according to an embodiment of the present disclosure;

FIG. 9K illustrates the case activity page depicting a new email feature within the case management system, according to an embodiment of the present disclosure;

FIG. 9L illustrates the case activity page depicting a new video conferencing feature within the case management system, according to an embodiment of the present disclosure;

FIG. 9M illustrates the case analytics page within the case management system, according to an embodiment of the present disclosure;

FIG. 10A illustrates an overview of a lien collectability assessment using a lien collectability algorithm, according to an embodiment of the present disclosure;

FIG. 10B illustrates another overview of the lien collectability assessment shown using data processing example, according to an embodiment of the present disclosure;

FIG. 10C illustrates a flow diagram depicting the lien collectability assessment, according to an embodiment of the present disclosure;

FIG. 11A illustrates a web application showing a login page, according to an embodiment of the present disclosure;

FIG. 11B illustrates the web application showing an invalid login page, according to an embodiment of the present disclosure;

FIG. 11C illustrates the web application showing a lead creation page, according to an embodiment of the present disclosure;

FIG. 11D illustrates the web application showing a data import page, according to an embodiment of the present disclosure;

FIG. 11E illustrates the web application showing a data uploading page, according to an embodiment of the present disclosure;

FIG. 11F illustrates the web application showing a lead dashboard, according to an embodiment of the present disclosure;

FIG. 11G illustrates the web application showing a new email page, according to an embodiment of the present disclosure;

FIG. 11H illustrates the web application showing the lead dashboard with one or more options, according to an embodiment of the present disclosure;

FIG. 11I illustrates the web application showing a new lead filling page, according to an embodiment of the present disclosure;

FIGS. 12A and 12B illustrate an exemplary table showing mediation step analyses, according to an embodiment of the present disclosure;

FIG. 13A illustrates a web application page showing one or more categories for each lien's cases collectability, according to an embodiment of the present disclosure;

FIG. 13B illustrates the web application page showing a detailed view of the lien's cases, according to an embodiment of the present disclosure;

FIG. 14A illustrates contracts management wireframes showing contracts page, according to an embodiment of the present disclosure;

FIG. 14B illustrates the contracts management wireframes showing a new contract page, according to an embodiment of the present disclosure;

FIG. 14C illustrates the contracts management wireframes showing a fulfillment details page, according to an embodiment of the present disclosure;

FIG. 14D illustrates the contracts management wireframes showing an exemplary contract page, according to an embodiment of the present disclosure;

FIG. 14E illustrates the contracts management wireframes showing the fulfillment details page with an add comment section, according to an embodiment of the present disclosure;

FIG. 15A illustrates leads management wireframes showing leads page, according to an embodiment of the present disclosure;

FIG. 15B illustrates the leads management wireframes showing a new data import page, according to an embodiment of the present disclosure;

FIG. 15C illustrates the leads management wireframes showing a new lead page, according to an embodiment of the present disclosure;

FIG. 15D illustrates the leads management wireframes showing a follow-up page, according to an embodiment of the present disclosure;

FIG. 15E illustrates the leads management wireframes showing lead details page, according to an embodiment of the present disclosure;

FIG. 15F illustrates the leads management wireframes showing a new email page, according to an embodiment of the present disclosure; and

FIG. 15G illustrates the leads management wireframes showing another leads page, according to an embodiment of the present disclosure.

### DETAILED DESCRIPTION

Some embodiments of this disclosure, illustrating its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to the listed item or items.

It should also be noted that as used herein and in the appended claims, the singular forms “a,” “an,” and “the” include plural references unless the context dictates otherwise. Although any apparatus and method similar or equivalent to those described herein may be used in the practice or testing of embodiments of the present disclosure, the apparatus and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

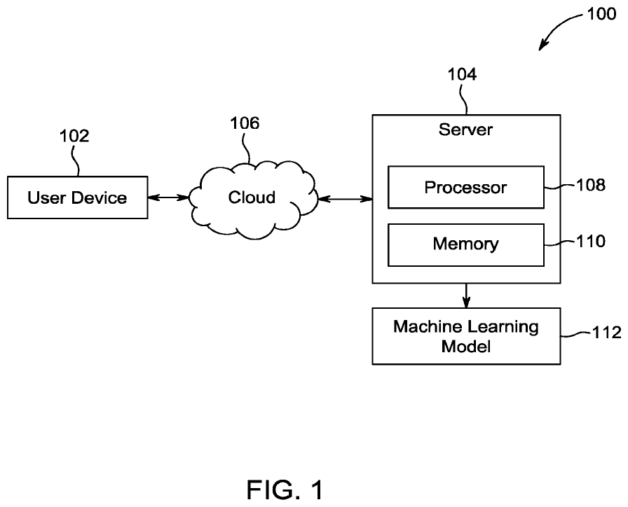

An example embodiment of the present disclosure and its potential advantages are understood by referring to FIGS. 1 through 15G of the drawings, like numerals being used for like and corresponding parts of the various drawings.

FIG. 1 illustrates a system 100 for mediating lien disputes, according to an embodiment. The system 100 may include a user device 102, a server 104, a cloud 106, at least one processor 108, a memory 110, and a machine learning model 112. The user device 102 is communicably coupled to the server 104 via the cloud 106. Further, the server 104 includes, but may not be limited to, the at least one processor 108 and the memory 110.

In one embodiment, the user device 102 includes, but may not limited to, a smartphone, a computer, a telephone, a desktop, a personal digital assistant (PDA), or a laptop. Further, the user device 102 may include input or output interfaces like a display screen, a touch screen, an antenna, and/or a microphone. In one example embodiment, the touch screen may correspond to at least one of a resistive touch screen, capacitive touch screen, or a thermal touch screen. In another example embodiment, the user device 102 may be integrated with a device processor (not shown) and an inbuilt device memory (not shown). The device processor includes suitable logic, circuitry, and/or interfaces that are operable to execute instructions stored in the inbuilt device memory to perform various functions. The device processor may execute an algorithm stored in the inbuilt device memory. The device processor may also be configured to decode and execute any instructions received from one or more other electronic devices or server(s).

In an embodiment, the user device 102 may be communicably coupled to the cloud 106. Further, the cloud 106 may be a wired and/or a wireless network. The cloud 106, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art. The cloud 106 may allow ubiquitous access to shared pools of configurable resources and higher-level services that may be rapidly provisioned with minimal management effort, often over the internet, and relies on sharing of resources to achieve coherence and economies of scale, like a public utility, while third-party clouds enable organizations to focus on their core businesses instead of expending resources on computer infrastructure and maintenance.

In an example embodiment, the cloud 106 corresponds to servers that are accessed over the internet, and the software and databases that run on those servers. In general, cloud servers are located in data centers all over the world. By using cloud computing, users and companies do not have to manage physical servers themselves or run a software application on their own machines. In another example, the cloud 106 enables users to access the same files and applications from almost any device, because computing and storage take place on servers in a data center, instead of locally on any user device. In yet another example, cloud computing is based on a technology called virtualization. The virtualization allows for the creation of a simulated, digital-only “virtual” computer that behaves as if it were a physical computer with its own hardware. Further, cloud computing includes main service models, such as, Software-as-a-Service (SaaS), Platform-as-a-Service (PaaS), Infrastructure-as-a-Service (IaaS), and Function-as-a-Service (FaaS). Also, there are different types of cloud deployments. The different types of cloud deployment include, but may not be limited to, private cloud, public cloud, hybrid cloud, and multi-cloud. In an example, the private cloud is a server, data center, or distributed network wholly dedicated to one organization. In an example, the public cloud is a service run by an external vendor that may include servers in one or multiple data centers. Unlike the private cloud, public clouds are shared by multiple organizations. Using virtual machines, individual servers may be shared by different companies, a situation that is called “multitenancy” because multiple tenants are renting server space within the same server. In an example, the hybrid cloud deployments combine public and private clouds, and may even include on-premises legacy servers. An organization may use their private cloud for some services and their public cloud for others, or they may use the public cloud as a backup for their private cloud. In an example, the multi-cloud is a type of cloud deployment that involves using multiple public clouds. In other words, the organization with the multi-cloud deployment rents virtual servers and services from several external vendors to continue the analogy used above, this is like leasing several adjacent plots of land from different landlords. The Multi-cloud deployments may also be hybrid cloud and vice versa.

It will be apparent to one skilled in the art that the above-mentioned components of the user device 102 and the cloud 106 have been provided for illustration purposes, without departing from the scope of the disclosure.

In an embodiment, the cloud 106 is communicably coupling the user device 102 and the server 104. It can be noted that the server 104 is a part of the system 100. The server 104 may handle each operation and task performed by the system 100. Further, the server 104 handles each operation and task performed by the at least one processor 108. In an exemplary embodiment, the server 104 includes other hardware and/or software components and/or devices such as, for example, applications, operating system, databases, communication ports, input devices, output devices, storage devices, processors, etc.

The server 104 includes the at least one processor 108 and the memory 110. The at least one processor 108 includes suitable logic, circuitry, and/or interfaces that are operable to execute instructions stored in the memory 110 to perform various functions. The at least one processor 108 may execute algorithms stored in the memory 110 to mediate lien disputes. The at least one processor 108 may also be configured to decode and execute any instructions received from one or more other electronic devices or server(s). The at least one processor 108 may include one or more general-purpose processors (e.g., INTEL® or Advanced Micro Devices® (AMD) microprocessors) and/or one or more special-purpose processors (e.g., digital signal processors or Xilinx® System On Chip (SOC) Field Programmable Gate Array (FPGA) processor). Further, the at least one processor 108 may be configured to execute one or more computer-readable program instructions, such as program instructions to carry out any of the functions described in the description.

The memory 110 may store a set of instructions and data. Further, the memory 110 includes one or more instructions that are executable by the at least one processor 108 to perform specific operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms (e.g. Microsoft Azure and Amazon Web Services, AWS), or other type of media/machine-readable medium suitable for storing electronic instructions. In an embodiment, the server 104 may include a database (not shown) to store instructions and data related to lien disputes. In an embodiment, the database provides storage location to all data and information required by the server 104. In an embodiment, the database may be at least one of hierarchical database, network database, relational database, object-oriented database, and the like. However, the database is not limited to above-mentioned databases.

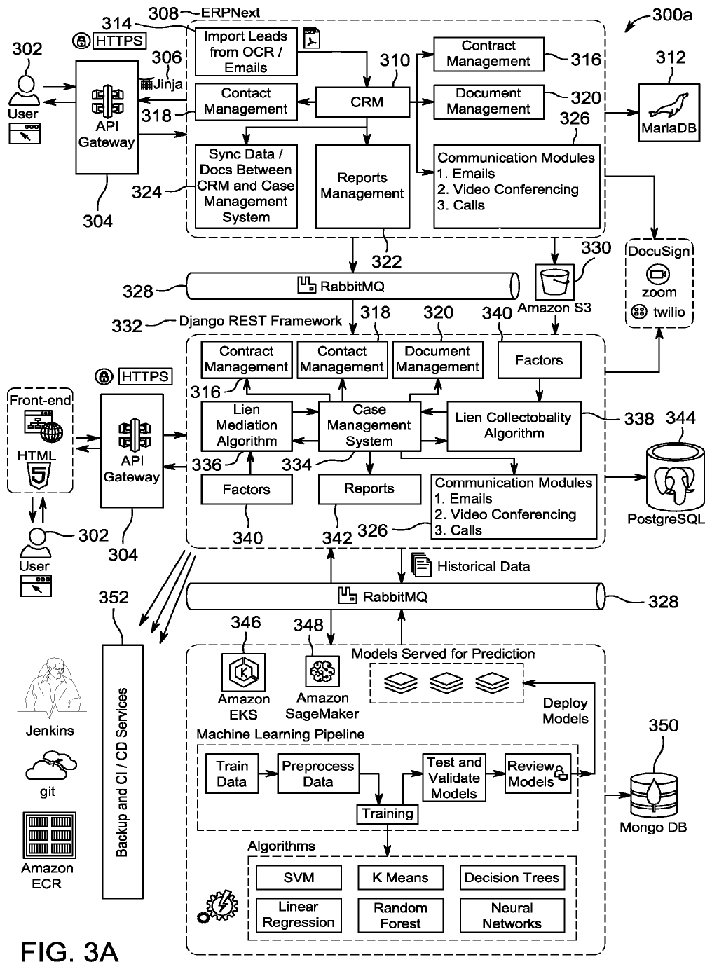

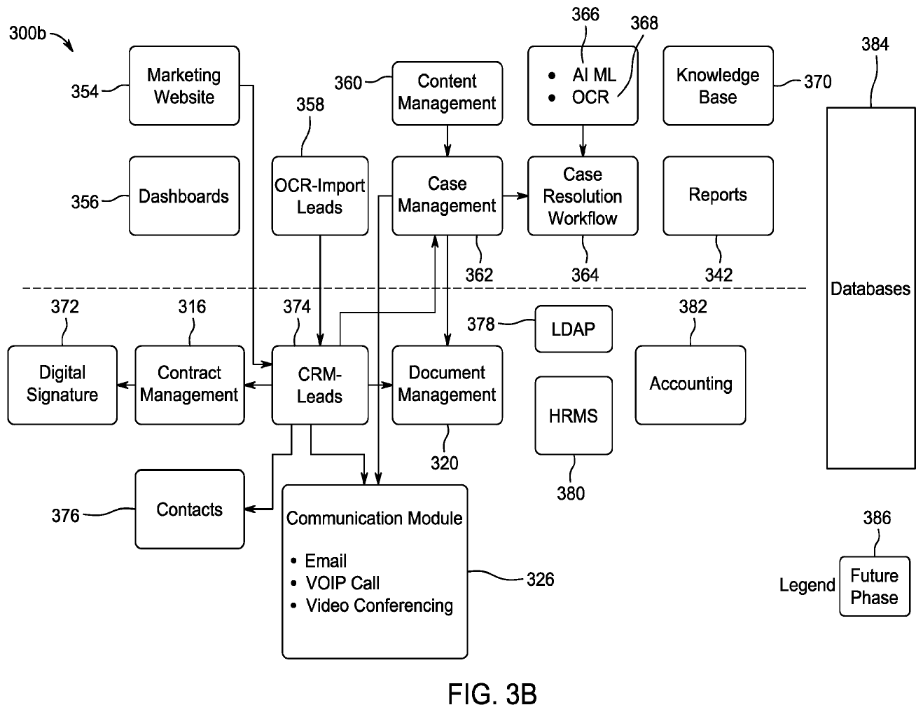

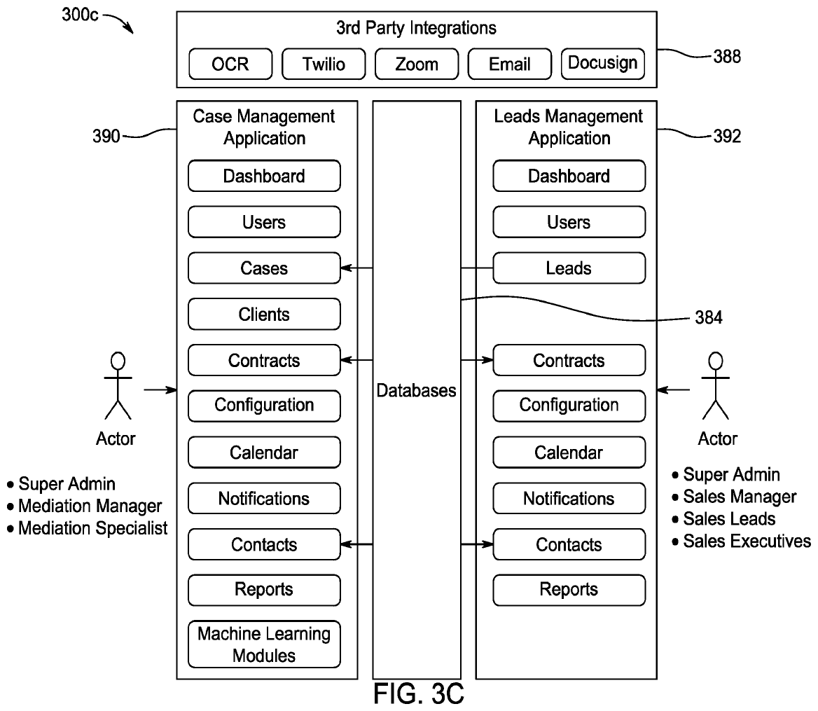

The server 104 has configured the at least one processor 108 via the memory 110 to perform operations. In an embodiment, the at least one processor 108 is configured to upload a user data to the memory 110. Further, the user data is related to one or more types of lien cases. The at least one processor 108 is configured to process the user data to identify and prioritize the one or more types of lien cases, based on one or more case factors. Further, the one or more types of lien cases are identified and prioritized by performing a lien collectability assessment using a lien mediating algorithm and a lien collectability algorithm, as shown in FIG. 3A. Furthermore, the lien collectability assessment categories each lien case's collectability into a high category, a medium category, and a low category. In an embodiment, the one or more case factors include, but may not be limited to, a ratio of the amount pending to amount received, a percentage of completion of job, a number of jobs previously done with the same employer, years of association with the same employer, a project type, a property size, a property owner, a financial entity, end-user client, availability of documentation, and a real estate value of a property location. In an embodiment, the one or more types of lien cases include, but may not be limited to, mechanic's lien, public improvement liens, bond claims, and construction claims.

Referring to FIG. 1, the server 104 is communicably coupled to the machine learning model 112. The server 104 has configured the at least one processor 108 to process the identified one or more types of lien cases as a training data to the machine learning model 112. The training data is used to train the machine learning model 112. Further, the training data includes one or more inputs and one or more predictive outputs derived from the machine learning model's 112 processing of the one or more inputs. In an embodiment, the one or more inputs include, but may not be limited to, total contract, change order, and retention balance of lien amount in relation to the percentage of project completion, end-user corporate client data rating, project type, and, contract start date and project termination date. In an embodiment, the one or more predictive outputs include, but may not be limited to, calculation of total contract, progress payment received, lien percentage of the total contract, percentage of the project completed, type of construction lien or claim, contract start date, length (completion date), early termination date, current filed lien status, field lien date, discharge bond filed date, lien law demand filed date, demand letter lien removal date, and lien foreclosure action filed date.

In one embodiment, the machine learning model 112 may determine each lien cases metric of the resolution, collectability, and resolution time parameters, based on the training. Further, each lien cases metric of resolution, collectability, and resolution time parameters are determined by the one or more predictive outputs derived by the machine learning model 112. In an embodiment of the present disclosure, each lien cases metric of resolution are determined based on one or more criteria. The one or more criteria include, but may not be limited to, emails to all shareholders and calls, lien bond and claim assessment and collectability investigation, end user communication blitz, building owner email and call for conceptual lien foreclosure strategy, conference room meetings with project related parties, conference call meeting with project related parties, pre-legal mediation project walkthrough, construction project onsite investigation & analysis, project financing entity investigation, end user lien item and progress payment investigation, diversion of funds investigation, diversion of funds investigation, final punch-list review, payment of performance bond submittal and strategies, past legal mediation strategies, final email demand with end user, CFO, director of construction, and owner representative, final payment close out documents, ratio of amount of pending lien balance to the amount received, % of completion of the construction project, % of completion of the construction project, type of construction project, property size, property owner, financing entity, end user client, availability and quality of lien documentation package, and real estate value of the property location. In an embodiment, the one or more predictive outputs are utilized by the machine learning model 112 to create a case study, a knowledge base summary, predictable sequential steps, an artificial intelligence summary, a machine learning efficiencies summary, and a combinational optimization sequential step summary. The machine learning model 112 may implement predictable sequential varied non-obvious and unique sequential varied steps during lien resolution process. In one embodiment, the machine learning model 112 may implement predictable sequential varied non-obvious and unique sequential varied steps during the lien resolution process. In another embodiment of the present disclosure, the machine learning model 112 determines lien case metric of resolution, collectability, and resolution time parameters tied into lien journey of the one or more inputs and the one or more predictive outputs sequencing. Further, the machine learning model 112 is trained using the training data related to uploads and downloads of the lien cases through a mediation specialist portals and dashboards, continuous CQC smart cyclical flow through a smart cycle databases, system & methods smart databases, machine learning smart databases, predictable algorithm smart databases, lien case communication blitz smart databases, lien input & output sequencing smart databases, predictable combinatorial optimization steps smart database, CQC lien collectability, algorithm CQC system modules, lien machine learning, IIC-CQC case study summary, lien machine learning knowledge base summary, lien case communication blitz smart database, final payment lien close out smart data base metric cyclical flow to mediation specialist & management portals and dashboards, mediation specialist lien collectability predictable algorithms work in progress CQC system functions, non-obvious and unique sequential varied steps smart cycle database, lien case metrics of live stream ticker data of smart cycle databases and client portals and dashboards on web platforms & cable outlets, IIC-CQC client efficiencies smart database uploads & downloads through the mediation specialist portals and dashboards. In an embodiment, the machine learning model 112 includes one or more machine learning algorithms. Further, the one or more machine learning algorithms may include, but may not be limited to, support vector machine, K Means, Neural Networks, Decision Trees, Linear Regression, and Random Forest Regression.

In an exemplary embodiment, described herein are systems, methods, and apparatuses for implementing machine learning model training and deployment with a rollback mechanism within a computing environment. In one embodiment, an exemplary system machine learning model 112 may include, means for: receiving training information item as input at the machine learning model 112, in which a training information item includes a multiple transactions, each of the transactions specifying a plurality of features upon which to make a prediction and a label representing a correct answer for the plurality of features according to each respective transaction; specifying a model to be trained by the machine learning model 112 using the training information item, in which the model includes a plurality of algorithms and source code; generating a new predictive engine variant by training the model to algorithmically arrive upon the label representing the correct answer as provided with the training information item based on the plurality of features for each of the multiple transactions; versioning the new predictive engine variant based at least on the time the new predictive engine variant was generated a version of the source code utilized within the model and the training information received as input; deploying the new predictive engine variant into a production environment to replace a prior version of the predictive engine variant; and rolling back the new predictive engine variant from the production environment to a specified version which is less than a version of the new predictive engine variant.

According to another exemplary embodiment, there are means for building and deploying machine learning models for predictive analytics. Certain embodiments relate to creating, evaluating, and tuning predictive engines in production. Other embodiments relate to replaying the performance of predictive engines for predictive engine design and analysis. Such predictive engines may include one or more predictive models which are trained on collected data for predicting future user behaviors, future events, or other desired information. Such prediction results are useful in various business settings such as in marketing and sales. Disclosed embodiments enable customization of engine components targeted for specific business needs, allow for systematic evaluation and tuning of multiple engines or engine variants, and provide means by which to replay engine performances during or after the evaluation and tuning processes. Additional embodiments enable the rollback mechanism, for instance to a specific previously known version or the prior version available within a model repository. Such the rollback mechanism is beneficial when a newer version of a trained model is not performing as expected or yields sub-par results in comparison to a previously known and utilized version of the trained model.

In an embodiment, the user data is related to each lien claimant. In general, a lien claimant corresponds to a person having a lien claim, other than any Noteholder or trustee in respect to any Noteholder claim. In an embodiment, the at least one at least one processor 108 is configured to determine a nature of lien dispute. Further, the nature of the lien dispute includes, but may not be limited to, delay in payments, change orders, job not completed, job un-satisfaction, and project timeline extension. In an embodiment, the at least one processor 108 is configured to calculate, percentage completion of job changes order, based on the determination of the nature of lien dispute. In one embodiment, the at least one processor 108 is configured to identify, other subcontractors and their job completion. Further, the at least one processor 108 is configured to identify punch list items. In another embodiment, the at least one processor 108 is configured to perform, project financial entity investigation, by checking property details on at least one website.

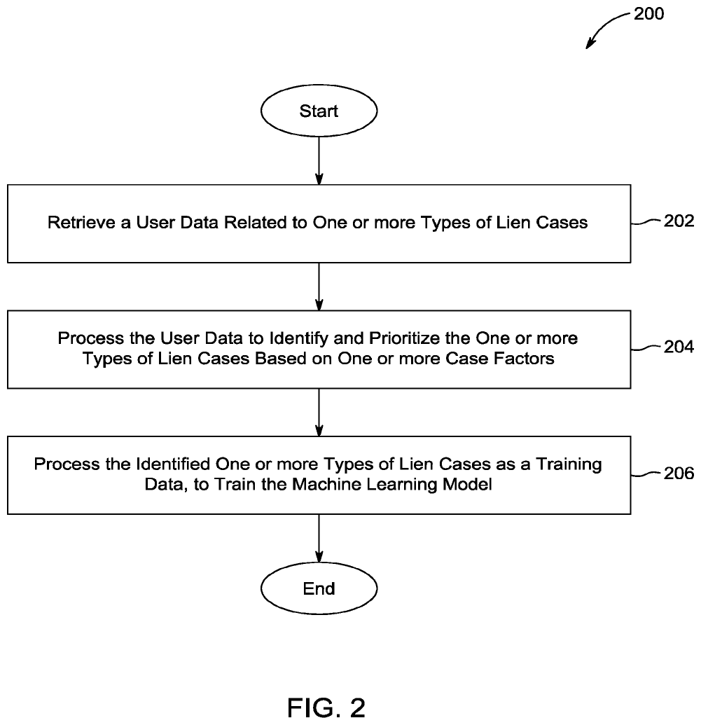

FIG. 2 illustrates a flowchart showing a method 200 for mediating the lien disputes, according to an embodiment of the present disclosure an example embodiment. FIG. 2 is described in conjunction with FIG. 1. At first, a user data related to the one or more types of lien cases may be retrieved, at step 202. For example, for user Alex, data retrieved is that Alex has a lien of $1,00,000 and a lien of $2,00,000 with a liability of $80,000. Successively, the retrieved user data is processed, by the at least one processor 108, to identify and prioritize the one or more types of lien cases, based on the one or more case factors, at step 204. For example, for user Alex, the lien of $1,00,000 is identified and prioritized. Successively, the identified one or more types of lien cases are processed, by the at least one processor 108, as the training data, to the machine learning model 112, at step 206. For example, for user Alex, the lien of $1,00,000 is sent to the machine learning model 112 as training data. The training data is used to train the machine learning model 112. The training data includes the one or more inputs and one or more predictive outputs derived from the machine learning model's 112 processing of the one or more inputs. The machine learning model 112 determines each lien cases metric of resolution, collectability, and resolution time parameters, based on the training. Further, each lien cases metric of resolution, collectability, and resolution time parameters are determined by the one or more predictive outputs derived by the machine learning model 112.

FIG. 3A illustrates a detailed architecture 300a for mediating the lien disputes, according to an embodiment of the present disclosure. The detailed architecture 300a may include, but not limited to, a user 302, an application programming (API) gateway 304, a web template engine (Jinja) 306, an ERPnext (Enterprise Resource Planning) 308, a customer relationship management (CRM) 310, and a MariaDB (database) 312. In an embodiment of the present disclosure, the user 302 may be any individual or any person.

The detailed architecture 300a includes the web template engine 306. In one example, the web template engine 306 used in the detailed architecture 300a is Jinja. It can be noted that Jinja is the web template engine used for Python programming language, corresponds to a text-based template language, and thus, may use to generate any markup, as well as, source code. In another example, Jinja template engine allows customization of tags, filters, and tests.

In one example, the ERPnext 308 is a free and open-source integrated Enterprise Resource Planning (ERP) software. Further, the ERPnext 308 is built on the MariaDB 312 database system using Frappe, a Python-based server-side framework. It can be noted that the ERPnext is a generic ERP software used by manufacturers, distributors, and services companies. Further, the ERPnext 308 includes modules like accounting, CRM, sales, purchasing, website, e-commerce, point of sale, manufacturing, warehouse, project management, inventory, services, and the like. Furthermore, the ERPnext 308 includes domain-specific modules, for example, schools, healthcare, agriculture, and non-profit.

Referring to FIG. 3A, the ERPnext 308 includes the customer relationship management (CRM) 310. In one example, customer relationship management (CRM) 310 is a technology for managing company's relationships and interactions with customers and potential customers. Further, the CRM 310 facilitates companies to stay connected to customers, streamline processes, and improve profitability. Further, the CRM 310 is a tool that helps with contact management, sales management, productivity, and the like. It can be noted that CRM solution focuses on organization's relationships with individual people, including, customers, service users, colleagues, or suppliers, throughout the lifecycle, further including, new customers, winning their business, and providing support and additional services throughout the relationship. In an embodiment, the customer relationship management (CRM) 310 performs various functions. Further, the various functions include, but may not be limited to, import leads from OCR/Emails 314, a contract management 316, a contact management 318, a document management 320, a reports management 322, a sync data/docs between the customer relationship management and a case management system 324, and communication modules 326. In an embodiment, the communication modules 326 include, but may not be limited to, emails, video conferencing, and calls. In an embodiment, zoom is the part of the communication modules 326. In one example, zoom provides video telephony and online chat services through a cloud-based peer-to-peer software platform and is used for teleconferencing, telecommuting, distance education, and social relations.

Referring to FIG. 3A, the detailed architecture 300a includes MariaDB 312. In one example, MariaDB 312 is an open-source relational database management system (DBMS) that is a compatible drop-in replacement for the widely used MySQL database technology. It can be noted that MariaDB is based on SQL and supports ACID-style data processing with atomicity, consistency, isolation, and durability for transactions.

The customer relationship management (CRM) 310 is communicably connected to DocuSign, Twilio, and Zoom. The DocuSign is a part of the communication modules 324. In one example, DocuSign allows organizations to manage electronic agreements. Further, DocuSign is a part of DocuSign Agreement Cloud, offers eSignature i.e., a way to sign electronically on different devices.

The customer relationship management (CRM) 310 is communicably connected to Twilio. Twilio is part of the communication modules 326. In general, Twilio allows software developers to programmatically make and receive phone calls, send and receive text messages, and perform other communication functions through web services application programming interfaces (APIs).

Referring to FIG. 3A, the detailed architecture 300a may comprise a RabbitMQ 328, an Amazon S3 330, and a Django REST Framework 332. Further, the ERPNext 308 is communicably coupled to the Django REST Framework 332 through the RabbitMQ 328 and the Amazon S3 330. In one example, the RabbitMQ 328 is an open source message-broker software, corresponds to a message-oriented middleware, implements Advanced Message Queuing Protocol (AMQP) along with a plug-in architecture to support Streaming Text Oriented Messaging Protocol (SOMP), MQ Telemetry Transport (MQTT), and other protocols. In another example, the Amazon S3 330 is an object storage built to store and retrieve any amount of data from anywhere.

As shown in the detailed architecture, the Django REST Framework 332 is communicably coupled to the user 302, a front-end, the API Gateway 304. The Django REST Framework 332 includes a case management system 334. The case management system 334 performs a plurality of functions. The plurality of functions may include functions related to, the contract management 316, the contact management 318, the document management 320, the communication modules 326. The case management system 334 is configured to perform the lien mediation algorithm 336 and the lien collectability algorithm 338 using one or more case factors 340. The case management system 334 is configured to generate reports 342. In one embodiment, the Django REST Framework 332 is communicably coupled to PostgreSQL 344. In one example, the PostgreSQL 344 is an advanced, enterprise-class open-source relational database that supports both SQL (relational) and JSON (non-relational) querying. It can be noted that the PostgreSQL 344 is used as a primary data store or data warehouse for many web, mobile, geospatial, and analytics applications.

The Django REST Framework 332 is communicably coupled to a machine learning model 112 through the RabbitMQ 328. The machine learning model 112 receives historical data from the case management system 334 through the RabbitMQ 328. The machine learning model 112 derives one or more models served for prediction. The machine learning model 112 includes, but may not be limited to, Amazon Elastic Kubernetes Service (EKS) 346 and Amazon SageMaker 348. In one example, the Amazon EKS 346 deploy, manage, and scale containerized applications using Kubernetes on Amazon Web Services. Further, the Amazon EKS 346 is a managed service that helps, making it easier to run Kubernetes on Amazon Web Service (AWS). Through the Amazon EKS 346, organizations may run Kubernetes without installing and operating a Kubernetes control plan or worker nodes. The Amazon EKS 346 is a managed containers-as-a-service (CaaS), that drastically simplifies Kubernetes deployment on AWS. In one example, Kubernetes is an open-source system, that allows organizations to deploy and manage containerized applications like platforms as service (PaaS), batch processing workers, and microservices in the cloud at scale. Further, through an abstraction layer created on top of a group of hosts, development teams may let Kubernetes manage a host of functions, including load balancing, monitoring and controlling resource consumption by team or application, limiting resource consumption, and leveraging additional resources from new hosts added to a cluster, and other workflows. Therefore, through the Amazon EKS 346, organizations using AWS may receive full functions of Kubernetes without having to install or manage Kubernetes itself.

In one example, the Amazon SageMaker 348 facilitates data scientists and developers to prepare, built, train, and deploy high-quality machine learning models quickly by bringing together a broad set of capabilities purpose-built for machine learning. In one embodiment, Amazon SageMaker 348 includes a machine learning pipeline. The machine learning pipeline includes one or more steps. Further, the one or more steps include, but may not be limited to, train data, preprocess data, training, test and validate models, review models, and deploy models to one or more models served for prediction. Further, the historical data is trained using one or more machine learning algorithms include, but may not limited to, Support Vector Machine (SVM), K Means, Decision Tress, Linear Regression, Random Forest, and Neural Networks. The machine learning model 112 is communicably coupled to a Mongo DB 350. The MongoDB 350 is a source-available cross-platform document-oriented database program.

In an embodiment, the case management system 334 is connected to backup and continuous integration/continuous delivery (CI/CD) services 352. The backup and the CI/CD services 352 include, but may not be limited to, Jenkins, Global information Tracker (Git), and Amazon Elastic Container Registry (ECR). It can be noted that Jenkins is an open-source automation tool written in Java with plugins built for continuous integration purposes. Further, Jenkins is used to building and test software projects, continuously making it easier for developers to integrate changes to project. It can also be noted that Git is a free and open-source distributed version control system designed to handle everything from small to very large projects with speed and efficiency. In one example, the Amazon ECR is a fully-managed Docker container registry that makes it easy for developers to store, manage, and deploy Docker container images. Further, the Amazon ECR is integrated with Amazon Elastic Container Service (ECS), simplifying your development to production workflow.

FIG. 3B illustrates high-level application modules 300b for mediating the lien disputes, according to an embodiment. The high-level application modules 300b include, but may not be limited to, a marketing website 354, dashboards 356, Optical Character Recognition (OCR)-import leads 358, a content management 360, a case management 362, a case resolution workflow 364, an Artificial Intelligence and Machine Learning (AI/ML) 366 and an OCR 368, the reports 342, a knowledge base 370, a digital signature 372, the contract management 316, a customer relationship management (CRM)-leads 374, contacts 376, the communication modules 326, the document management 320, Light Weight Directory Access Protocol (LDAP) 378, Human Resource Management System (HRMS) 380, accounting 382, databases 384, and future phase 386. In one embodiment, the marketing websites 352 are linked to the CRM-leads 374. Further, the OCR-import leads 356 are also linked to the CRM leads 374. Furthermore, the CRM leads 374 include contacts 376. The CRM leads 374 are connected to the communication modules 326. In an embodiment, the communication modules 326 include email, Voice Over Internet Protocol (VOIP) call, video conferencing, and the like. The CRM leads 374 facilitate the case management 362, the contract management 316, and the document management 320. The contract management 316 includes the digital signature 370. The case management 362 facilitates the content management 360 and the case resolution workflow 364. The case resolution workflow 364 is performed using the AI/ML 364 and the OCR 366.

FIG. 3C illustrates an application design 300c for mediating the lien disputes, according to an embodiment of the present disclosure. The application design 300c includes, but may not be limited to, third party integrations 388, case management application 390, leads management application 392. The case management application 392 includes dashboard, users, cases, clients, contracts, configuration, calendar, notifications, contacts, reports, machine learning modules, and the like. The leads management application 392 includes dashboard, users, leads, contracts, configuration, calendar, notifications, contacts, reports, and the like. The case management application 390 and the leads management application 392 are communicably coupled to the databases 384. In one embodiment, the case management application 390 is managed and operated by super admin, mediation manager, mediation specialist, and the like. Further, the leads management application 392 is managed and operated by super admin, sales manager, sales leads, sales executive, and the like. In an embodiment, the third party integrations 388 include OCR, Twilio, Zoom, email, and Docusign. In one example, Twilio allows software developers to programmatically make and receive phone calls, send and receive text messages, and, perform other communication functions using its web service Application Programming Interfaces (APIs). In another example, DocuSign allows organizations to manage electronic agreements.

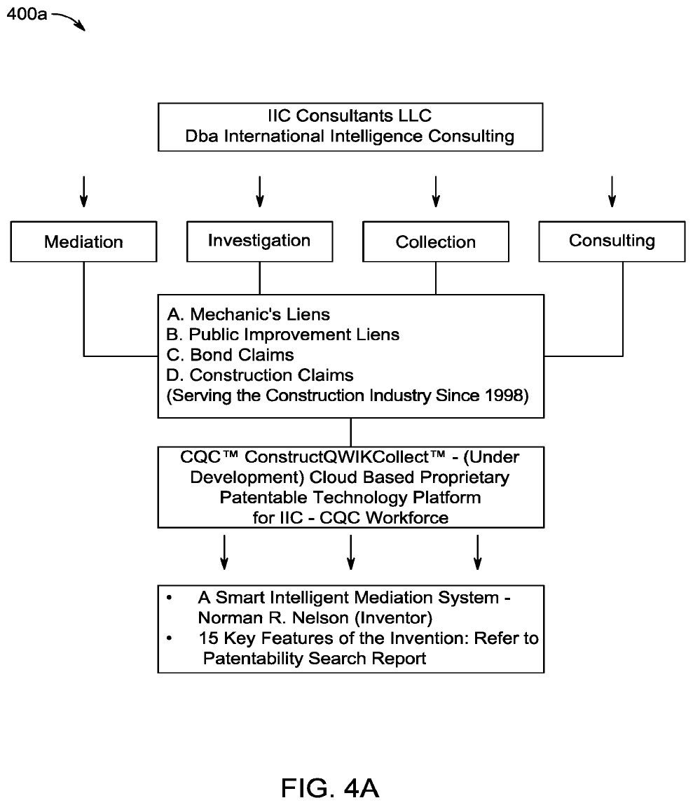

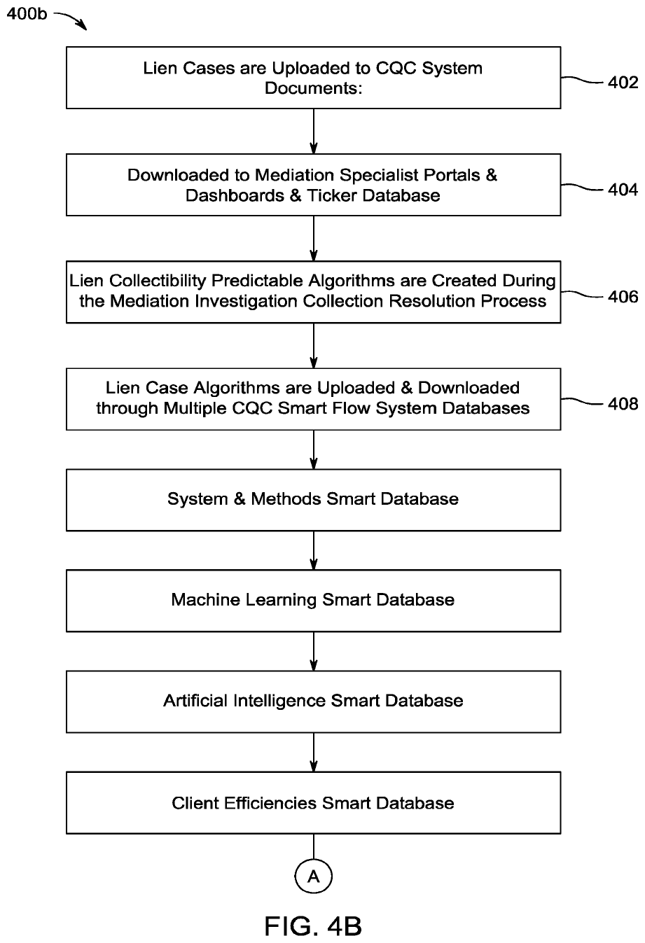

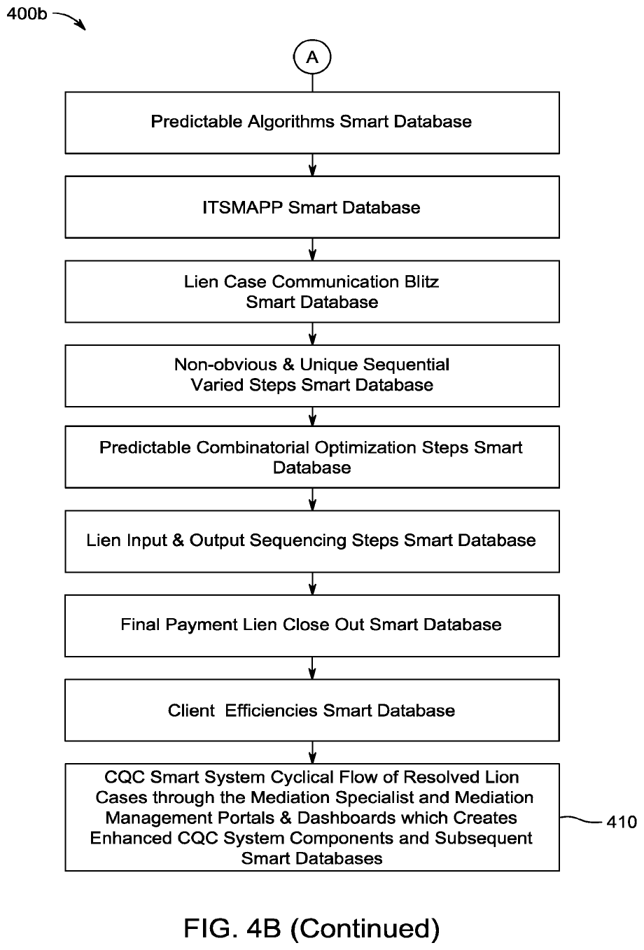

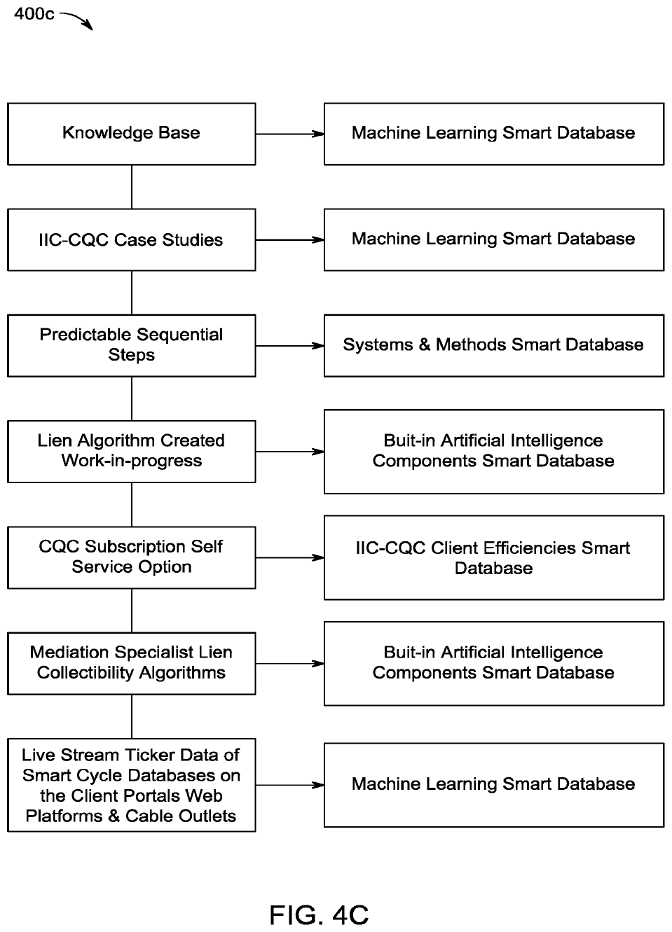

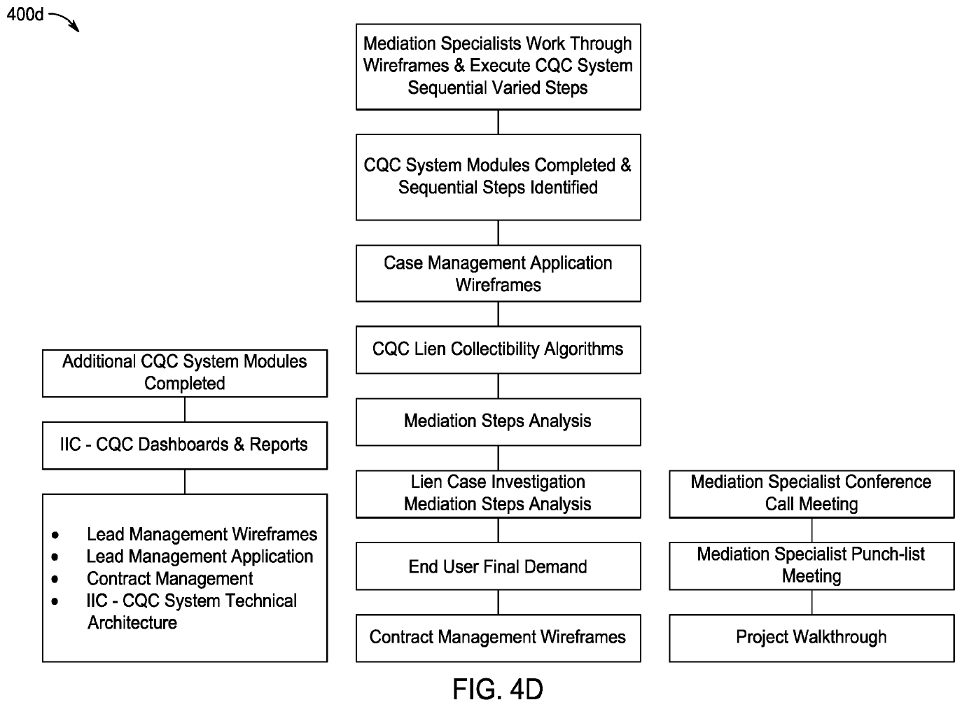

FIGS. 4A-4D illustrate a detailed methodology 400a for mediating the lien disputes, according to an embodiment. Referring to FIG. 4A, the lien disputes are resolved by performing mediation, investigation, collection, and consulting, on the one or more types of lien cases. In exemplary embodiments, a construction claim may be successfully investigated and mediated by using a variety of creative and non-obvious steps to bring about resolution. Such creative techniques include fully investigating the details and context of the construction claim; determining the actual causes for the lack of payment; determining the key parties and the available leverage that may be used to achieve resolution; and engaging the key parties and applying that leverage to reach settlement.

In exemplary embodiments, some or all of the following actions may be taken in the successful investigation and mediation of the construction claim according to the above-described process. For ease of illustration, in what follows a scenario where the construction claim made by a subcontractor is sought to be mediated and collected shall most often be described. It is understood that the methods and systems of the present invention may equally apply to claims by a general contractor against a contract beneficiary, claims by a second or third tier subcontractor, or claims made by any other party with a valid construction claim against any other party responsible for payment, directly or indirectly. In general, the term “construction claim” will be used throughout this description. Such term is intended to be general, and to encompass all types of such claims, including both those that are associated with mechanic's, materialman's or other liens, and also those not secured by a lien. For ease of illustration, the titles of key parties to a construction claim mediation are sometimes capitalized, so that they may be easily identified in example scenarios. It can be noted that the term subcontractor is understood to include subcontractors of the general contractor or of any other subcontractor, thus including subcontractors of any and all tiers. For example, when a strategy for a case where the lien is involved is described, it is understood that the strategy may equally apply to the exemplary lien discussed or any other type of construction lien, and a particular type of lien (e.g., “mechanic's”, “materialman's”, “public project lien”, etc.) described is exemplary and for illustrative purposes, and not limiting.

It can be noted that the following described creative mediation actions, techniques and strategies are in the nature of colors on a palette, or arrows in a quiver, and it is the context and details of given case that drives which actions may be taken, in what sequence and with what emphasis. Ultimately it is a mediator who is the artist or the archer that judiciously uses the available tools. Thus, the methods of the present invention will also be illustrated below by various case studies and real-world examples to illustrate how such tools and techniques may be combined and in what sequence. Additionally, systems methods according to the present invention may be used as the basis of a construction claim mediation business, either in a stand-alone context or in a franchisor-franchisee structure. Additionally, the methods of the present invention may be performed with the guidance and assistance of a computer-based system, which may for example, encode the intelligence of the various construction mediation tools and techniques of the present invention and act as an electronic mentor, supervisor, guide and/or teacher to a user.

In an exemplary embodiment, the following techniques may, for example, be used, inter alia, 1) Contacting the Director of Facilities for a major tenant buildout; 2) Contacting by telephone and facsimile the managing agent, property manager, or corporate attorney for a building owner in which the Subcontractor has filed a mechanics lien; 3) Filing a complaint with the key executives of a major corporate client of the General Contractor. Simultaneous letters to chief financial officer (CFO), chief operating officer (COO), Controller and Director of Construction, as well as follow-up telephone calls and facsimile correspondence; 4) Letters and telephone calls to the financing entity of the construction project, i.e., where the progress payments originate and are sent to the General Contractor. A forward request for a direct or two-party check, all relevant lienor claim backup sent with such a written demand; 5) For state, municipal and city projects where there is a payment and performance bond, submission of proof of claim backup to state and municipal agency, as well as the attorney and Senior Claim Analyst of the surety company and the General Contractor's key executives, all letters followed with follow-up telephone calls; 6) Simultaneously contacting the General Construction Subcontractors simultaneously by written and telephone demand and submitting uncompleted punch list to arrange an onsite mediation meeting or walk through at the construction project site; 7) Requesting a two-party check or direct check from the General Contractor's client, submittal of backup documentation to the key executives, CFO, President, Controller, Construction Manager, etc., and substantiating that the Subcontractor's line items of work are completed; 8) Directly contacting the General Contractor's Subcontractors who have not completed their line items of work, getting a written commitment from each Subcontractor that they will receive payment upon completion of their work. Facsimiles and follow up calls simultaneously sent to the key executives; and 9) Contacting Director of Construction and the financing entity for the construction project. Submitting of change orders with supporting documentation to Director of Construction, as well as Project Executives with the General Contractor. Arranging meeting onsite at the project location, with General Contractor's Executives, Owners Representatives, Director of Construction. Further, prior to the meeting having the Subcontractor (i.e., the mediation client) recreate a time line and quantify specifically as to the dates and individuals that were present when they were instructed to execute the change order work. Further, placing a quantitative measure or value on each change order. Consulting Subcontractor's contract to investigate how to change order-related work is handled.

In another exemplary embodiment, when the mechanic's lien is filed against a company during a major tenant buildout, the mediator may contact by telephone and facsimile the Director of Construction and facilities, the CFO, the corporate office key executive, the owner of the property, the Property Manager, the Owner's Attorney, and any other related parties. Bringing a copy of supporting documentation, the lien, and a demand letter directed to the owner's representative or attorney may catalyze a forward movement of a mediation or resolution process.

In another exemplary embodiment, when a Subcontractor is owed money by a General Contractor who has a relationship with a major corporate client, an effective approach to the collection and mediation effort in exemplary embodiments of the present invention may be to determine the key decision makers at that client and file a presidential complaint with copy to the CFO, Director of Construction, Controller, Board of Directors, etc. This may, for example, be executed simultaneously, in written form and via follow-up calls to all key players, in a consistent and methodical manner.

Additionally, it is often useful in the collection, investigation and mediation of mechanic's liens and construction claims to strategically reach out to the financing entity, and the individual there that authorized the financing of the project in question. In implementing such a strategy all the relevant documentation, including a copy of the lien, may, for example, be sent to the individual at the financing entity. Because the General Contractor may receive progress payments from a client that has in turn received financing either from a bank, private investment group, state or municipal agency, a letter with all the relevant documentation, and a series of telephone calls to the key executives that financed the construction project may, for example, facilitate a meeting between the Subcontractor and the General Contractor to try to resolve the lien or construction claim dispute through mediation according to exemplary embodiments of the present invention.

In one exemplary embodiment, when the Subcontractor is working for a General Contractor who is working for a city, state, federal agency, bank, college, hospital or other public or quasi-public entity, there is often a payment and performance bond associated with the project. In such contexts this information may be obtained under the Freedom of Information Act by written request to the appropriate agency or end user. A subsequent written demand with lien or claim back-up data may, for example, be submitted (with or without a proof of claim affidavit submittal form) to the Chief General Counsel and Senior Claim Analyst of the surety company. Such a written demand may be coupled with simultaneous telephone calls to the appropriate parties.

In another exemplary embodiment, when the Subcontractor is working for a General Contractor who is working for a major corporate client. It is assumed that the Subcontractor was told by the General Contractor's Project Manager to do work that falls under change orders, and the Subcontractor was verbally advised that payment would be made for this extra work. The Subcontractor completed the work called out under the change orders; it is assumed for illustration purposes that there were three change orders that totaled $100,000 over the principal contract amount. In such a scenario, for example, the (major corporate) client's Director of Construction and the financing entity to the construction project may be contacted, and the change orders may be submitted with supporting documentation of the completed work to both the corporation's Director of Construction and the Project Executives with the General Contractor. Further, a meeting may be arranged on site, at the project location, with the General Contractor, Project Executives, Owner's Representative(s), and Director of Construction. Thus, prior to this meeting, for example, the Subcontractor (i.e., the lien claimant) may recreate a timeline and quantify specifically, as to dates and the individuals that were present, when the change orders were requested and agreed upon.

In another exemplary embodiment, assume the Subcontractor works for a General Contractor who has been hired by an end user. The Subcontractor has filed the mechanics lien, and there is no movement with regard to payment. The General Contractor is contacted and responds “we have not gotten payment from our client (i.e., the end user) because one of the other Subcontractors has not completed their work.” In such a scenario the General Contractor may be contacted by fax and this may be followed up with a visit to the end user's Director of Construction (i.e., the General Contractor's client) at the project location. Then, for example, demand for payment may be made to the end user via a formal request with supporting backup, and a two-party or direct check from the end user may be solicited. This may alert the key executives, the CFO, etc. of the end user that a completed line item or items of work has not been paid and that a lien has been filed on their property. Although the lien may remain there until bonded or satisfied, this strategy may trigger a chain of events in the mediation process. The lien claims documents and demand for payment, in conjunction with follow up calls to the key executives with the end user, may force the General Contractor, the Project Managers and the Project Executives to sit down and come to an agreement to resolve the lien or claim dispute. This method of working forward and then backwards may be very effective in resolving mechanic's liens and construction claim disputes in which the Subcontractor is owed money by a Contractor who is owed money by a client or end user. The chain of command at the end user must be notified systematically by fax, telephone and onsite visit to project location. On the other hand, it is noted the more conventional obvious move of directly contacting the General Contractor initially is generally not an effective step in the mediation process.

In another exemplary embodiment, assume the Subcontractor is owed final payment from a General Contractor, who is owed final payment from his ultimate client, the end user. Assume further that only two Subcontractors have completed their line items of work. As a result, the end user refuses to pay the General Contractor the final payment which includes contract and retainage balance. In this scenario the mediator may contact the ultimate client, the owner's representatives (if they are different form the ultimate client, such as, for example, if the end user is a tenant contracting a build out or remodel) and the Subcontractors who have not completed their line item of work. An arrangement with the Subcontractors that they will get paid upon completion of their work within a reasonable time frame may, for example, be made. Additionally, for example, a review of open punch list items with the Subcontractors may be undertaken. Getting a written commitment from these Subcontractors and an estimated completion time to finalize corrective work, and submitting this to the owners' representative and Project Executives at the General Contractor, may expedite resolution. Additionally, for example, an onsite walk-through may be arranged to concretize what work items are still actually open.

In yet another exemplary embodiment, assume a concrete Subcontractor claimant is a subcontractor to a Concrete Contractor who itself is a subcontractor to a General Contractor engaged by a library for a public improvement project. The Concrete Subcontractor, has a public improvement mechanics lien against the project. There is a bonding company and a surety company that represents the Concrete Subcontractor and General Contractor. Thus, in this example mediation client is a second tier subcontractor (a subcontractor to the Concrete Subcontractor, who itself is a subcontractor to the General Contractor).

In one embodiment, mediation actions to be taken in this scenario may include, for example: initial contact with the surety company Claim Analyst or General Counsel, obtaining a proof of claim affidavit, having the mediation client notarize the documents and submitting all the relevant backups to the surety company. Additional actions may include sending copies of the bond claim to the General Contractor and the General Contractor's other Subcontractors and Project Executives. After the bond claim is filed, both tiers of General Contractors, principals and their Attorneys may, for example, be contacted by written and telephone demand. This may prompt the bonding company to contact their surety representation and a mediation meeting may be set up between the principals of the Concrete Contractor, the (lien claimant) Concrete Subcontractor and the bonding company's surety representatives.

In an exemplary embodiment, assume a system may be, for example, in the nature of an expert system that may store and encode intelligence which may assist a novice or even an experienced mediation specialist in the performance of various tasks needed to implement the methods of the present invention. Such an expert system may be, for example, be created by articulating the intuitions and “gut-level sensibilities” that one or more expert construction claim mediation specialists have acquired based on their vast experience. Such articulation may be, for example, quantified in a set of rules, and/or in various metrics, functions and algorithms to be used to process, evaluate and operate on construction claim case data and make recommendations as to strategy and actions to take.

Such an exemplary system may be, for example, assist in processing claims from the very beginning. When a prospective claim enters the system it may be analyzed for various factors. These may include, for example, the amount of the claim, the time it has been outstanding, the industry, and various other factors. These factors may be reduced to a list of numerical parameters (a vector). From this vector, length may be generated, for example, for the various pending decisions. At first, for example, these decisions may be to simply determine which leads are the most likely to be profitable and place them at the head of a processing queue for the telemarketers. There may also be vectors, for example, for decisions to either abandon the case as an unworkable lead or to pass it to a closing specialist. A good exemplary visualization of such vectors is a set of arrows that may represent the different decisions. As information enters the system, the arrows may change in length. The system may make decisions based on the relative lengths of the vectors, for example. More precisely, the system may have several length measuring functions (metrics), whose values may be compared to determine which decision is most likely the best at any point in time. This may, for example, simulate the way that a human being would make decisions based on their finely honed instincts and experience.

In an exemplary embodiment, each time a telemarketer makes a call to a prospective mediation client, the results may be entered into the system to determine the current state of the vectors. If certain factors start coming up, such as, for example, a disagreement about punch lists, the arrows associated with sending the claim to a closer may get longer. On the other hand, if a telemarketer is making a large number of calls to a lead but is not getting business, then the vector for abandoning the process may grow. This same process may occur, for example, when the lead is in the hands of a closer. His actions may change the sizes of the various arrows connected with each decision. After a prospective case has been taken by a user, the lien or claim documents may undergo an initial analysis and a preliminary list of key players may be drawn up. An exemplary system may produce the necessary documentation and automatically generate faxes to send out (which may, for example, be done completely electronically within the case management environment itself), while the mediator may make a first batch of calls and visits. This may take place in a very short time to have a blitz effect. After this blitz there may be, for example, an investigative period. During this period, the mediator may work to determine enough information about the case to produce a plan for its resolution. As information is entered into an exemplary system, it may be evaluated by system algorithms and decision modules. As more data is entered, the system may guide the mediator towards a plan to close the case.

It can be noted that the sets of decision vectors are made for each of the individuals and documents outlined in the plan. Further individuals may be added later, as well. The decisions in question may be, for example, to continue working with each individual, or to decide that that individual has reached the point where he should be able to resolve the claim, or to abandon that person as an inefficient use of resources. As the mediator/user works on the claim the system may change the lengths of the vectors. The system may also perform an important additional function at this point, for example, the system may estimate which activities (documents and people) may most help the mediator to bring the claim to a successful conclusion or eliminate it if the situation is hopeless. Once again, in so doing, the system may emulate the instincts of an experienced mediator.

In an exemplary embodiment, such a system may, for example, be self-improving. The functions that determine the relative lengths of the various decision arrows may be functions of both the specific factors of the claim and a set of weighting constants. These constants may be thought of as representing how important various factors are in evaluating the claim. The initial values of these constants may, for example, be determined by consulting with professionals in the field. As the system is used, the information may be stored in a database. Periodically, this information may be reviewed and the constants adjusted. There may be, for example, both a relatively quick running method for slightly perturbing the constants, as well as a much more complex method for analyzing constants without presuppositions of their approximate values. By running this process, the system may learn from experience just as a professional mediator would.

In exemplary embodiments, each construction claim mediation case (both active cases and prospective cases being sought) may be expressed as a vector. The system may, for example, work with lists of ratings based on factors involved in the claims. The system may at first work with just a first order approximation of the relationship between the factors and the length created by the functions. This may give, for example, a first order polynomial of the form A₁X₁+A₂X₂+ . . . AnXn, where An are the weighting factors and the Xn are the indices from the case. If useful, cross terms may be added, as well as other higher order terms.

Periodically, for example, the constants may be evaluated to determine those that best fit the situation. For example, in one system, the sum of the lengths of the items that generated business may be the highest while the sum for the rejected may be the lowest. This process may be implemented for each of the vectors, and may be fairly easily done when it is reasonably certain that the constant values are close to correct. One may simply individually alter them slightly and then see in which direction the match is better. Doing this with each of them may provide a better fit. If it does not, that implies the need for various cross-terms, i.e., the influence of the various factors is not independent.

In one exemplary system, the values of X, may all be in the range of 0 to 1. They may, for example, be divided into two types: Nominative Types, representing things like the industry of the claimant, or the presence of a specific item or document, and Ratio Measurements, representing things like time overdue or the amount of the claim. These types may, for example, be put through a normal function to generate their values. For example, a system may start with a normal curve with just a mean and standard deviation. If needed, a given function may be changed to represent different levels of attenuation on the sides.

Thus, in exemplary embodiments of the present invention, such a system may allow a relative novice to perform from the very beginning as if they had years of built-up expertise. In exemplary embodiments, a franchise arrangement may be set up wherein a franchisor trains franchisees in the methods of the present invention and provides the franchisees with such an exemplary expert system, that may allow them to perform their duties efficiently and successfully, as well as provide them with the benefit of a “virtual senior partner”, assisting such a franchisee at every step of the way.

Additionally, in exemplary embodiments, an expert system may maintain databases of relevant construction industry and real estate data, and automatically cross-reference and research any construction claim in a given market as to building owner, key parties related to the property or project, and key relationships of the claimee that may be available to exploit to bring pressure to bear on the claimee to reach a settlement. Such a database may also, for example, maintain a history of all cases handled throughout the system, and may cross-reference and supply the names of key parties in entities involved in current cases. Additionally, in a franchise context, each franchisee may, for example, be required to enter each case into an exemplary system, and manage the case through the system. Data entered into the system by the franchisee at each of the various points in the life of a mediation case, may then be used to generate reports back to the franchisor for data mining, monitoring, and analysis by the franchisor for various purposes.

FIG. 4B illustrates the flow chart 400b for mediating lien disputes. The flow chart depicts one or more steps. At first, lien cases are uploaded to the system 100 of FIG. 1, at step 402. The lien cases include, but may not be limited to, client contracts, notice of liens, invoices, purchase orders, client agreement, sales executive ID number, change orders, and payment requisitions. Further, the lien cases are downloaded to mediation specialist portals, and, dashboards and ticker database, at step 404. Further, a lien collectability predictable algorithms are created during a mediation investigation collection resolution process, at step 406. The lien collectability predictable algorithms are performed on the lien cases to identify and prioritize the lien cases. Further, the lien case algorithms are uploaded and downloaded through multiple ConstructQwikCollect (CQC) smart flow system databases, at step 408. In one embodiment, the CQC smart flow system databases comprise, a system and methods smart database, a machine learning smart database, an artificial intelligence smart database, client efficiencies smart database, predictable algorithms smart database, information tracking system method application (ITSMAPP) smart database, a lien case communication Blitz smart database, non-obvious and unique sequential varied steps smart database, predictable combinatorial optimization steps smart database, lien input, and output sequencing steps smart database, final payment client close out smart database, and client efficiencies smart database. In one embodiment, the CQC provides an interface for client relations to the ITSMAPP smart database. Further, the CQC smart system cyclical flow of resolved lien cases through the mediation specialist and mediation management portals and dashboards which creates enhanced CQC system components and subsequent smart databases, at step 410. In an embodiment of the present disclosure, the CQC system downloads lien documents to predictable algorithms smart cycle database system & methods smart cycle database machine learning smart database. Further, the CQC system uploads lien documentation to mediation specialist & mediation management portals & dashboards. The CQC system creates lien resolution algorithms during mediation, investigation, collection & consulting process data flows through smart cycle database, and mediation specialist, mediation management and IIC-CQC client portals & dashboards. Each resolved lien offers the CQC system, a machine learning, client efficiencies, artificial intelligence, knowledge base, case study, new lien technology, smart cycle CQC system components and system & methods enhanced smart cyclical flow with ITSMAPP tracking of sequential steps for client benefits (Information Tracking System Method Application). The CQC system allows Mediation Specialists to work on case management CQC system application wireframes, contact management wireframes, case management application wireframes, mediation sequential steps analysis, lien case investigation, mediation steps analysis, project onsite punch-list walkthrough, mediation management dashboard & reports CQC lien collectability algorithms assessment mediation specialist conference call meeting with multiple project related parties mediation specialist steps and analysis preliminary sequential steps for each lien case actions taken, the CQC system requirements and expected outcome.

Referring to FIG. 4C, one or more databases 400c for resolving lien disputes are shown. The one or more databases includes, but may not be limited to, predictable algorithms smart database, ITSMAPP smart database, lien case communication blitz smart database, non-obvious and unique sequential varied steps smart database, predictable combinational optimization steps smart database, lien input & output sequencing steps smart database, machine learning smart database, built-in artificial intelligence components smart database, final payment lien closeout smart database, and client efficiencies smart database.

Referring to FIG. 4D, the mediation specialists work through wireframes and execute sequential varied steps 400d. The sequential varied steps are identified by case management application wireframes. The case management application wireframes perform the lien collectability algorithm and mediation step analysis. The mediation step analysis is performed by the mediation specialist through a lien case investigation. The lien case investigation renders end user final demand to the mediation specialist. The mediation specialist performs conference call meetings, punch list meetings, and project walkthroughs.

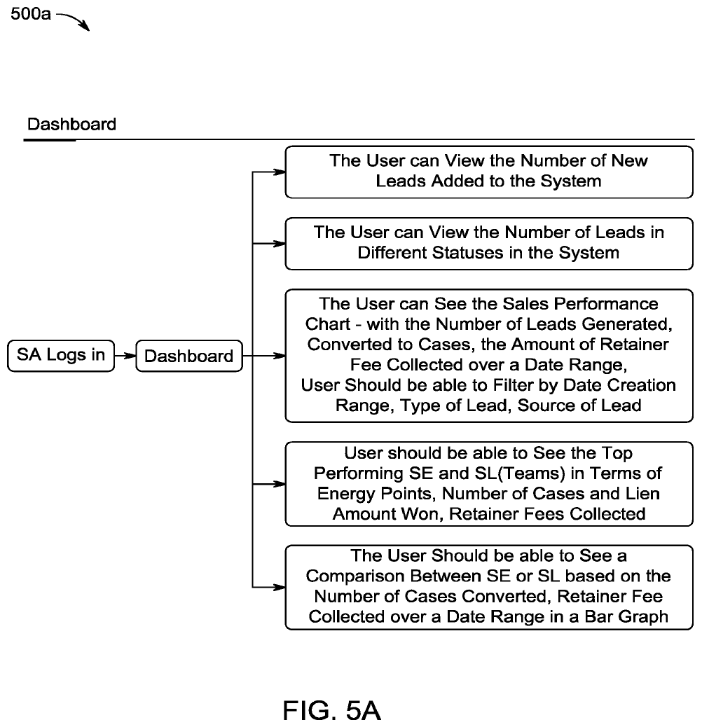

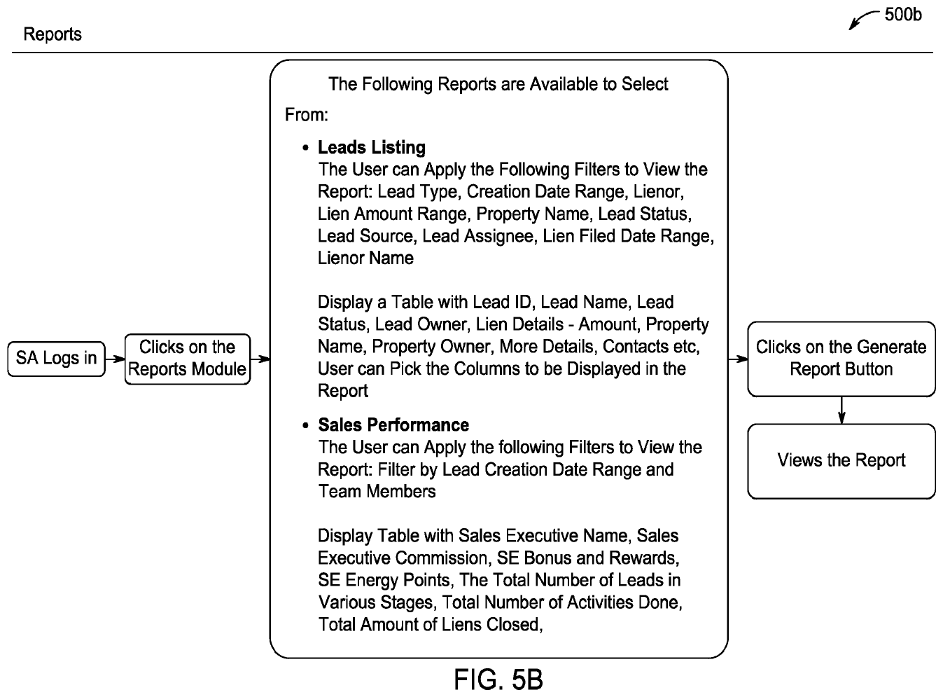

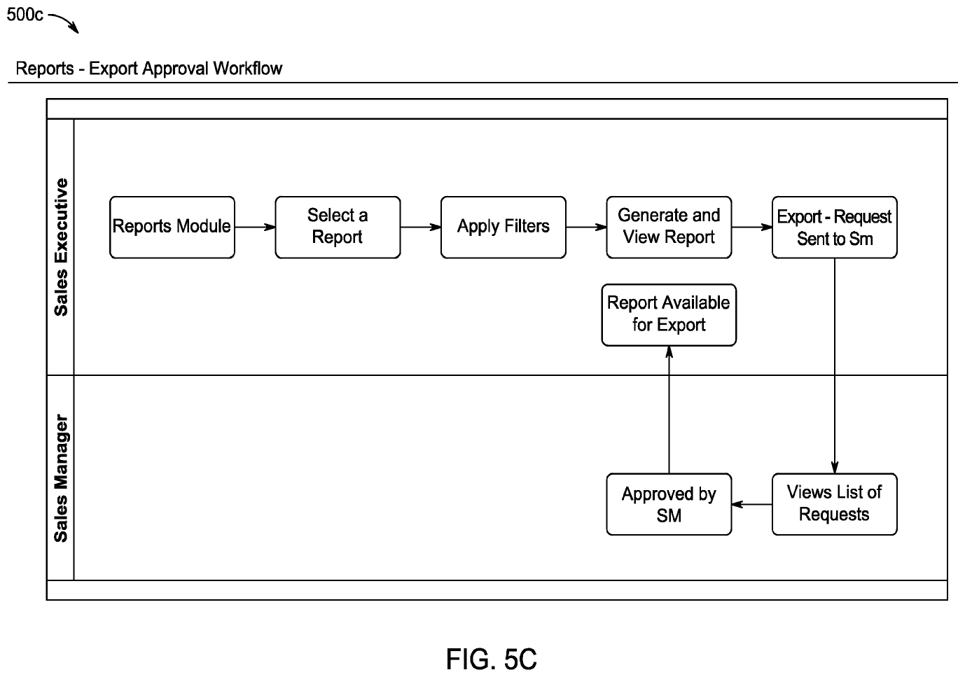

FIG. 5A illustrates an exemplary dashboard 500a showing a process of a lead management application, according to an embodiment. The exemplary dashboard 500a explains that, once a user logs in to the lead management application, the user may view, but not limited to, a number of new leads added to a system. Further, the user may view the number of leads in different statuses in the system. Further, the user may see a sales performance chart, including, the number of leads, generated, converted to cases, the amount of retainer fee collected over a data range. Further, the user may filter, by data creating the range, type of lead, and source of lead. Further, the user may view top performing SE (sales executives) and SL (sales leads) (teams), in terms of, energy points, the number of cases and lien amount won, retainer fees collected. Further, the user may view a comparison between SE or SL based on the number of cases converted, retainer fees collected over a date range in a bar graph.

FIG. 5B illustrates an exemplary dashboard 500b showing a process followed by the reports module of the lead management application, according to an embodiment. The exemplary dashboard 500b explains that, once the user clicks on the report module of the lead management application, the user may view leads listing and sales performance. In the leads listing, the user may apply the following filters to view the report i.e. lead type, creation date range, lienor, lien amount range, property name, lead status, lead source, lead assignee, a lien filed date range, lienor name. Further, the leads listing displays a table with lead ID name, lead status, lead owner, lien details, for example, amount, property name, property owner, more details, contacts, and the like. In the sales performance, the user may apply the following filters to view a report i.e. filter by lead creation date range and team members. Further, the sales performance displays a table with sales executive name, sales executive commission, SE bonus and rewards, SE energy points, a total number of leads in various stages, the total number of activities done, the total amount of liens closed, and the like.

FIG. 5C illustrates an exemplary dashboard 500c showing an export approval workflow of the reports module, according to an embodiment. The exemplary dashboard 500c is divided into two sections i.e. sales executive and sales manager. The export workflow of the reports module includes one or more consecutive steps. At first, a report is selected. Successively, filters are applied to the selected report. Further, the report is generated and viewed. Successively, a request is sent to the sales manager to export the generated report. Further, the sales manager views the list of requests. Successively, the requests are approved by the sales manager. Finally, the reports are available for export.

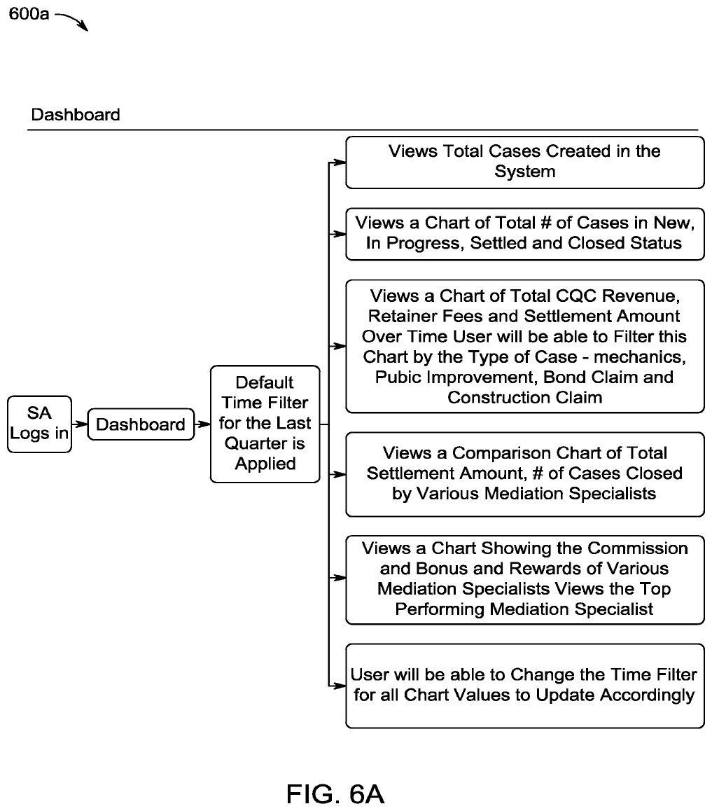

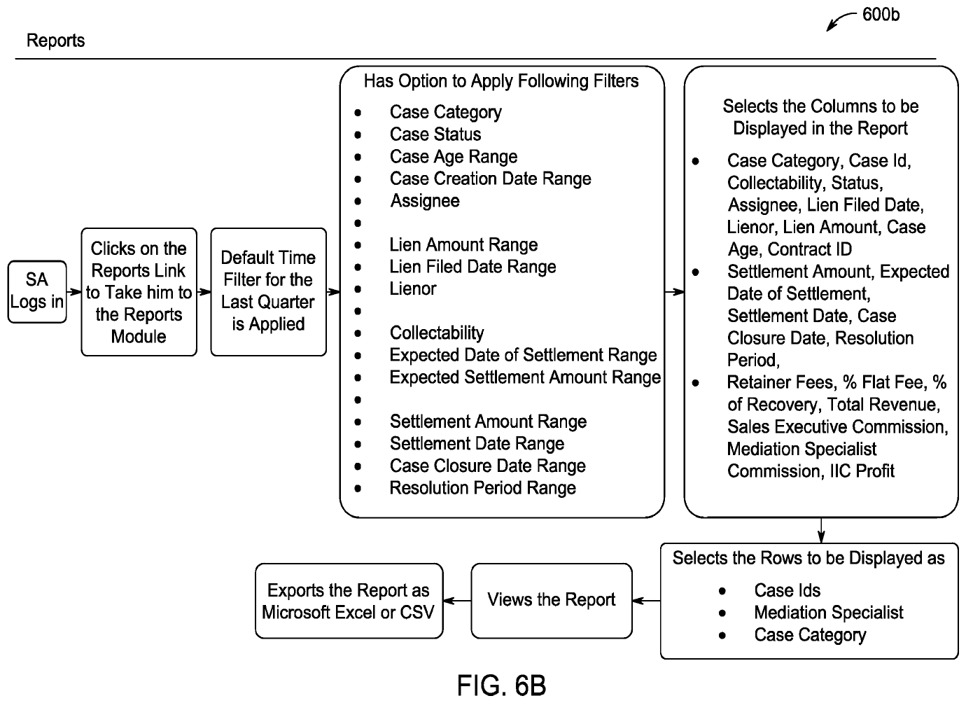

FIG. 6A illustrates an exemplary dashboard 600a showing a process of a case management application, according to an embodiment. The exemplary dashboard 600a explains that, once a user logs in into the exemplary dashboard 600a, a default time filter for the last quarter is applied. The exemplary dashboard 600a facilitates the user to view total cases created in the case management system. Further, the user may view a chart of a total number of new cases, in-progress cases, the settled and closed status of cases. Furthermore, the user may view a chart of total CQC revenue, retainer fees, and settlement amount over time. Furthermore, the user may view the chart by a type of cases i.e. mechanics, public improvement, bond claim, and construction claim. Furthermore, the user may view a comparison chart of the total settlement amount, and a number of cases closed by various mediation specialists. Furthermore, the user may view a chart showing a commission and bonus rewards of various mediation specialists views a top-performing mediation specialist. Furthermore, the user may change a time filter for all chart values to update accordingly.

FIG. 6B illustrates another exemplary dashboard 600b showing a process followed by reports module of the case management application, according to an embodiment of the present disclosure. The exemplary dashboard 600b explains that, once the user logs in into the exemplary dashboard 600b, the default time filter for the last quarter is applied. In one embodiment, the user may select a reports link to trigger to reports module. The exemplary dashboard 600b facilitates the user to apply one or more filters in the case management system. The one or more filters include, but may not be limited to, case category, case status, case age range, case creation date range, assignee, lien amount range, a lien filed date range, lienor, collectability, expected date of settlement range, expected settlement amount range, expected settlement amount range, settlement amount range, case closure date range, and resolution period range. Further, the user may select columns to be displayed in the report based on the one or more filters i.e. case category, case ID, collectability, status, assignee, lien filed date, lienor, lien amount, case age, contract ID, settlement amount, expected date of settlement, settlement date, case closure date, resolution period, retainer fees, percentage flat fee, percentage of recovery, total revenue, sales executive commission, mediation specialist commission, and profit. Furthermore, the user may select rows to be displayed as case ids, mediation specialist, and case category. Furthermore, the may view the report and export as Microsoft excel or comma-separated values (CSV) file.

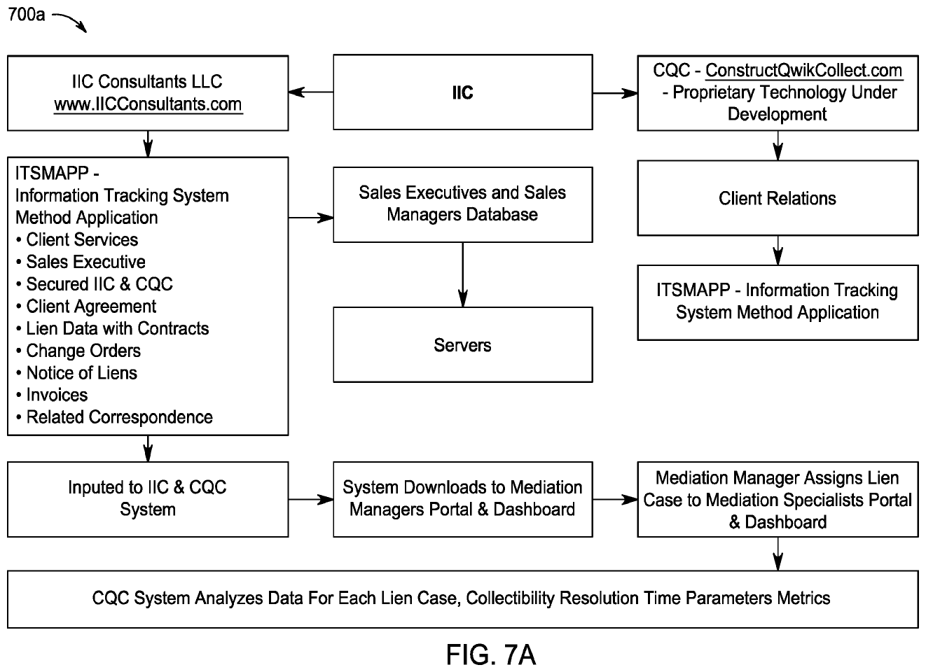

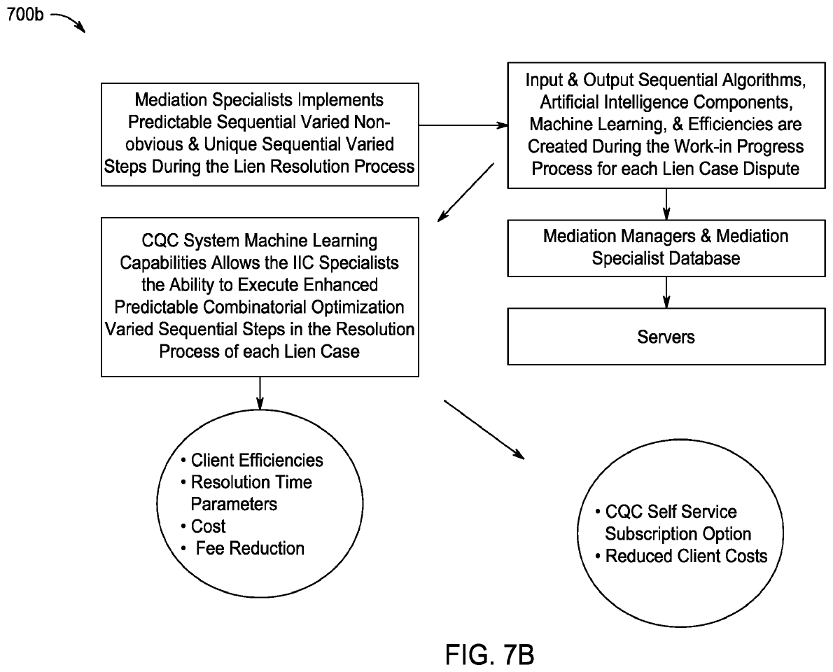

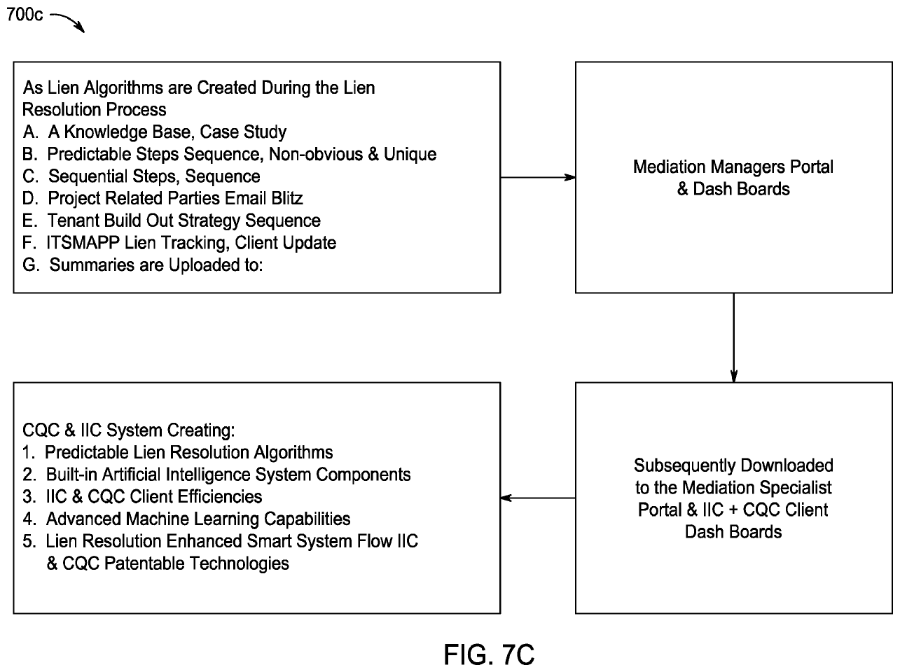

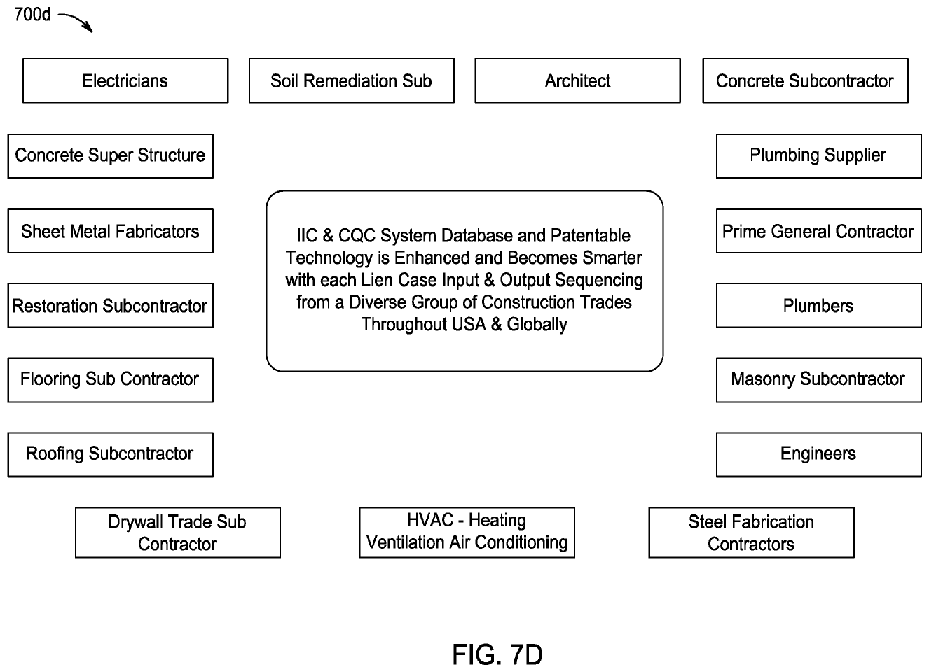

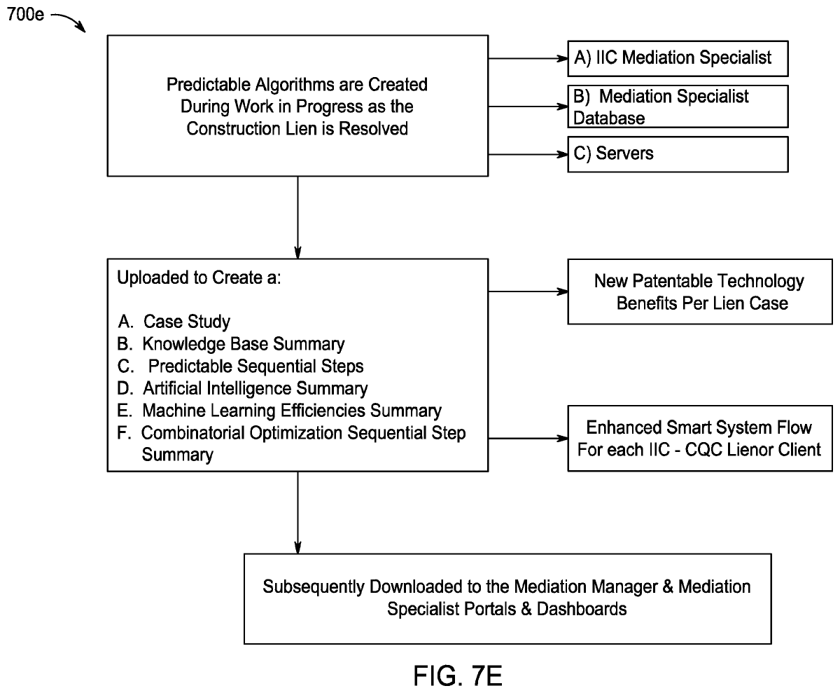

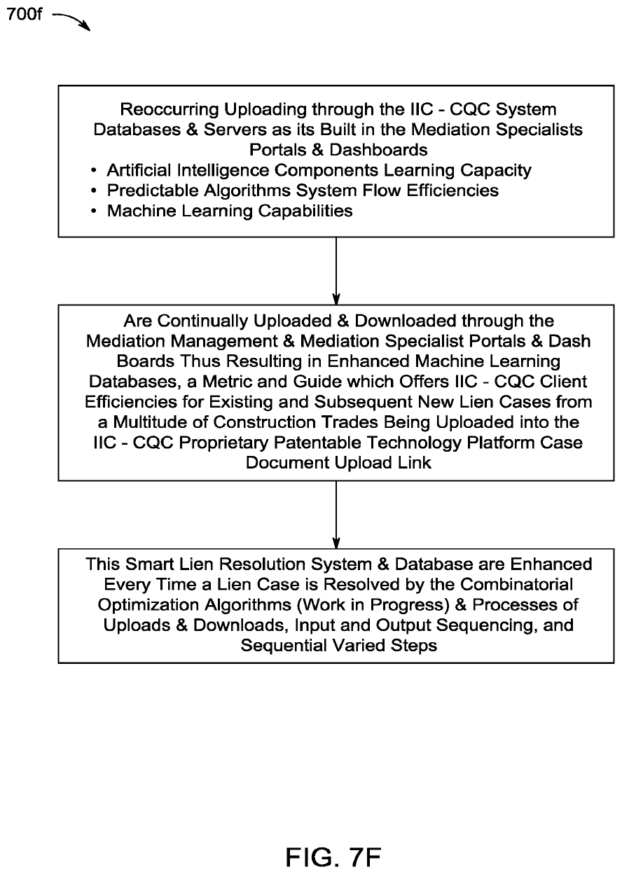

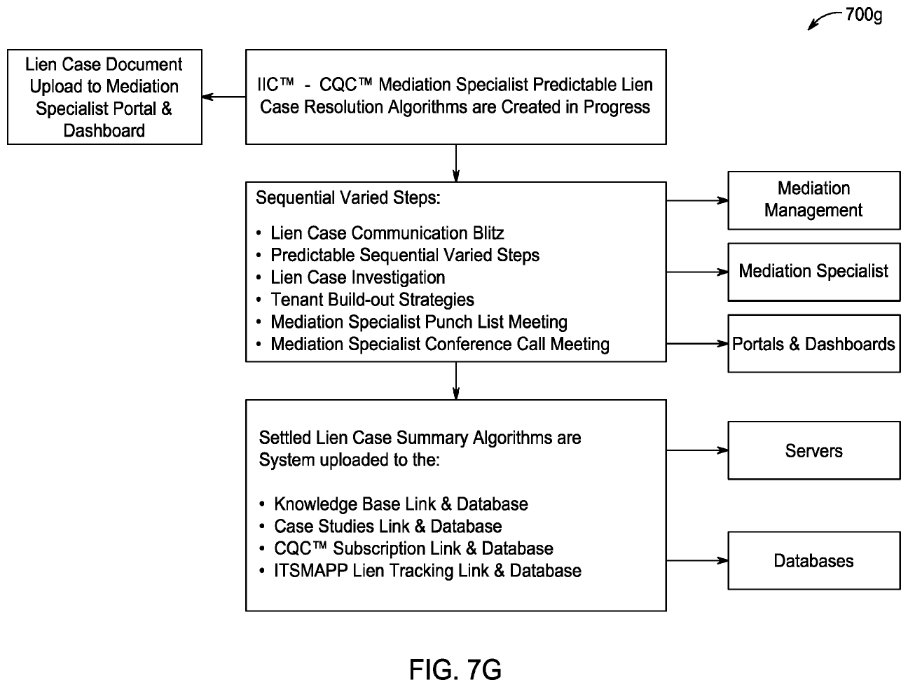

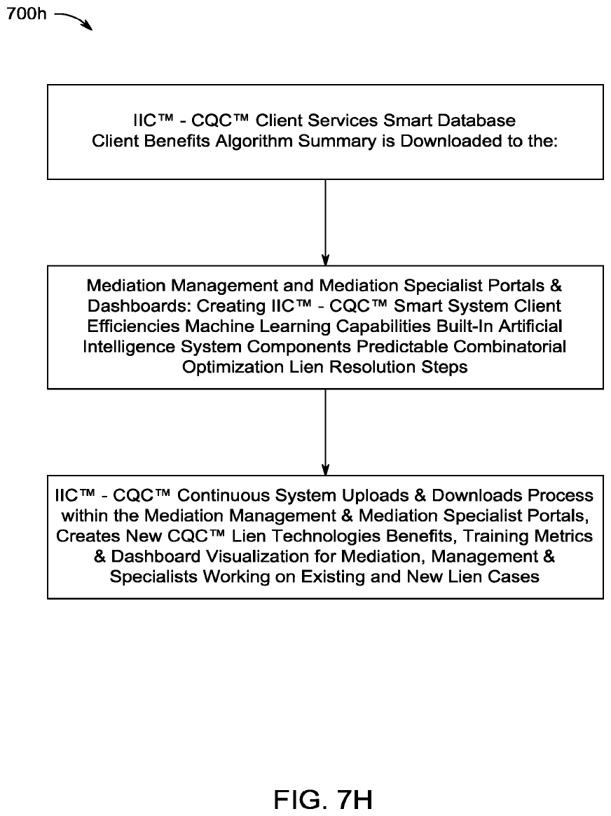

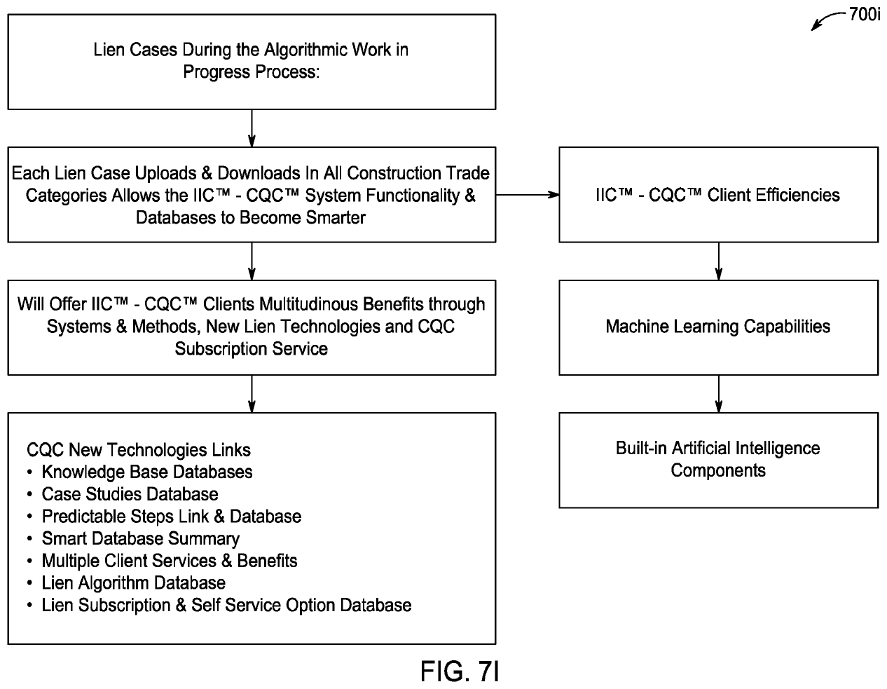

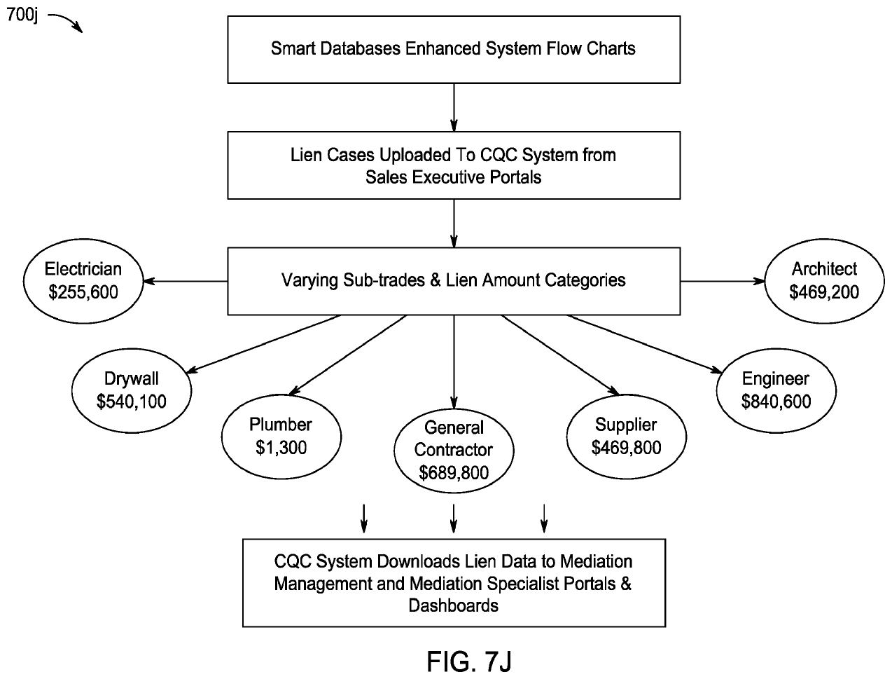

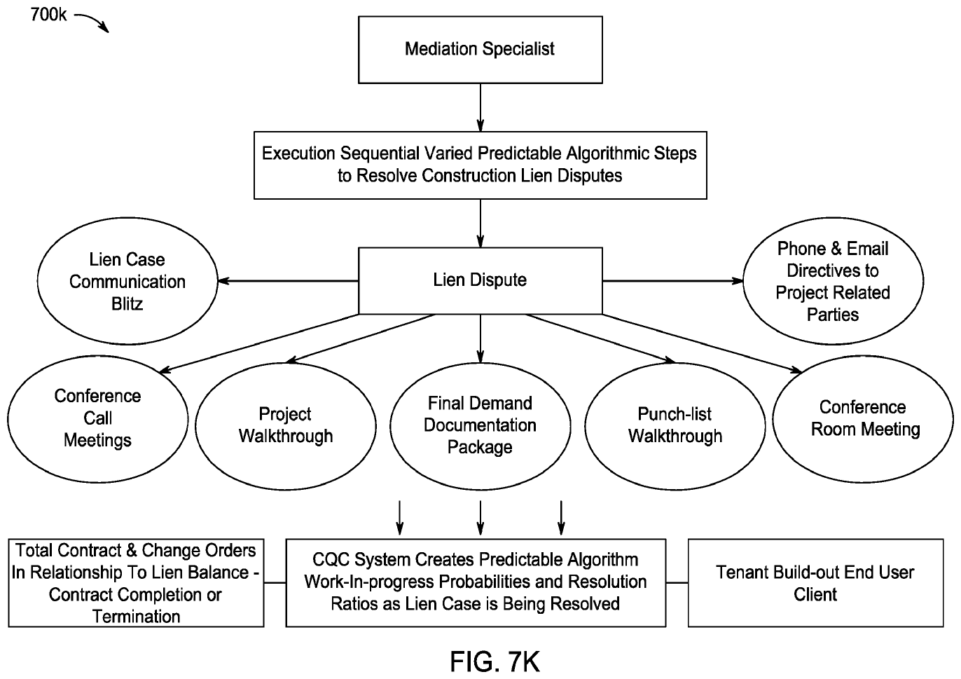

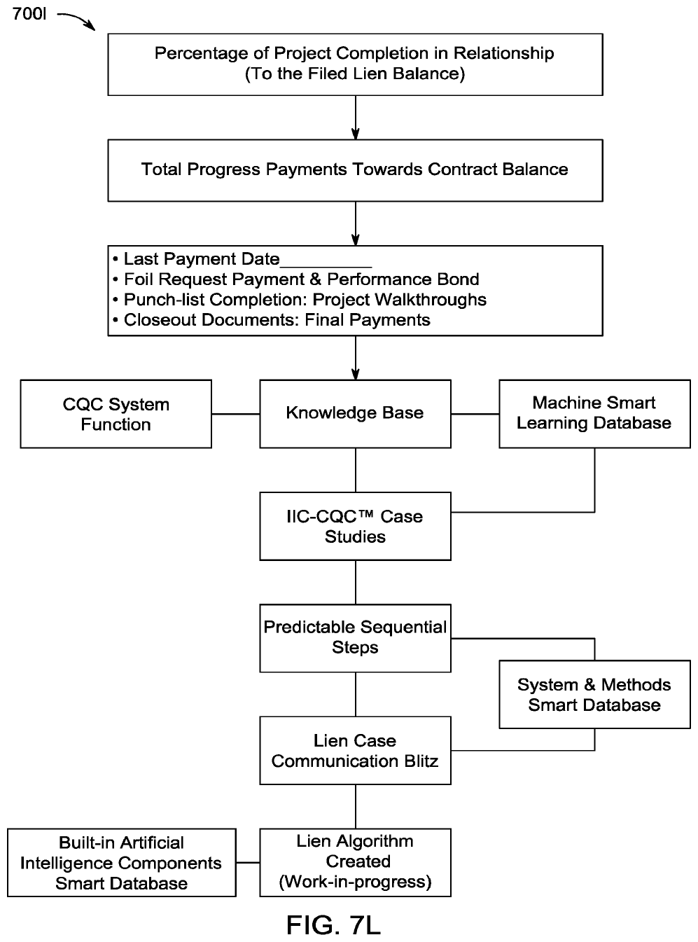

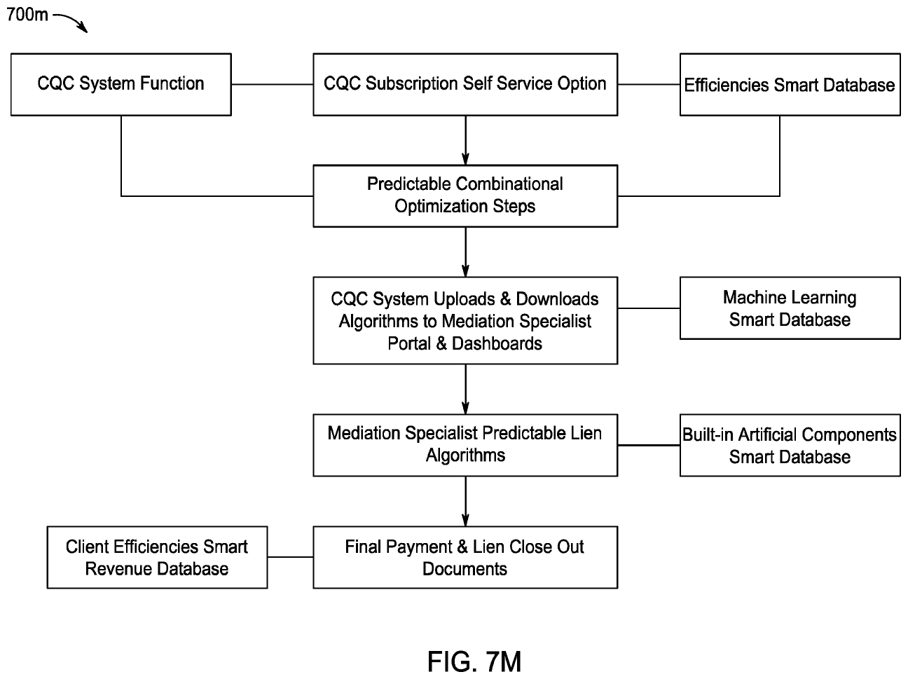

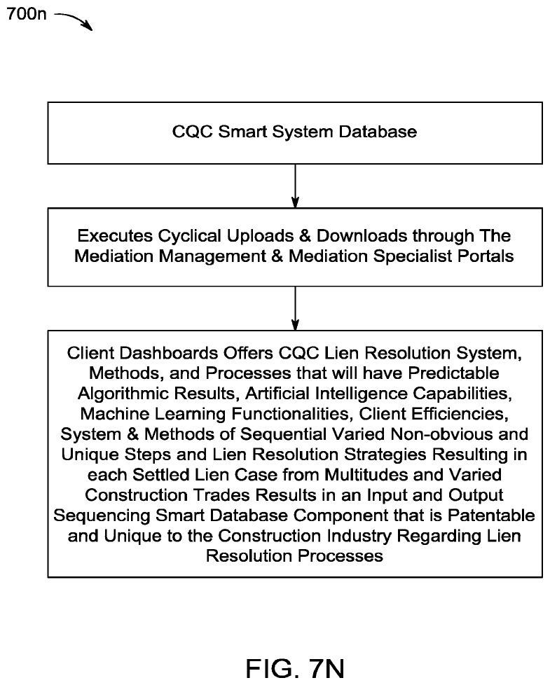

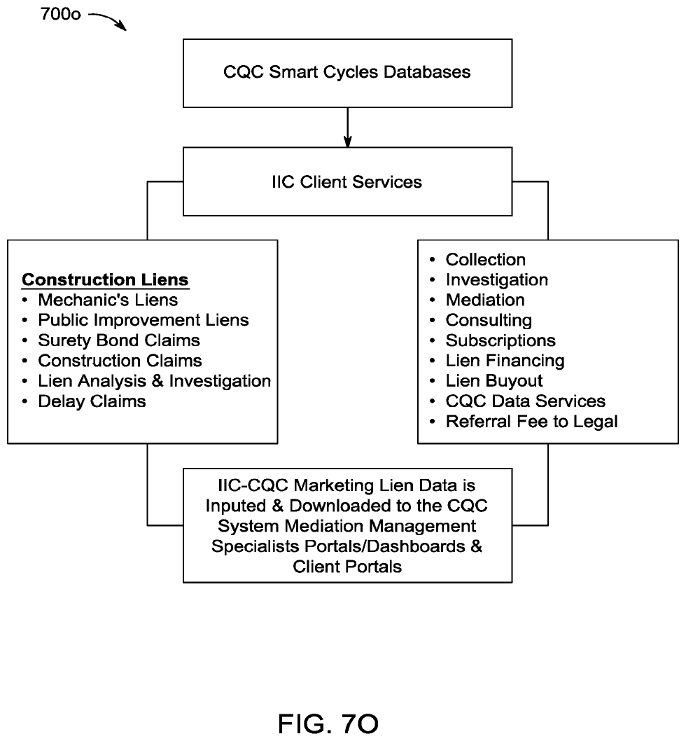

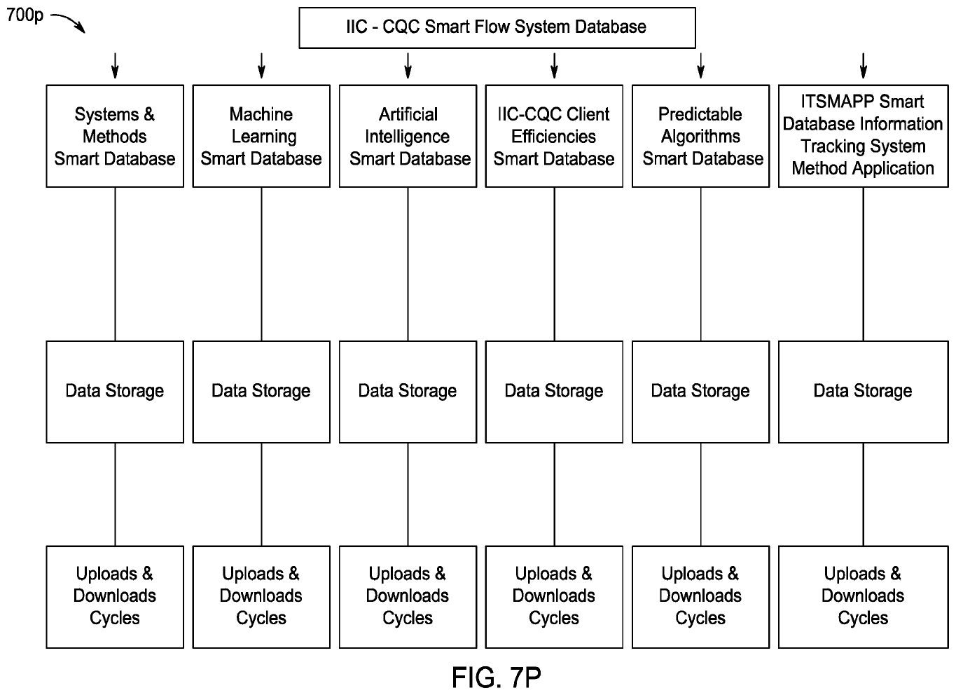

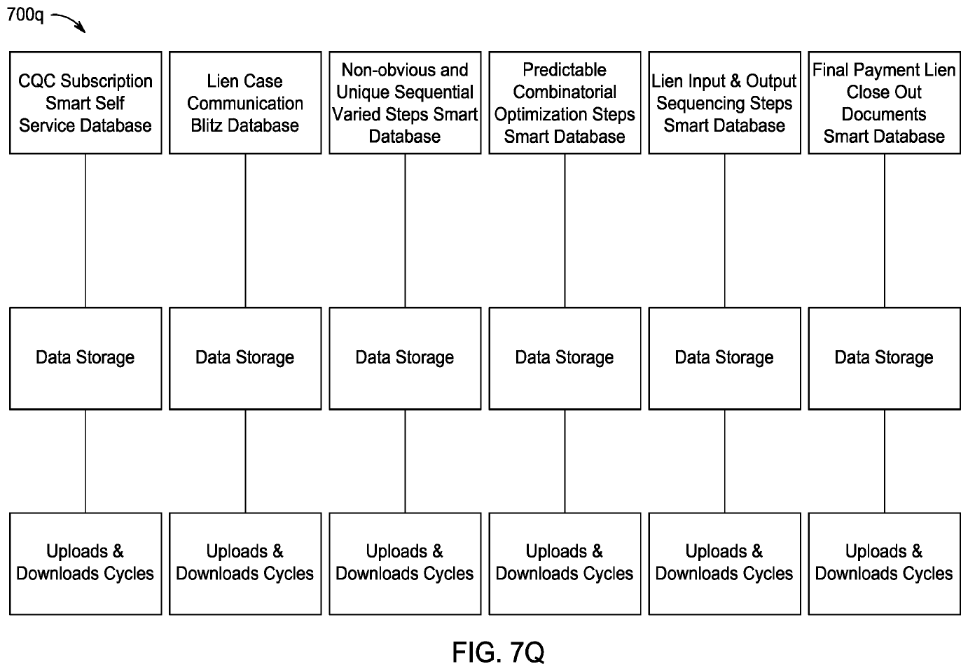

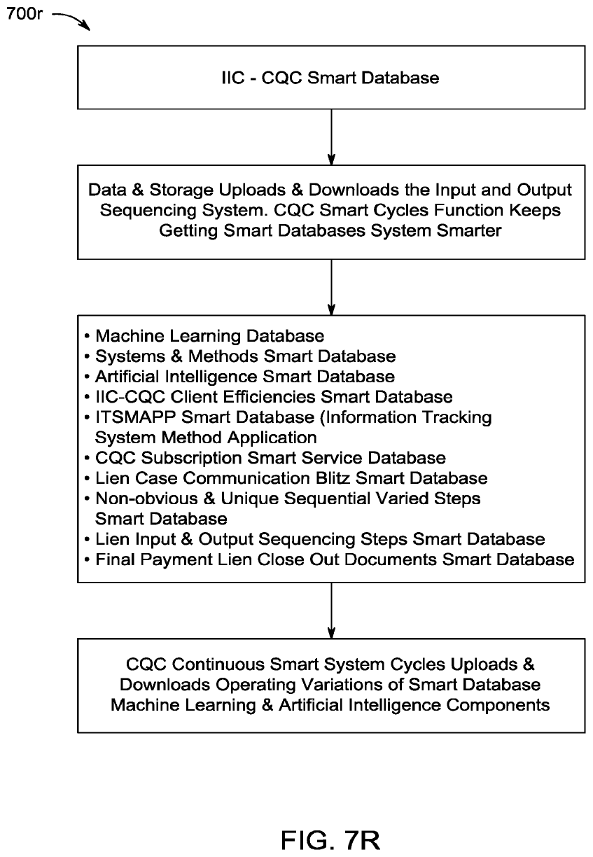

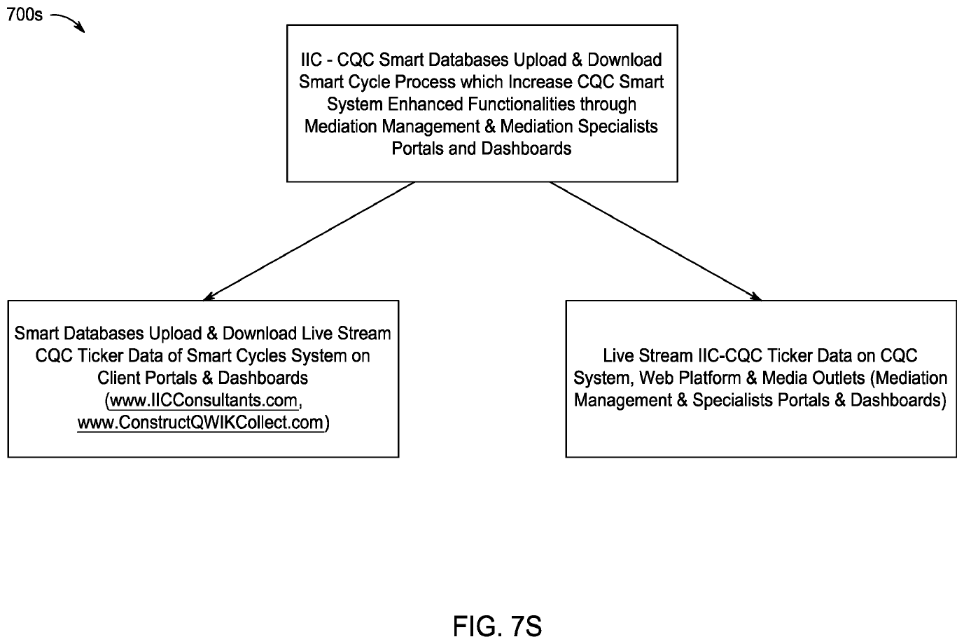

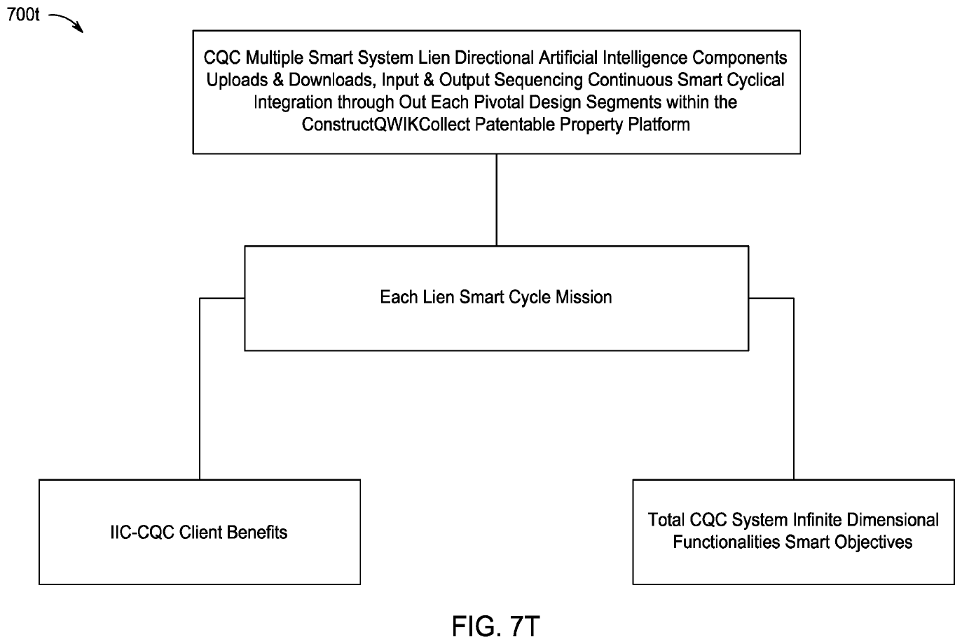

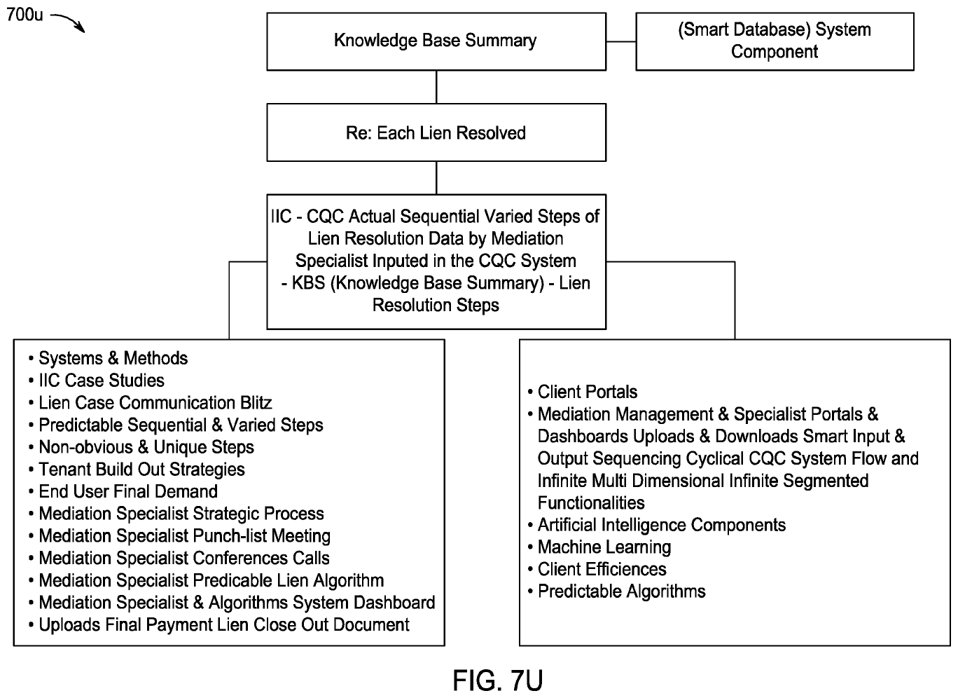

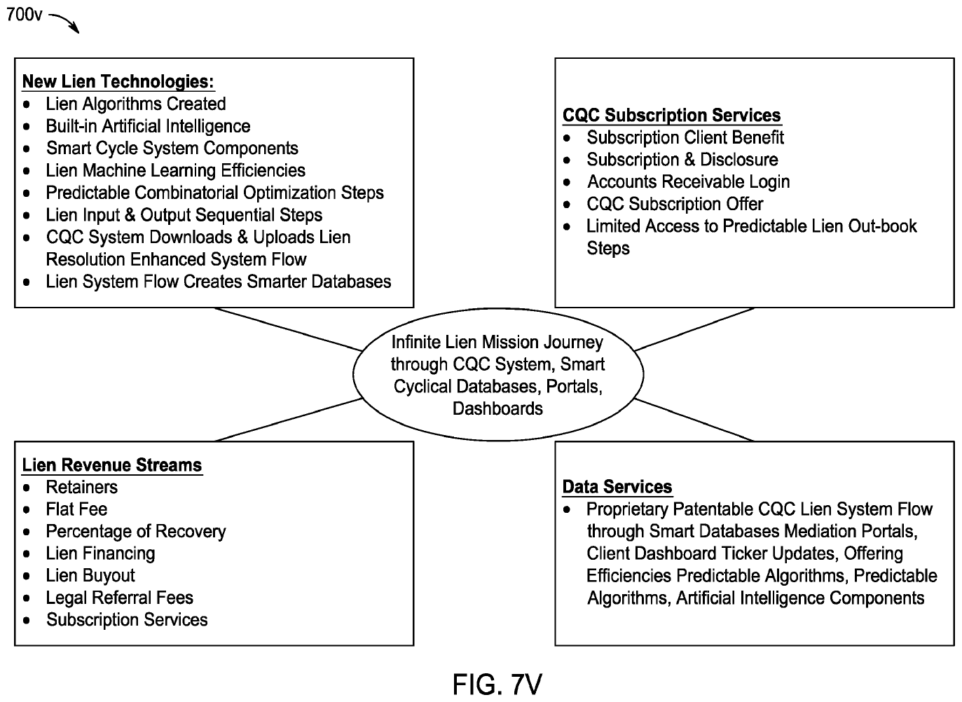

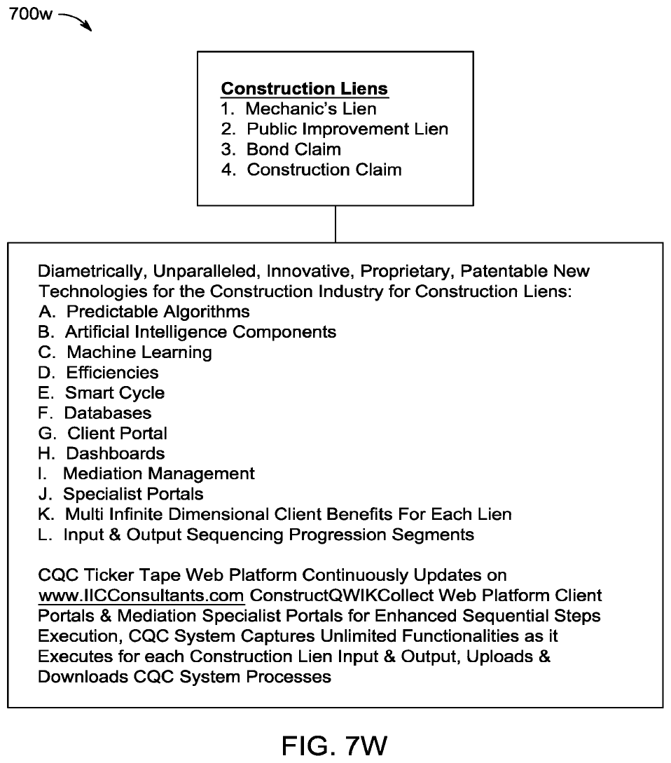

FIGS. 7A-7W illustrate exemplary models 700a-w for mediating the lien disputes, according to an embodiment of the present disclosure. In an embodiment of the present disclosure, the CQC system downloads lien documentation to mediation specialist and mediation managers portals & dashboards. Further, the CQC system and mediation specialist analyzes data for each lien case, collectability, resolution time parameters metric. Furthermore, mediation specialist implements predictable sequential varied resolution steps to create predictable collectability algorithm, client efficiencies are created, CQC self-service subscription options for clients are created. The CQC systems get smarter with each lien input & output sequencing uploads & downloads to mediation specialist, mediation management portals & dashboards CQC system smart cyclical databases, ITSMAPP tracking, knowledge base, case studies, subscription agreement, lien financing, lien buyout, systems & methods, machine learning, client efficiencies, artificial intelligence components, live streams, CQC ticker data on web platforms; www.IICconsultants.com, www.ConstructQWIKCollect.com. IIC & CQC (Smart Intelligent Mediation System for Lien Disputes) relating to construction liens offers unparalleled, patentable, CQC system flow through mediation specialist portals & dashboards, smart cycle databases, CQC new lien technologies, predictable collectability algorithms, live stream ticker data on interchangeable IIC-CQC web platforms, mediation specialist metrics, training work-in-progress on existing and future lien cases. Each lien from thousands of subcontractors, general contractors, suppliers, as it gets resolved, offers the construction industry and machine learning CQC system. The Smart system client efficiencies, predictable combinatorial optimization lien resolution sequential steps shortest path to lien resolution CQC system primary components get smarter with each lien input cyclical flow and final payment resolution. In an embodiment of the present disclosure, mediation specialist skills are enhanced through each lien resolution process of sequential steps, offering enhanced efficiencies and resolving lien cases in 30, 60, & 90 days on the average without attorney intervention. Each lien case has a potential to go through 12 smart cycle databases, mediation specialist & management portals & dashboards, CQC live stream ticker data of sequential steps, proprietary patentable cyclical CQC system flow with enhanced functionalities CQC technical architecture of lead management application, case management application, & smart cycle databases, custom built modules of CQC (ConstructQWIKCollect under development) for several months. IIC-CQC system resolves lien 65% of the time without attorney intervention and offers litigation support to lien cases that were forwarded to corresponding counsel. In one embodiment, some detailed exemplary case studies to describe the exemplary model are shown below. It can be noted that the methods of the present invention involve applying a variety of possible strategies and actions at the proper time and in the proper manner, the methods as described above are best exemplified by actual case studies. Such case studies, beyond a mere listing of strategies, techniques, steps, and possible actions that the mediator may take or implement, provide real-world context and illustrate how the various tools available to the mediator according to the methods of the present invention may be used in resolving real-world construction claims.

In one exemplary embodiment, the mediator seeking cases to mediate may procure a list of filed construction liens. Sources for such a lien list may include county records, or services which track such records. Such a lien list may be evaluated to predetermine which are viable leads to work. In such an evaluation, the size of the mechanics' lien should not be the sole factor in choosing which liens to pursue. Money may be made on a $10,000 lien at 35% or on a $350,000 lien at 12%. In fact, it is generally better to have 10 liens with an average balance of $50,000 than 1 lien with a balance of $500,000, as a higher success ratio may be achieved. When the mediator looks at a mechanic's lien list he may, for example, assess all of the following: the lien amount, when the lien was filed, the type of Subcontractor, General Contractor or supplier, knowing and understanding their trade designations. The mediator may, for example, familiarize himself/herself with the entity the lien has been filed against by cross referencing the list to predetermine if there are other liens filed against the project or if the General Contractor claimee has other money owed to other Subcontractors. In general, a filed mechanics lien may have the following basic components: 1). The subcontractor/all types of subcontractors; 2). The General Contractor (Prime or Sub-General Contractor); 3). The Supplier; 4). The location of the filed lien (address, county, city, borough, etc.). 5). The corporate entity of the property owner; 6). The corporate client, or name of the Construction Project; 7). The Subcontractor(s), General Contractor and/or Construction Manager for the Project; 8). The date the mechanic's lien was filed; and 9). The amount of the filed mechanic's lien.

In another exemplary embodiment, the mediator may conceptualize the scope of the project, whether it is ongoing or near completion, and what is the estimated total contract the client prospect has in relation to the size of the overall construction project. Looking at a lien lead may give an indication of how viable the claimee is, by asking the following questions: 1). Is this a General Contractor that has repetitive liens against their projects? 2). Are there other subcontractors that are owed money with regards to the same construction project that also filed liens? 3). Is this lien recently filed or has it been on the lien lead list for more than one month?

In another exemplary embodiment, if calling on a $100,000 lien, even before speaking to the key decision-maker, it is often desirable to quote a fee between 15-20% of the recovery. If the case is settled for $75,000 in a time frame of 30 days, the potential fee is $11,250-$15,000. In exemplary embodiments of the present invention, it is advisable to use the 20% rule, where a prospective mediation client is told they will get back 80% of their money. On substantial lien and construction claim cases, the fee may be dropped, for example, to the 12-15% range.

In another exemplary embodiment, when calling liens from a lead list, making a presentation or sending out brochures by email or facsimile, it may be determined if there is a sense of urgency on the part of the client prospect or if the client prospect is willing to enter into negotiations for the fee or advance retainer for handling their lien case. In perusing the mechanics lien lists in a given local market, the mediator may, for example, call first and ask, “Are you a painting contractor, or are you an electrical contractor”, or “are you a heating ventilation or air conditioning (HVAC) contractor?” In exemplary embodiments of the present invention, the mediator may determine to what type of subcontractor or general contractor the presentation is to be made. If the end user is recognized, such as, for example, a notable college, bank or national retail chain, the collectability of the lien or claim may be more easily conceptualized by the mediator.

In another exemplary embodiment, the location of a project may also indicate if it is an affluent area and a prestigious building, or a depressed area; whether it has a high or low crime rate, whether it is prime space conversion, a tenant buildout, or moderate to expensive real estate. It may also be determined if it is in the east, west, north or south side of the city, town or suburb, for example. The location may also indicate a commercial or residential building. Thus, in an exemplary embodiment of the present invention, evaluating the project address and location may be highly beneficial. The name of the subcontractors or general contractor may give insight into the viability of a lien or claim; i.e., are they a recognizable general contractor or are they a small general contractor? Are they a financially sound company, or are they a company that always has subcontractors filing against them?

Further, the case studies described herein relate to lien disputes. In exemplary embodiments, by using, inter alia, the criteria discussed above, the mediator may select, assess, analyze and review mechanics lien lists of daily or monthly filed mechanics liens. The following case studies illustrate methodologies and strategies to work a lien or construction claim case according to exemplary embodiments of the present invention. These case studies are based upon the actual experiences of the inventor. It is noted that in what follows the client of the mediation service is variously referred to as the “lien claimant”, “claimant” and/or “mediation client”, as may fit the context. Similarly, the mediation client's immediate obligor (e.g., a General Contractor where the claimant is a Subcontractor) is referred to as the “claimee.”

In one exemplary embodiment, stating Case Study No. 1—General Contractor: the mechanics lien list, a general contractor filed the mechanics lien against a high-end national women's retail chain and designer. The lien amount was $381,000. The mediator called and spoke to the principal for the general contractor and made a presentation over the telephone. Subsequently, the mediator made an appointment to meet the client prospect's principal and after a one-hour discussion, closed the deal and negotiated a 15% contingency fee with a $3,000 retainer to be deducted from the 15%. The mediator requested copies of the contract, the filed mechanics liens, all correspondence, change orders, purchase orders, final punch list, a list of all of the relevant subcontractors, and a list of all the telephone numbers of all the project managers for the claimant and the end users, including cell phone numbers.

The mediator's review of the lien case file indicated that the client's total contract, including change orders, was $2.5 million dollars. The mediator asked the client how long they had been working for this client of theirs, and learned that they had a 10-year relationship and had completed many construction projects throughout the United States. The mediator called the client and asked the principal why they had had a falling out, and learned that towards the end of the project, progress payments slowed up, and as a result, the general contractor was late in paying his subcontractors. These subcontractors started filing mechanics liens against these two high-end retail stores. As a result of an uncompleted punch list and filed liens, the end user would not continue to make progress payments until the general contractor resolve these issues. Review of the case file documentation and flushing out the appropriate questions to the claimant gave the mediation specialist a direction of approach to resolve this multi-faceted lien dispute.

As a mediation specialist, in conducting an investigation of a lien claim, it is necessary to speak with, and fax information to, as many key decision makers relevant to the construction project as possible. Armed with a list of all of the individuals that the claimant worked, the mediator had to go beyond these individuals to make all parties aware of the lien claim. In this scenario, the claimant was the Primary General Contractor who had a direct relationship with their client, the retail fashion chain. There was no intermediary. The General Contractor (the claimant), however, had employed at least seven Subcontractors, who were also owed at least 30% of the contract balance. The mediator's initial step was to reach out to the Director of Construction, the Chief Financial Officer and the Project Accountant for the General Contractor's client (i.e., the retail fashion chain).

It is advisable that key partners are put on notice with a letter and a copy of all hard copies, no matter how large the file is. After reviewing the file and speaking to the client, the mediator knew it was necessary to bring the client and the Director of Construction back together in a civilized setting. The client's principal was very angry; he was owed this money and he was getting real pressure from his subcontractors. The women's retail chain corporate officer was based in California, while the projects were in New York. It only made sense to have a meeting at the project location, especially since the end user's (i.e., the retail chain's) contention was that the project was uncompleted. The mediator arranged a walk-through of the construction project at various intervals. It is noted that all of the Subcontractors had additional work to do as listed on the uncompleted punch list according to the end user.

In exemplary embodiments of the present invention, in properly executing a mediation function, various options must be executed simultaneously to achieve momentum. The mediator obtained the punch list from the end user and forwarded this list to the general contractor. The mediator subsequently arranged a meeting with the end user and the principal for the general contractor at the jobsite. Phase one of the punch list was with the General Contractor, and phase two was with the General Contractor's subcontractors. It was then time to have a meeting with the Director of Construction (for the retail chain) at the project location. The General Contractor's principal joined the mediator at both project locations, spent several hours in a walk-through and prepared a check list of what items the General Contractor would complete and what work items subcontractors would complete. Once an agreement was reached in principle, this was submitted to the retail chain's Director of Construction for final review.

In exemplary embodiments of the present invention, when working with a small group of individuals that are owed money, the mediator tries to reach a universally fair and acceptable arrangement. This is because all subcontractors on the same project will talk with each other, and there are no “secret deals.” The mediator was able to commit the subcontractors in a written agreement to finish their line items of work from the punch list, even though they were still owed their contract balances. Once the mediator got two subcontractors to get started on their punch list work, progress payments were made on a weekly basis and this caused the other five subcontractors to follow suit and complete their respective punch lists. The General Contractor also took the lead in completing their portion of the punch list items. Additionally, the mediator strategically filed written complaints with each of the building owner and managing agent for the property, and negotiated directly with the property owner's attorneys, thus using the leverage of the filed mechanics liens to the fullest extent.

Such astute use of leverage involves being always just short of having an attorney intercede via a lien foreclosure action, yet still keeping the thought paramount in the minds of the claimee's key executives that a default may be forthcoming from the building owner regarding their lease obligation to keep the property free of liens. Attorneys for the building owner will generally put their tenants on notice to resolve this dispute with the general contractor and get the mechanics liens off of the properties. The claimee and the fashion chain's Director of Construction signed a two-way agreement and agreed upon a weekly progress payment of $24,000 per week. The prioritization of the subcontractors' work during the punch list cleanup process was agreed to be as though the project had never stopped. Initially the mediator had thought that the subcontractors could be trusted to complete their punch list assignments; however, when the mediator became aware that a couple of the subcontractors got behind the agreed work/payment schedule, this resulted in an inspection by the mediator of each subcontractor's punch list completion work prior to their weekly draw. The stipulated agreement resulted in a 3.5-month payout for a total sum of $369,000. The mediator controlled the disbursements of payments, even to their client, the General Contractor, who was to receive a $24,000 progress payment and exchange that check for the subcontractor's disbursements only after their portion of the specified work was completed.

In one exemplary embodiment, stating Case Study No. 2—Specialty Drywall Contractor: A Specialty Drywall Contractor had a $2-Million-dollar contract with one of the largest national movie chains in the United States. The disputed contract and change order balance was $500,000. When a lien this substantial appears on a mechanic's lien list, a client prospect is generally wavering between three options: 1) Forward the matter to an attorney and litigate; 2) Continue to negotiate; and 3) Bring in a construction mediation firm that is fully familiar with construction contracts and has the ability to mediate or arbitrate my lien case successfully without legal intervention. The claimant tried to negotiate a settlement for six months but was unsuccessful. In this case a mechanic's lien filed against the project, a multiplex theater on 42^{nd} Street in New York City, was not the motivating factor in reaching a resolution to this dispute. In fact, the multiplex theater was a multi-billion-dollar concern represented by one of the top law firms in New York City.

The mediator's strategy from the inception involved getting substantial documentation from the claimant that gave a full accounting and all supporting documentation, purchase orders, invoices, copies of contracts and proposals and change orders. The mediator realized that the key to resolving the lien dispute was proving the validity of the balance of the claimant's contract and change orders, and not whether their client or end user had the ability to pay this lien claim. The mediator's task was to overwhelm the attorney for the cinema chain with a substantial package of documentation (in the range of 300-400 pages) supporting the claim. A rapport was established with a key partner at the law firm, and the mediator diplomatically requested that they take a hard look at the claim, sent a courier to deliver the package. Also, by sending the same package to the Vice President of Construction at the cinema group, the mediator simultaneously caused both partners to peruse the back-up documentation at the same time so that they could discuss among themselves how this dispute could get resolved. Thus, if a claimant's lien documentation is sufficient, a mediator may generally force the attorneys and the claimee's principals to make a careful review of the claim, and make recommendations regarding payout. Thus, it is always better to be armed with an over-abundance of substantiating documentation that tells a full story of what happened during a construction project.

A series of follow-up telephone calls prompted a mediation meeting between the mediator and the attorney for the cinema chain. The mediator agreed to meet with one of the senior partners in the firm. A mediator may never be intimidated in a meeting of this type, but should rather show respect and be thoroughly familiar with the construction project, the documentation, the key project managers and all correspondence. The mediator sat down with two attorneys. To survive such questioning a mediator should thoroughly know the scope of the work, the total contract and claim order balance, the number of change orders, how accessible a copy of the purchase orders from the last payment requisition is, and how to easily refer to the disputed clauses within the contract. The mediator in such a situation should remain calm, as his function is to back up the claimant's documentation. If the documentation is overwhelming a strong legal position may be set up in the event the claim has to be litigated.

In many ways, it comes down to positioning for the right deal and trying to get the most money for a client. The claimee's attorneys will either put up an immediate strong defense or will listen to reason and not jeopardize their client being sued with a likely eventuality of spending time and money and losing the case. These two fears may only be exploited if the claim proof and documentation is irrefutable, and the mediator deals from a position of strategic strength. Thus, the attitude the mediator projected to the attorneys was that the mediator may either prove the case now, or later in the legal process. Because the claimant was owed $500,000 and had engaged the mediator to resolve their case at a lower fee of 8% of the recovery, there was some latitude to settle their lien claim. Everything about the case indicated that there was money available: a major Fortune 500 ultimate client, a $2-Million-dollar contract just for the drywall, many other subcontractors, and the total of all contracts on the job was $50,000,000. Including all subcontractors, the mediation client was paid everything but the last $500,000. Thus, the mediator knew that this was a quantifiable lien claim.

The focus of mediation was to show the Vice President of Construction and the attorney for the cinema that although the lien claim is valid, settlement of the lien claim is possible if a fair offer is presented. In exemplary embodiments of the present invention, it is important to always let a mediation client have a conference call with the relevant parties—here the cinema's attorney and the Vice President of Construction. In this case, the mediator arranged two conference calls. The mediation client may explain the construction project better than anyone and when the opposing side tries to question the mediator with a lack of the full course of events, having the client argue the rebuttal, explain and negotiate adds more credibility. There are times, of course, when a private meeting with all the relevant parties is needed prior to the involvement of a claimant's principal; however, in the vast majority of mechanic's lien and construction claim disputes, the client is a mediator's key ally, engaging in conference calls and face-to-face meetings, either at the construction site or at the general contractor's Owner's Representative's or the end user's (here the cinema chain) office. The particular strategy to use in a given context depends upon various factors. If a General Contractor is questioning the quality of the claimant's work, then they should defend themselves verbally with supporting documentation. Everything comes back to the initial contract and terms and conditions of the business engagement. Also, often the project manager, the vice president of construction, the job supervisor, the facilities director, the construction managers, the project accountants or the attorneys also have inherent knowledge, perspective, and opinions about the construction project, so insight into the mediation strategy may be gained by speaking to these and other key individuals.

The mediator was able to convince the cinema's attorney that they should be negotiating directly with the theatre's Vice President of Construction who was already evaluating the lien claim. In the final analysis, a back charge credit of $100,000 was agreed to by the mediation client and the Vice President of Construction of the cinema group, and a settlement check for $400,000 was approved and exchanged for all relevant close-out documents. This mediation process took 60 days to settle.

In one exemplary embodiment, stating Case Study No. 3—Painting Subcontractor—General Contractor had Obstinate In-House Attorney but Needed Major Supermarket Chain's Goodwill: A Painting Subcontractor was owed $183,000 by a New Jersey based General Contractor. The General Contractor had not paid the Subcontractor for over eight months. The mechanic's lien that was filed against the project was eight months old, and thus nearing a one-year deadline for taking legal action. This case study illustrates psychological leveraging of the relationship between a General Contractor and their corporate client. A client knows his options and the cost relative to those options—mediate, settle or litigate. Their mediation efforts without third parties will generally fall short of the additional leverage that is required to push negotiations over the top and result in a final payment. A client will always prefer to settle in most cases without their construction mediation firm, collection agency or collection attorney, as they get less of the payout by using such assistance. Thus, they are trying to execute all options so they may settle in-house and not pay either a commission or a retainer. The final option, litigation, is for the most part, the most exhausting option. It is costly, intense, time consuming and sometimes long and protracted. In most cases, it is also the most financially draining option. Further, knowing this the mediator quoted a fee of 12%, i.e., one half of what a contingency attorney would charge in the event legal action was necessary.

In this case, the threat of legal action with the alternative of mediation as a first option was thought to be the best approach to take. However, when the mediator started working the lien case, the mediator discovered that the General Contractor was a family-owned business and the in-house attorney was the daughter of the principal partner. Legal action in itself would not be the best approach here, and the inference that such action would commence would not be the proper motivating factor to obtain resolution. Through a review of the lien file and asking the appropriate questions, it was determined that the General Contractor had as one of its primary clients a major national supermarket chain. The General Contractor worked locally, regionally and nationally for this supermarket chain. The mediator spoke with the General Contractor's in-house attorney, and explained that he was from a specialized construction mediation firm, and if he was not successful, there were attorneys ready to foreclose the lien and file a breach of contract action. The mediator called repeatedly, sent faxes and tried to set up a mediation meeting with the relevant parties.

The in-house attorney for the General Contractor was not at all phased by the mediator's initial strategic approach. The mediator realized that these strategic steps were not working, so therefore the strategy had to be changed. The mediator's due diligence investigation had revealed the General Contractors' primary client relationship, as the mediator learned this fact from another subcontractor. As a result, the mediator implemented an immediate strategy in its arsenal of psychological leveraging tools. The mediator contacted the Director of Construction and the Vice President of Finance for the General Contractor's client (i.e., the supermarket chain) by telephone and fax. The mediator also spoke with a key executive at the supermarket chain who was aware of the work of the General Contractor. After these strategic steps, a telephone call came from a high-level executive of the supermarket chain to both the mediator and the General Contractor's attorney. This softened up the attorney who realized that tens of millions of dollars in construction projects throughout the US were in jeopardy from a $183,000 dispute with the claimant painting subcontractor. Here, the mediator properly used leverage. There are times when a number of telephone calls and faxes over a period of several weeks to multiple decision makers at the claimee's ultimate client (here the supermarket chain) will precipitate a sit down meeting that will be a turning point in the resolution of a lien or claim.

The General Contractor and the claimant were thus able to enter into final negotiations with regard to the satisfaction of mechanics' liens, final waiver of lien and general release documents. The mediator took a step back to allow facilitation of this final payment process. There were some minor punch list issues and an authorized back charge for $20,000 against the subcontractor was made. A final settlement of $163,000 was reached in a total time frame of 60 days. The original satisfaction of lien and the final waiver documents were exchanged for the General Contractor's check for $163,000.

In this case there was no onsite mediation meeting regarding the lien claim dispute. It was all resolved via telephone and facsimile. The case illustrates how a mediator must adapt, strategize, conceptualize and leverage all key players, and continue with such efforts until final payment of the lien or claim is achieved.

In one exemplary embodiment, stating Case Study No. 4—Sheet Metal Subcontractor: A Sheet Metal Subcontractor was owed $70,000 by a subcontractor that specialized in modular prefabrication work. The Prefabrication Subcontractor was hired by a General Contractor. Thus, the Sheet Metal Subcontractor was a subcontractor of a subcontractor, or third tier down. The General Contractor's client was a school construction authority of a city agency. The General Contractor was to provide prefabricated modular classrooms for the school construction authority. The lien claimant's claim was referred to as a public improvement lien against a city school project. The General Contractor was required to have a payment and performance bond through a reputable mutual surety casualty company. The claimant was close to approaching their one-year prerequisite deadline for filing against the payment bond. Many claimants file the payment bond prior and then don't have the perseverance and know-how to negotiate with the bond claim analyst or attorneys for the bonding companies to reach an agreement to settle the claim.

First, the mediator had to refile a proper proof of claim and submit it with all the relevant backup to the surety company. It is important for a mediator to preserve or perfect all of his client's lien rights to maintain leverage. Thus, a mediator should be thoroughly familiar with the various lien laws in each jurisdiction in which he operates. Telephone calls and faxes went out to the General Contractor and their Modular Mechanical Subcontractor notifying them that a proof of claim was refiled with the bonding company. While the proof of claim was taking its course through the bonding company, the mediator set up a meeting with the key executives and project managers of this project with the principals of both the Sheet Metal Subcontractor and the General Contractor.

The claimant had strong backup documentation that prompted the bonding company to ask for the position of their principal. The bonding company is supposed to conduct an independent impartial investigation of the bond claim. The mediator's actions involved reaching the nucleus of key individuals by telephone and fax, leading up to an onsite mediation meeting and walk-throughs at the construction site. After the key and crucial meetings with all the relevant parties at the city agency, the mediator felt an agreement could be reached.

The mediator repeatedly requested that the surety company's attorneys contact the project managers at the city agency and collaborate the results of their mediation meeting. The city agency informed the bonding company that the claim had merit and recommended payment by their principal. The General Contractor was aware that legal action was imminent, and also seeing that the lien could extend for a potential one-year, made the General Contractor accept the fact that in addition to losing the $70,000 dispute, it could also lose its relationship with the bonding company as well as its relationship with the specialty subcontractor (i.e., the one who hired the Sheet Metal Subcontractor claimant), who would be a third party in any potential legal action. Moreover, this specialty subcontractor had a design patent for prefabricating modular classrooms. All this leverage against the General Contractor weighted heavily in its decision to settle this public improvement lien claim for $50,000.

Again, the multiple relationship scenario involved bringing all the parties together in one sit down meeting, having the key executives at the city agency seek out the General Contractor's bonding company contacts and having the attorneys for the bonding company make recommendation for payment to the General Contractor to finalize and pay this lien claim. The entire mediation process took 2.5 months.

In one exemplary embodiment, stating Case Study No. 5—Foundations Subcontractor and Fee-Conscious Consulting Firm: A specialty subcontractor had a contract for superstructure concrete with a large construction manager working for a multi-billion-dollar health institution, such as a hospital. There were four integral parts of their total contract and four phases to the overall project. The claimant had been owed $1,406,395 for more than seven months. Thus, even with this substantial sum of money owed, the claimant was trying to resolve this matter in-house without an attorney. The total contract amount for the claimant was greater than $6 million dollars. They were thus owed almost ¼ of the total contract. The mediator sat down with the claimant for over two hours discussing their lien case and extracted a substantial file full of backup documentation.

The claimant had two sit-down mediation meetings prior to the mediator's involvement. It was important to convince the client that prior to a third sit down mediation meeting, the mediator would implement a series of actions to ensure that the third and final mediation meeting was conclusive. If the key individuals that are the facilitators of the construction project are unknown, then they should be determined. Upon identifying these project-related, and non-project-related, key executives, a uniform message by telephone and fax may be executed as first steps in positioning for a mediation meeting with the five to seven key project decision-makers. In this case, these individuals may be, but not limited to, the owner's representative and key executives, the project executives for the construction manager; the in-house attorney for the construction manager; the Director of Construction for a Maycer Center; or the Chief Financial Officer of the Maycer Center.

Also, the mediator knew that the subcontractors' principals should also be present at a mediation meeting. The documents were sent via courier to the individuals identified above and telephone calls were made to confirm their receipt of the hard copy documents and to extract their promises to call back and speak to the next in command. As a result, a meeting was set up with the mediation client. However, the meeting was only set up after a barrage of sending documents over a three-week period. It is often necessary to reinforce that a claimant has a valid lien claim and has completed their work. In the meeting, the owner's representatives emphasized discrepancies in the payroll records, but it was agreed upon that if the claimant could recreate specific records they could be paid their contract and change order balance. The mediator knew that if the owner's representatives and the independent construction consulting firm involved could delay the subcontractor in the payment process, they would. The consultant firm was fee-oriented, billing hourly, and the mediator had to push their buttons by exacerbating their relationship with their client. The mediator was warned not to call their client. The mediator not only called their client, but put together the argument in its letters questioning why the owner's representative has not recommended payment of the undisputed portion of this $1,406,395 claim.

In fact, common sense would cause one to wonder how could the entire $1,406,395 be disputed in its entirety. After digging deeply into the underlying reasons why the claimant was not getting paid, it turned out that the obstacle was an attorney working with the consulting firm; ultimately a settlement was reached for $988,000 to be paid in two installments. This allowed the claimant to provide the additional documentation that was necessary to get paid on the balance of its contract.

The relationship between the owner's representative and the hospital maycer center was exploited by one individual. This illustrates how a mediator should develop a sense as to who is holding up settlement discussions and what the impediments are. This matter was resolved without legal action. The mediation fee charged the claimant was a 6% contingency fee; while the lien case was highly collectible, identifying the obstacles and impediments was developed by proactive involvement in the entire process from start to finish.

In one exemplary embodiment, stating Case Study No. 6—Fireproofing Subcontractor: A Fireproofing Subcontractor was working for a General Contractor who went out of business. This project was a school construction authority project. There was a payment and performance bond in place. The bond company hired a new General Contractor to complete the project. There were many Subcontractors who were not paid their contract and change order balances. The Fireproofing Subcontractor was owed approximately $100,000. The key steps that facilitated a successful mediation were as follows. The mediator contacted the bonding company attorney, forwarding the relevant claim documentation. At the same time, the mediator contacted the General Contractor's project executives and forwarded all relevant claim documentation. The mediator also contacted the project executives at the school construction authority, and submitted a written claim to all three parties and a demand for payment. This spurred a dialogue between all parties and a meeting was set up between the Fireproofing Subcontractor, the General Contractor's principal partner and the Project Executives. This meeting lasted 1½ hours and resulted in settlement and eventual processing of a change order progress payment of $40,000 for the Fireproofing Subcontractor, all partial waivers and assignment documents being signed off at the mediation meeting. These documents were necessary because the surety company took over the project once the original General Contractor went of business.

The obvious step in this situation would have been to demand payment from the new General Contractor (that took over of the project from the surety company), make a demand for payment and then recommend legal action. Thus, the mediator executed non-obvious, creative and unique steps necessary to set up the meeting. This resulted in an agreed settlement among the parties and subsequent processing of the initial change order payment, with a written commitment as to when the balance would be paid and the approximate date when the retainage would be released.

In one exemplary embodiment, stating Case Study No. 7—Electrical Contractor: A mediator was hired by an Electrical Contractor that was a Subcontractor to a General Contractor who was engaged by a museum foundation. The General Contractor was required to have a payment and performance bond for the project. The amount of the lien claim was $40,111.

Initial contact was made on three fronts: the mediator contacted the attorney for the museum foundation, the mediator spoke with and sent a facsimile to the museum, the surety company agent received a call and a fax, and an immediate proof of claim was filed with the bonding company. Also, the General Contractor received a telephone call and a facsimile demand for payment and the director for the museum foundation received a telephone call and facsimile. All these steps were performed simultaneously, resulting in the General Contractor calling his Subcontractor, and offering $10,000 per month to pay off the debt. The mediator told his client not to accept this payment, due to the fact that the General Contractor had already obtained payment from the museum foundation. With the payment bond in place and everyone put on notice, subsequent faxes to the surety company and additional follow up conversations resulted in a letter from the surety company indicating that they would pay the claim if the claimant could produce a copy of liability insurance, updated payroll reports and a satisfaction of the filed mechanic's lien.

The obvious approach would have been a demand to the General Contractor, followed by legal action. The less obvious and creative approach according to the methods of the present invention involved sending several faxes to the museum, their foundation's attorney, the surety company's representative, the General Contractor and its principal, all with follow-up telephone calls. These actions resulted in a resolution of this lien claim within four weeks.

Case Study No. 8—HVAC Subcontractor: This claim involved a city housing authority that owed a claimant $225,000 for approximately one year. The claimant serviced seventy buildings for the housing authority, doing sewer and HVAC work (including the installation of air conditioning units), and they had maintenance and service contracts with the city housing authority. The housing authority had changed computer systems, resulting in vendors not getting paid due to information being lost in the system. The mediator's initial approach was to acquire all the documentation (which involved over 500 documents) that substantiated the claim. The mediator contacted the Deputy Director of Physical Compliance for the housing authority by telephone and fax, and forwarded documentation by overnight delivery. The mediator also contacted by facsimile and telephone the Deputy Director of Disbursements, and the Director of Community Operations. Subsequently, simultaneous follow-ups to all the related parties resulted in a check being processed for $710,000. The mediator was told that it would take three weeks to process a check and they insisted on mailing the check. The mediator then had the claimant write a letter to the Director of Disbursements, the Accounting Manager of Community Operations called and it was arranged for the check to be provided. The check processing took three days and the total time to mediate this claim was two weeks. The obvious steps would be to sue this city agency, the non-obvious, unique approach was to fax and speak to this small group of individuals and ask them to assist you in the process of getting your client paid. This case illustrates how when dealing with a regulated agency the diplomatic approach often works best.

In one exemplary embodiment, stating Case Study No. 9—Drywall Subcontractor and Diversion of Funds Leverage: The claimant was a Drywall Subcontractor hired by a General Contractor, and the end user was a public health laboratory in a city hospital system. There was a Construction Manager that was overseeing this project. The claim amount was $156,125.90. The claimant's attorney filed a proof of claim with the bonding company. This initial step was ineffective and the claimant opted not to be the obvious step of legal action because that would be lengthy and cost prohibitive. The mediator developed a strategy that would produce the money without legal action. A preliminary investigation revealed that the General Contractor had in fact been paid by their client several months ago.

The mediator determined that this was not just a normal filing of a proof of claim. This case involved a diversion of funds issue. The first of a series of creative steps started with a facsimile to the attorney handling this claim that this was a diversion of funds issue that and the bonding company must pay this claim promptly.

After several calls and faxes to the attorney handling the claim at the bonding company, the mediator received no response, however the attorney for the bonding company notified the client's attorney that filed the claim. The mediator was thus circumvented and requested the claimant to have their attorney send a representation letter to the attorney for the bonding company that they must contact the mediator with respect to the referenced claim.

Now having full control of this claim, the mediator sent a second facsimile to the Claims Manager outlining the claim with relevant backup. The Mediator sent a third fax to the Vice President of Operations and spoke with this person outlining the diversion of funds issue. The mediator set a fourth fax to the President/CEO of the surety company; the mediator lodged a presidential complaint and called his Executive Assistant. The mediator simultaneously sent a fifth facsimile to the CFO for the General Contractor, informing him to remit payment or the mediator would be forced to obtain payment from their bonding company. After this simultaneous barrage of pages and telephone calls, the mediator knew the bonding company had to pressure the principal or the General Contractor to pay the claim.

The mediator received a telephone call from the Claims Manager for the bonding company that a check would be sent from the bonding company to the claimant's attorney. This promise of a check became tied up in a partial lien waiver document, due to legal language that favored the General Contractor. The mediator had to thus implement one final non-obvious step. In a diversion of funds matter the surety has to be impartial, and after their investigation, pay the claim. The mediator contacted by telephone and facsimile the Vice President of Internal Investigations for the surety company and their final step motivated the bonding company to give an ultimatum to their principal to release the check to the Attorney for the Subcontractor.

In one exemplary embodiment, stating Case Study No. 10—Masonry Subcontractor: A Masonry Subcontractor was owed $109,600 by a General Contractor who worked for a school district in Long Island, N.Y. An engineering firm and a Construction Manager controlled the project. The conventional and obvious step to resolve this claim was to make a demand for payment with the General Contractor and recommend legal action if that did not work. The non-obvious unique steps and strategies that were implemented involved the following actions. The mediator first contacted the school system and wrote a letter to the Assistant Superintendent of Schools and requesting that they evaluate the claim and review all of the supporting documentation that the mediator enclosed. The mediator also requested a two party check. The mediator also simultaneously contacted the engineering firm by facsimile and telephone and requested that they intervene and evaluate my client claim for payment. The mediator also simultaneously contacted the clerk at the school district that parades the information to related subcontractors on the project, the name of the payment and performance bond or surety that levies this project.

After the mediator reviewed this information, he filed a proof of claim with the bonding company of record, demanded payment and; sent a demand letter to the engineering firm and Architect for the project. Further, the mediator called and faxed the demand to all the related parties simultaneously. The mediator also contacted the Supervisor of Accounts Payable for the school district and requested payment by written demand along with supporting documentation.

The General Contractor's Controller had submitted incorrect payment requisitions to the school district. This was the primary reason that the claimant had not been paid. The mediator submitted supporting documentation in conjunction with follow up calls to: 1) The Architect; 2) The Bonding Company; 3) The School System; 4) The Construction Manager; 5) The Engineering Company; and 6) The General Contractor.

This leveraged the General Contractor into a position of settlement for $75,000. This resolution was accomplished without legal action. The mediator made the General Contractor's various business associates and relationships aware of this claim by sending key letters and faxes and telephone calls to the key decision makers of all the concerns with whom the General Contractor had an ongoing business relationship.

As noted above, in exemplary embodiments of the present invention the construction mediation claim business may be operated by implementing the methods of the present invention. Such a business could, for example, be a standalone business or a franchise with a franchisor providing support to it. In exemplary embodiments of the present invention such a business may, for example, utilize an expert system, as described above, to help practitioners organize each case, automatically generate the necessary documentation used in handling a case, and provide analysis and possible strategies as well as investigation data form a central database operated by the franchisor.

Submitted herewith as further illustration of the methods and systems of exemplary embodiments according to the present invention are a number of appendices from an exemplary franchise implementation of the present invention. The exemplary franchiser is listed as “COMED Construction Mediation Solutions” of New York, N.Y., and the appendices are various exemplary manuals that may be provided to prospective franchisees explaining the methods and practice of the present invention. The appendices thus elaborate upon the description of the methods of the present invention provided above, and provide sample forms and scripts for prospective users/mediators to use according to various exemplary embodiments of the present invention. The appendices are thus fully incorporated herein by this reference as if fully set forth herein. The appendices are described in a cover sheet which precedes them, and delineates what each appendix contains.

The present invention has been described in connection with exemplary embodiments and implementations, as examples only. It will be understood by those having ordinary skill in the pertinent art that modifications to any of the embodiments or preferred embodiments may be easily made without materially departing from the scope and spirit of the present invention which is defined by the appended claims.

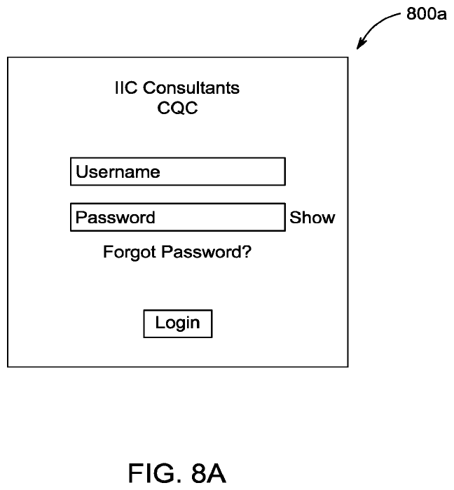

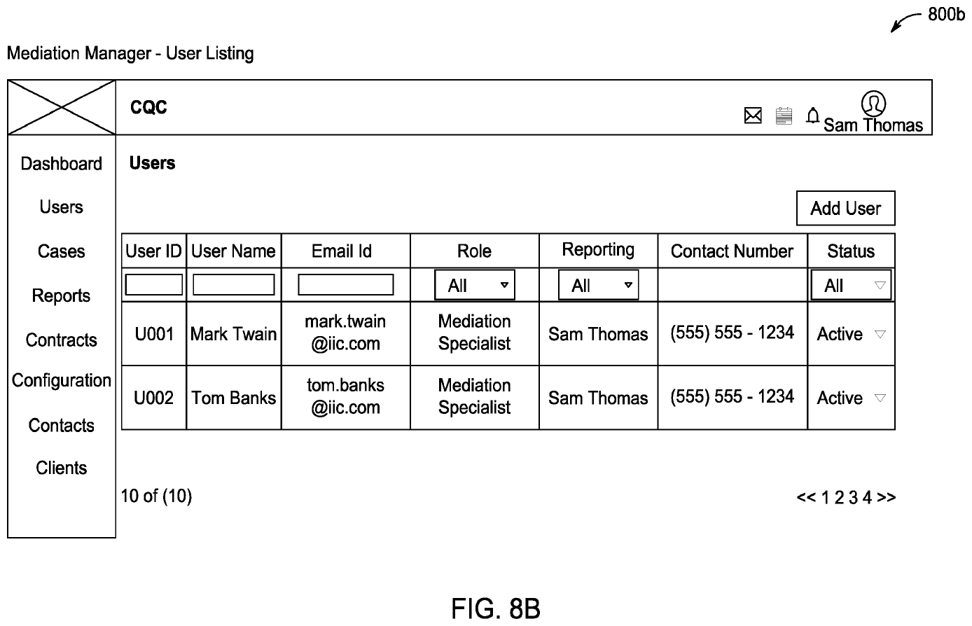

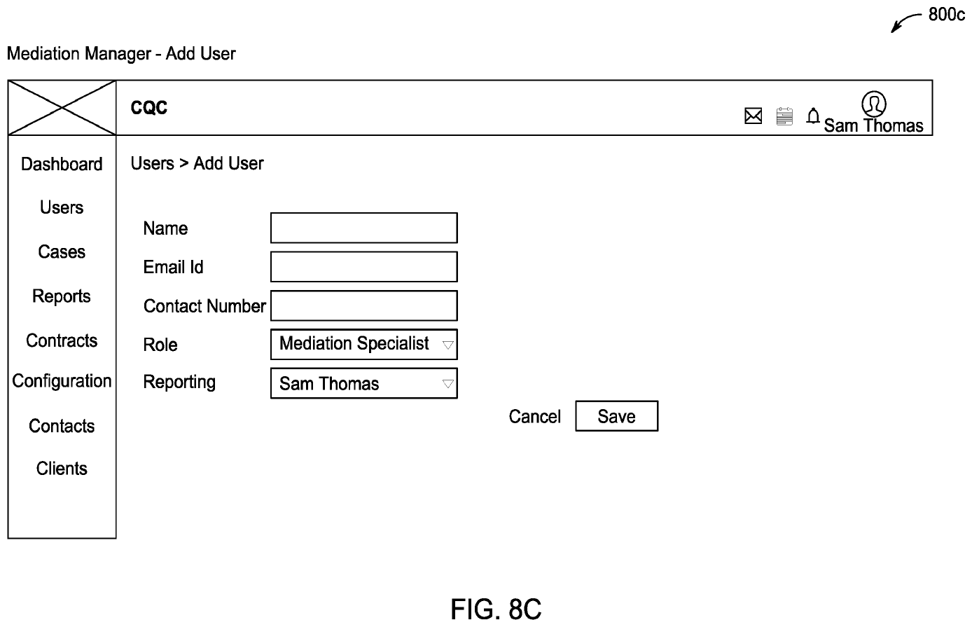

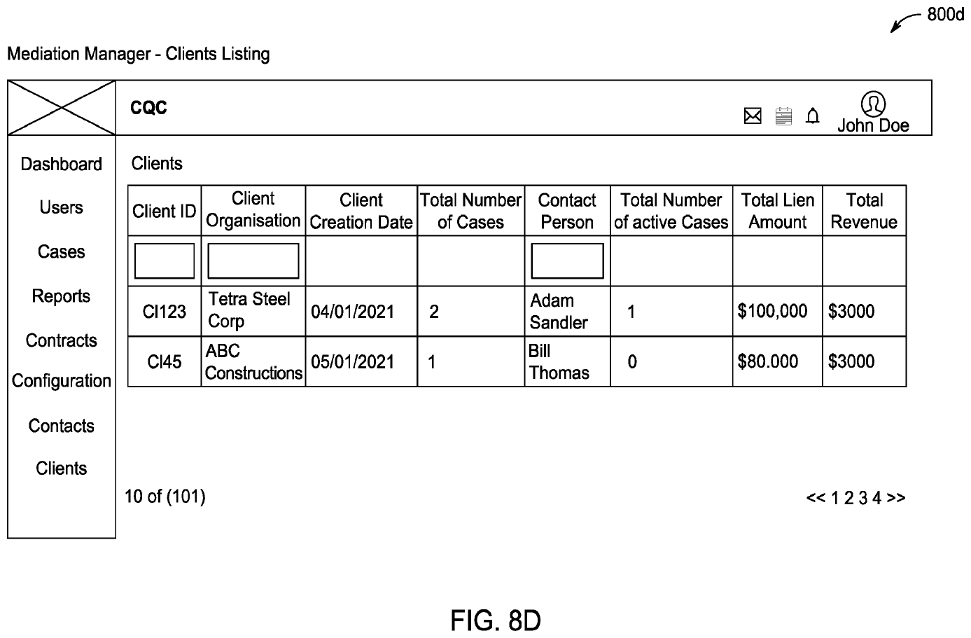

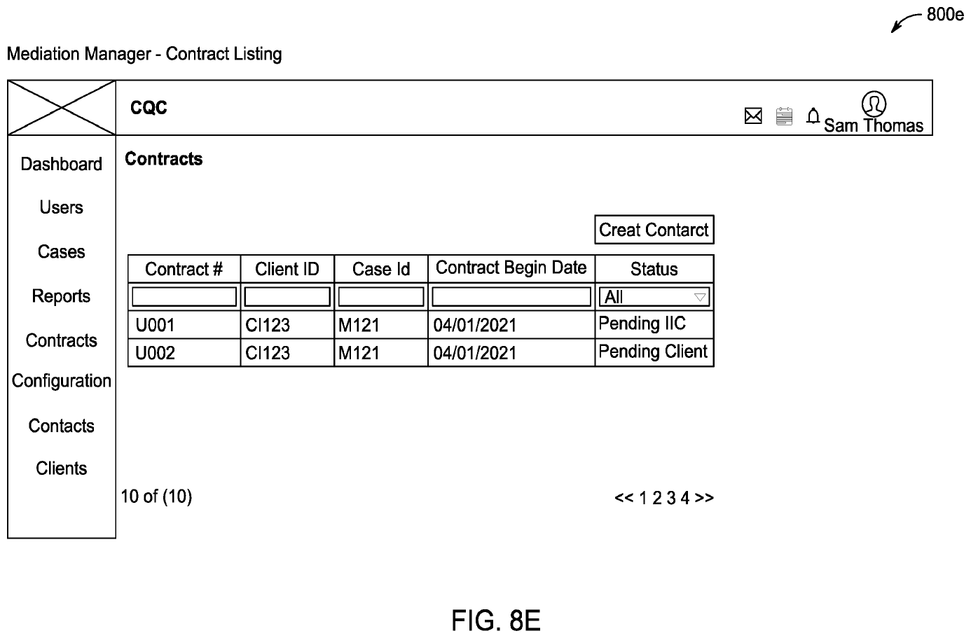

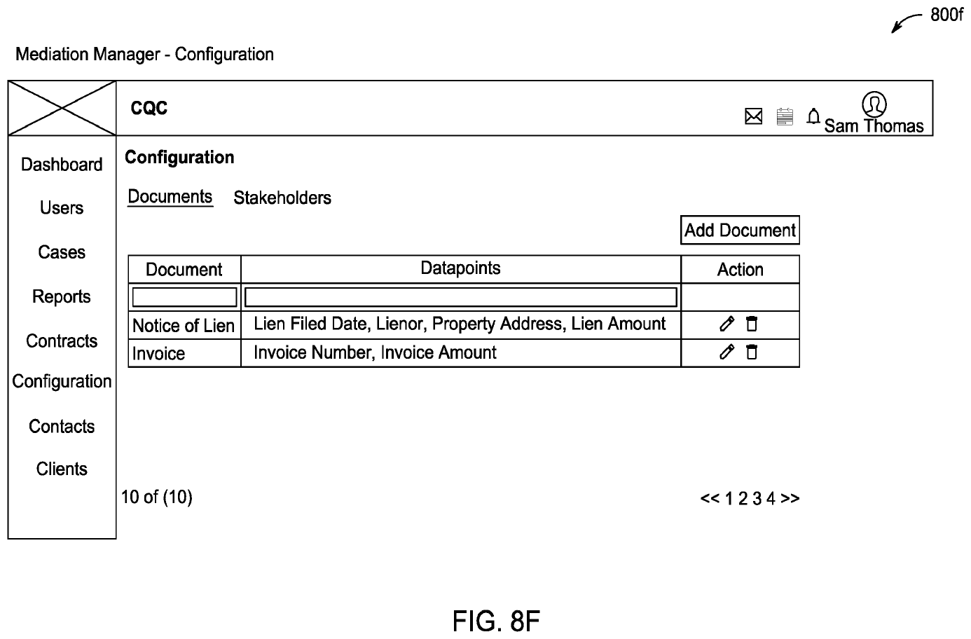

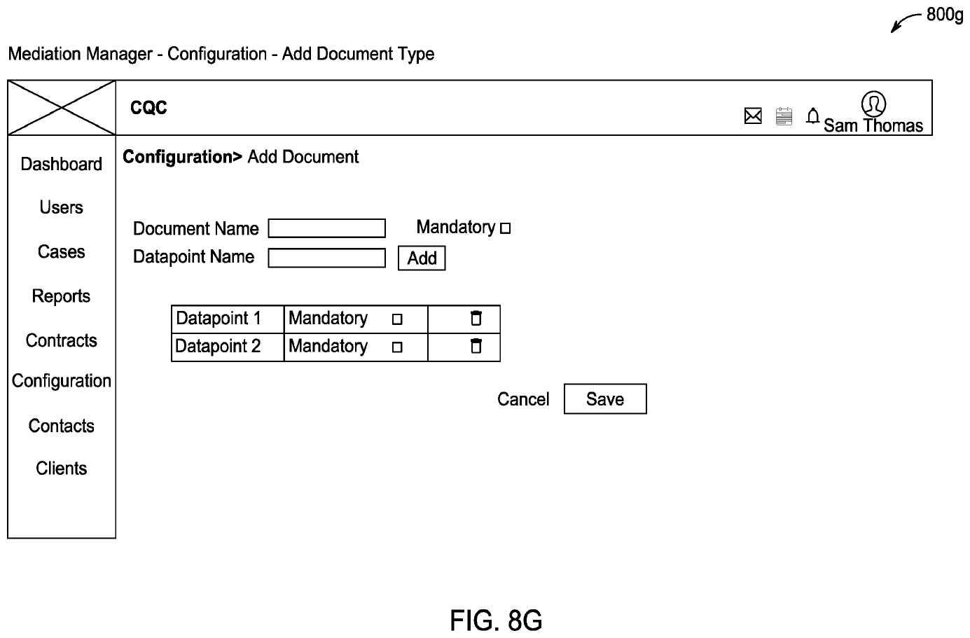

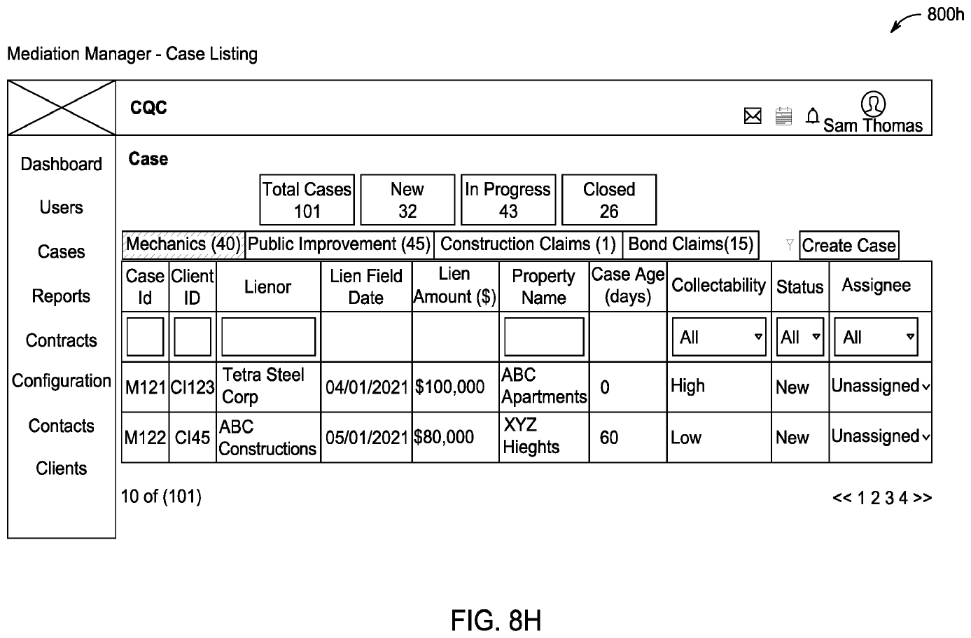

FIG. 8A illustrates a login page 800a for a case management system, according to an embodiment of the present disclosure. The login page 800a shows username and password options to login into the case management system.

FIG. 8B illustrates a mediation manager page 800b showing user listing within the case management system, according to an embodiment of the present disclosure. The mediation manager page 800b showing the user listing includes, but may not be limited to, user ID, User Name, Email ID, Role, Reporting, contact number, and status. In an example, the mediation manager page 804 showing the user listing with username i.e. Mark Twain, user ID i.e. U001, email ID i.e. mark.twain@iic.com, role i.e. Mediation Specialist, reporting i.e. Sam Thomas, contact number i.e. (555) 555-1234, and active status.

FIG. 8C illustrates the mediation manager page 800c showing add users within the case management system, according to an embodiment of the present disclosure. The mediation manager page 800c showing add users include options, such as, name, email ID, contact number, role, and reporting. Further, the user may switch between the dashboard, users, cases, reports, contracts, configuration, contacts, and clients window.

FIG. 8D illustrates the mediation manager page 800d showing clients listing within the case management system, according to an embodiment of the present disclosure. The mediation manager page 800d showing clients listing include, but may not be limited to, client ID, client organization, client creation date, total number of cases, contact person, total number of active cases, total lien amount, and total revenue. For example, for client Tetra Steel Corp, with client creation date of Apr. 1, 2021, with total number of cases as 2, contact person as Adam Sandler, a total lien amount of $1,00,000, and a total revenue of $3000.

FIG. 8E illustrates the mediation manager page 800e showing contract listing within the case management system, according to an embodiment of the present disclosure. The mediation manager page 800e showing contract listing includes, but may not be limited to, contract ID, client ID, case ID, contract begin date, and status.

FIG. 8F illustrates the mediation manager page 800f showing configuration page within the case management system, according to an embodiment of the present disclosure. The mediation manager page 800f showing configuration page includes, but may not be limited to, document, datapoints, and action. Further, the document may be, notice of lien and invoice. Furthermore, the document related to the notice of lien includes, lien filed date, lien or, property address, lien amount. Furthermore, the document related to the invoice includes, invoice number, invoice data, and invoice amount.

FIG. 8G illustrates the mediation manager page 800g for configuring a document type within the case management system, according to an embodiment of the present disclosure. The mediation manager page 800g to configure the document type includes, but may not be limited to, document name, and data-point name.

FIG. 8H illustrates the mediation manager page 800h showing case listing within the case management system, according to an embodiment of the present disclosure. The mediation manager page 800h showing case listing allows to select a type of lien case. The type of lien case includes mechanics, public improvement, construction claims, and bond claims. The client listing includes, but may not be limited to, case ID, client ID, lien or, lien filed date, lien amount, property name, case age (days), collectability, status, and assignee.

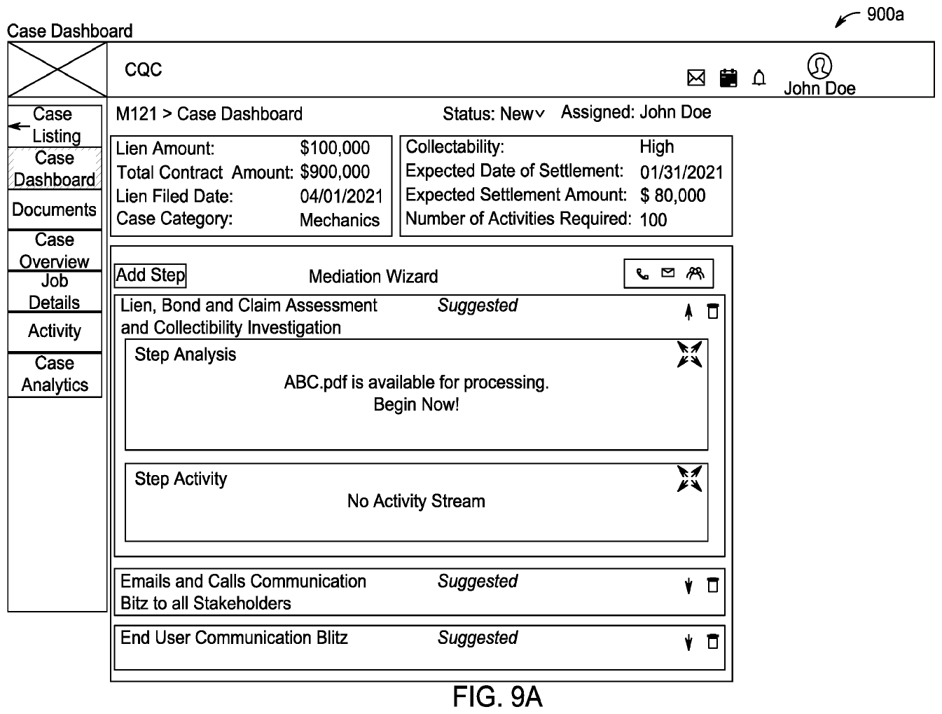

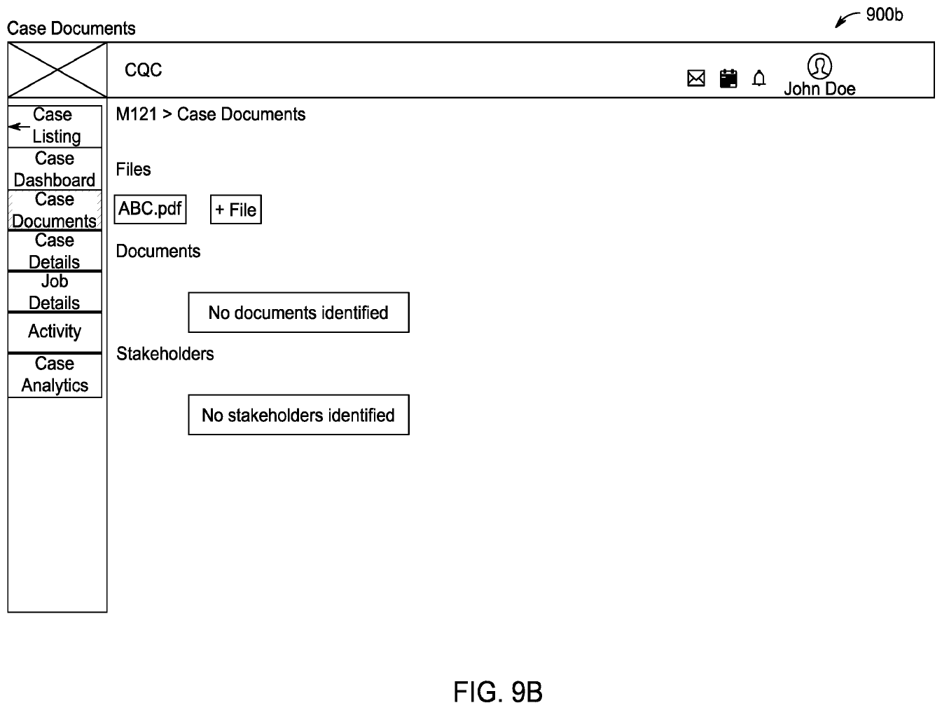

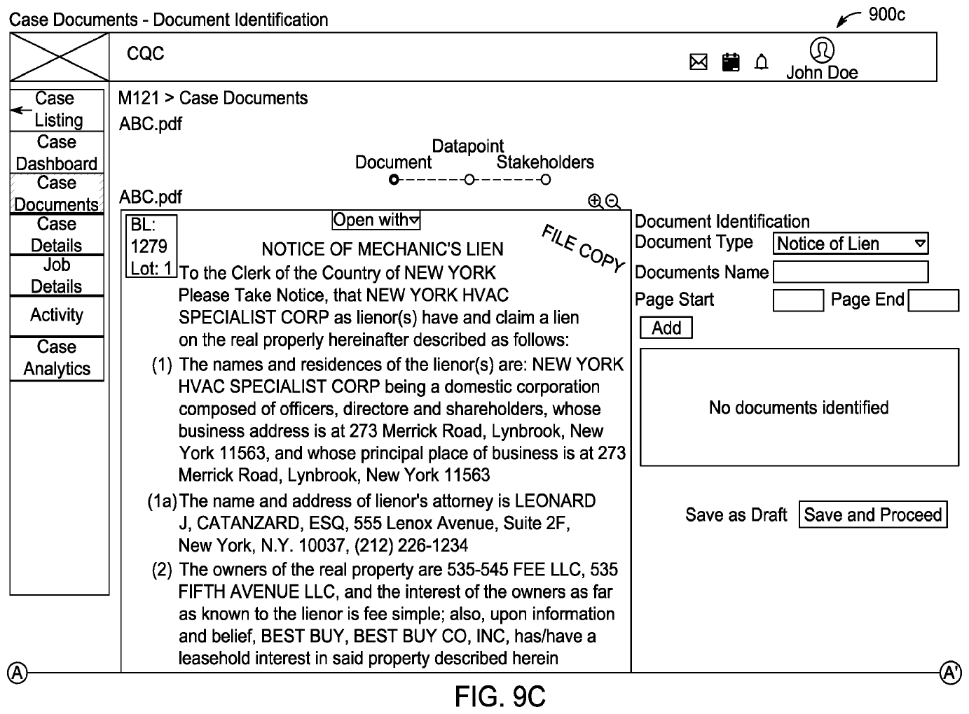

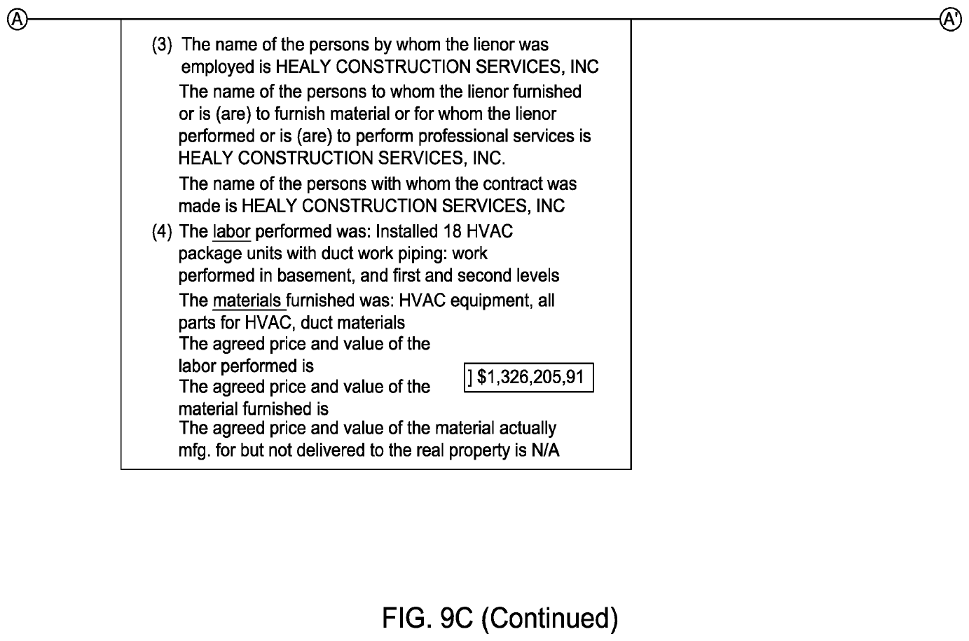

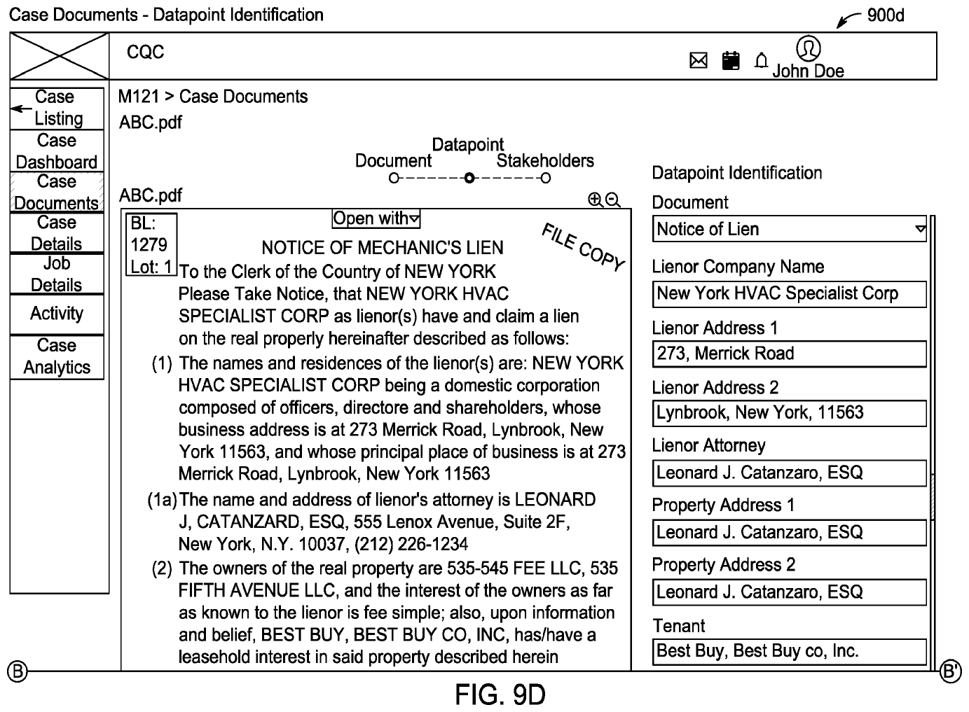

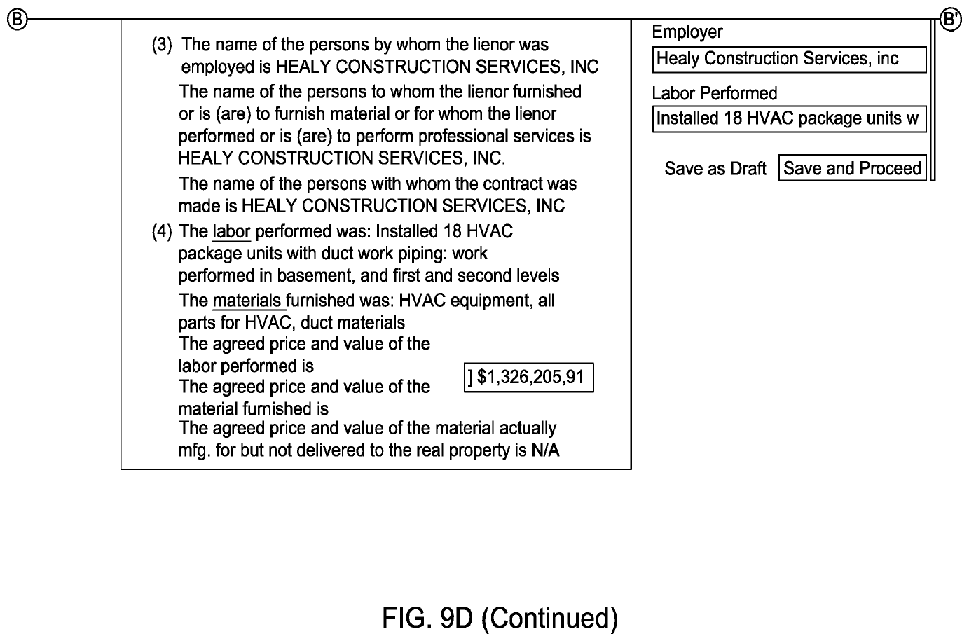

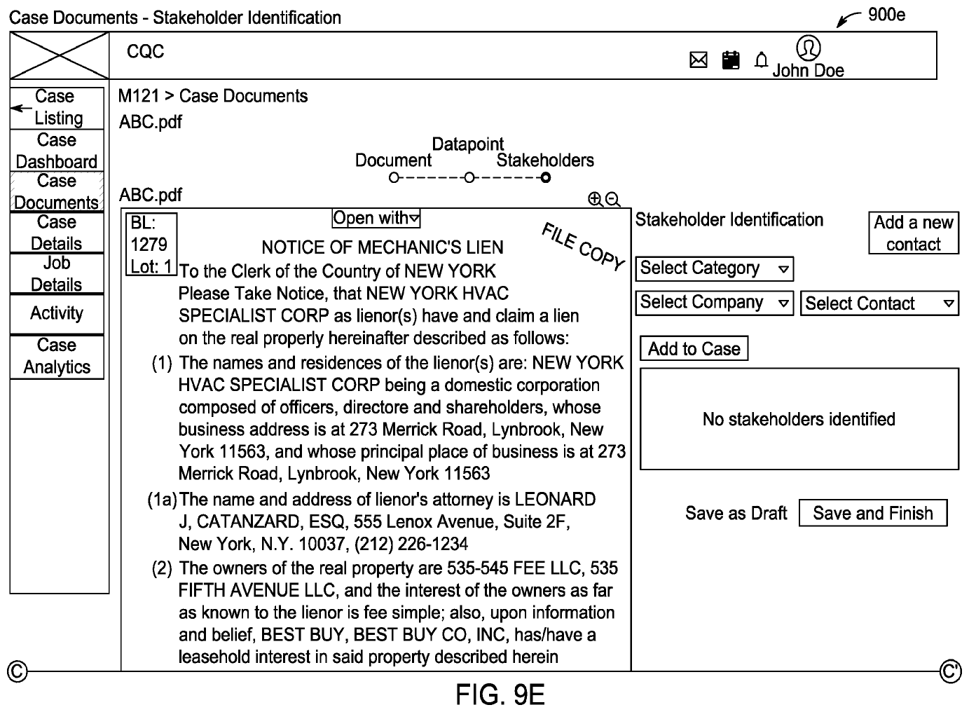

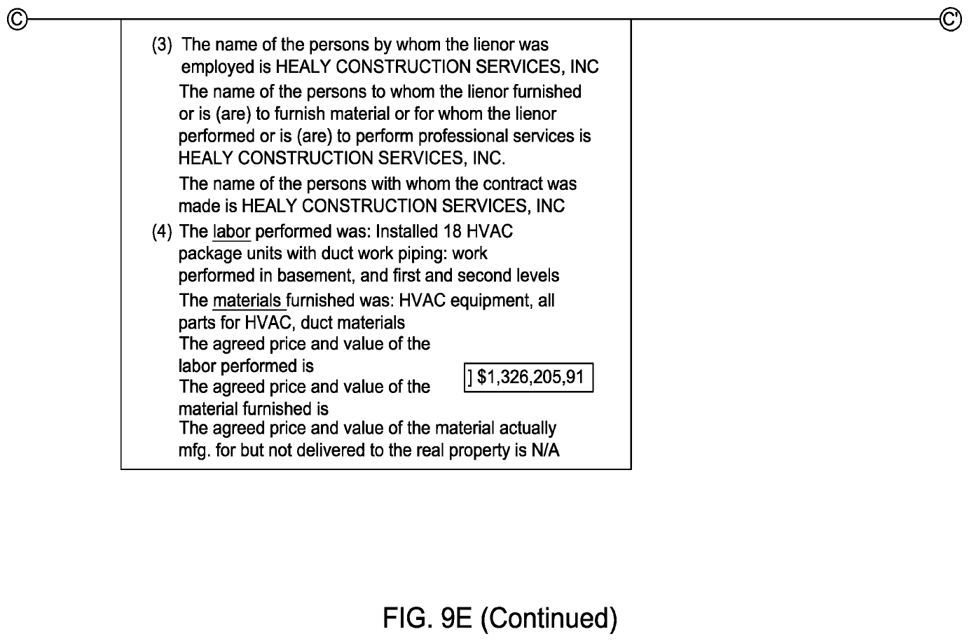

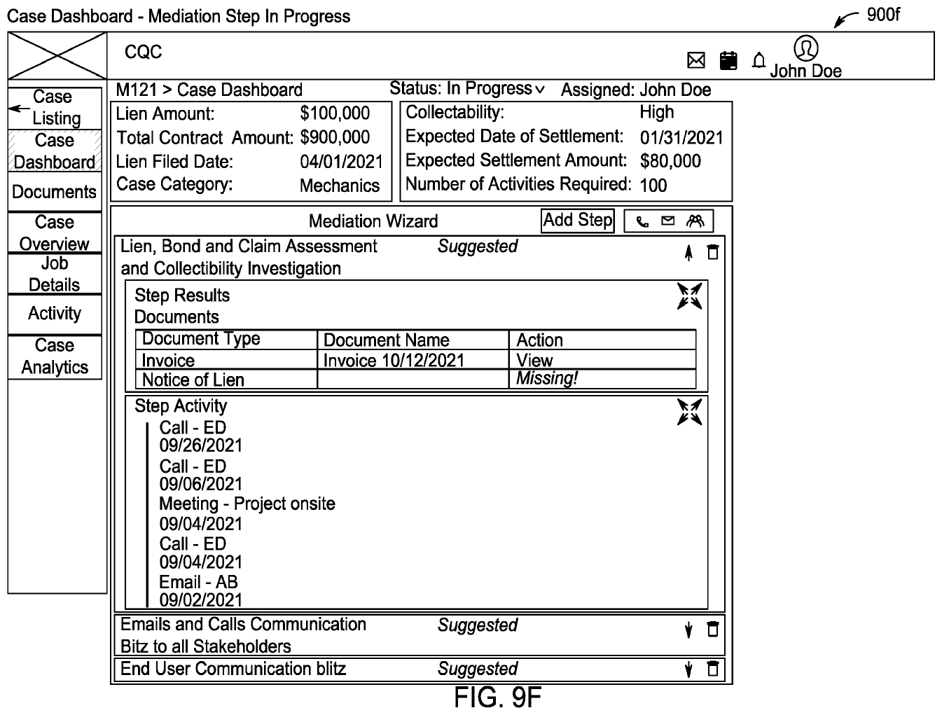

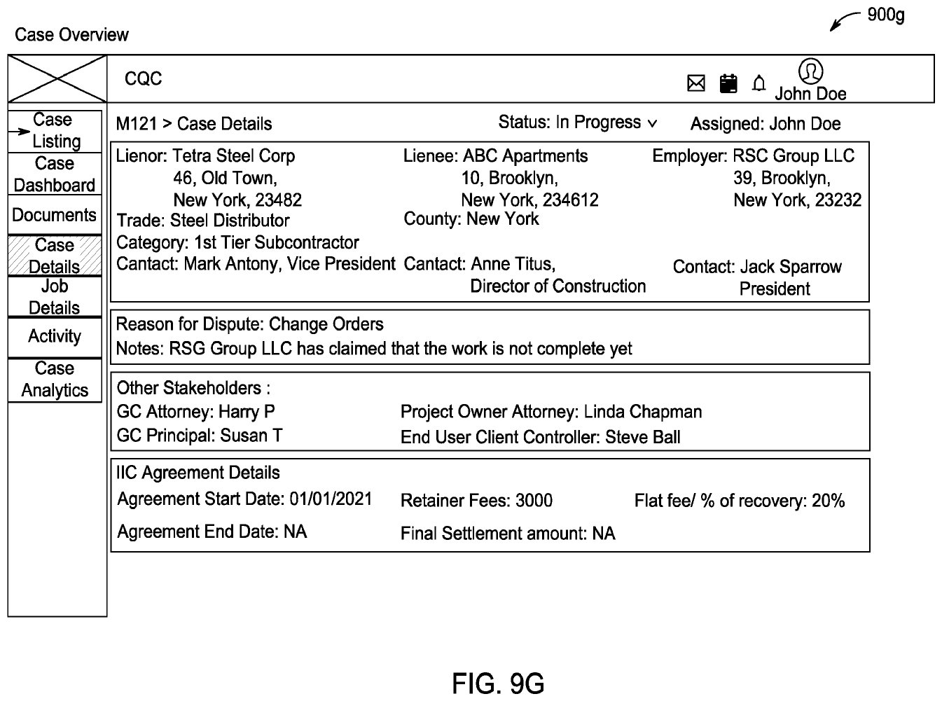

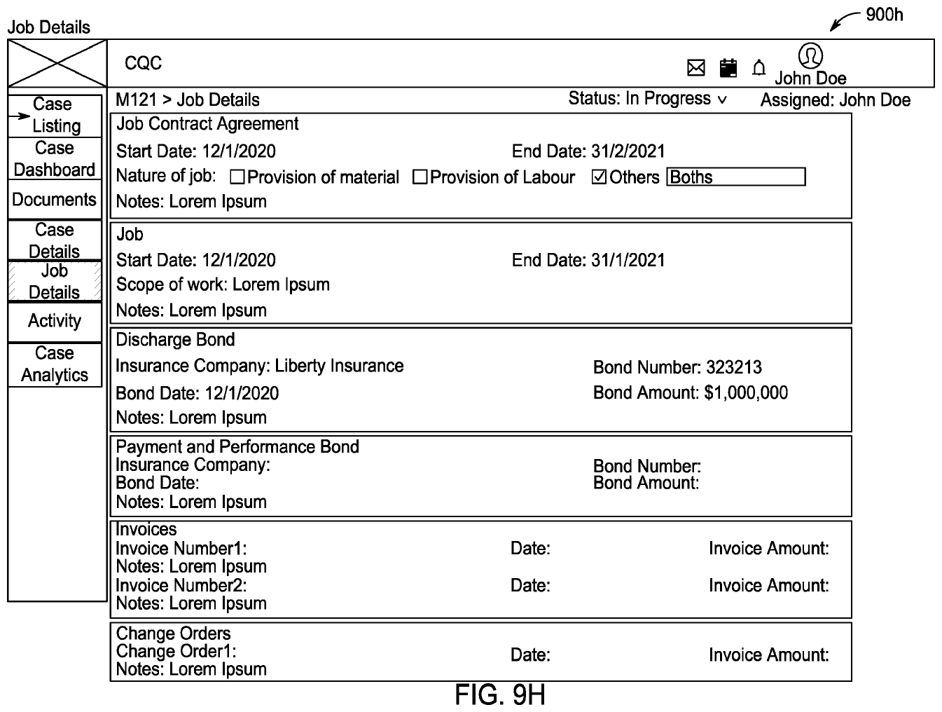

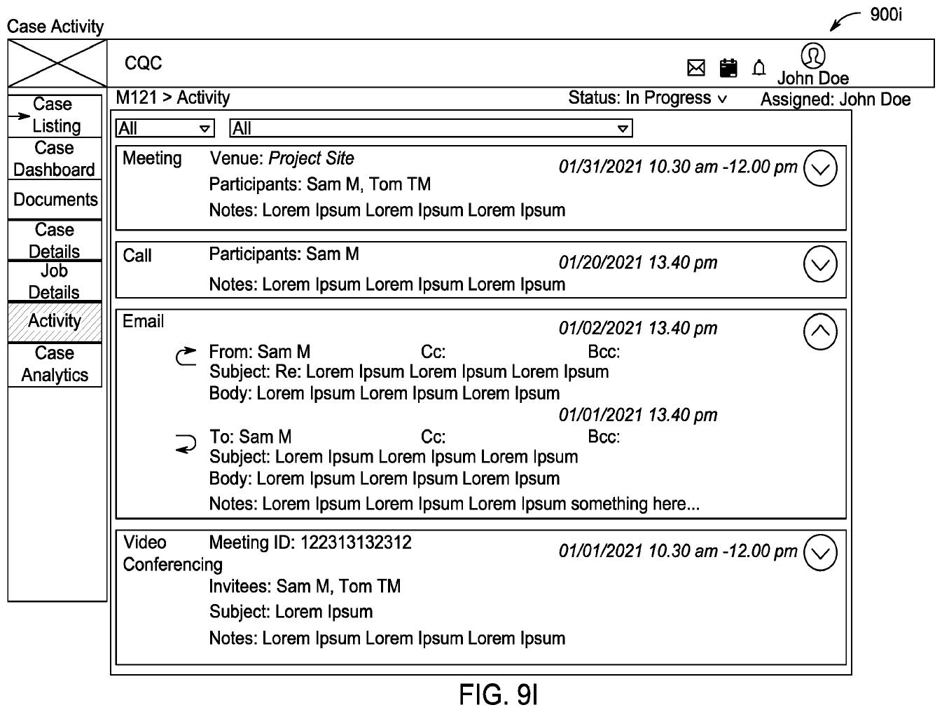

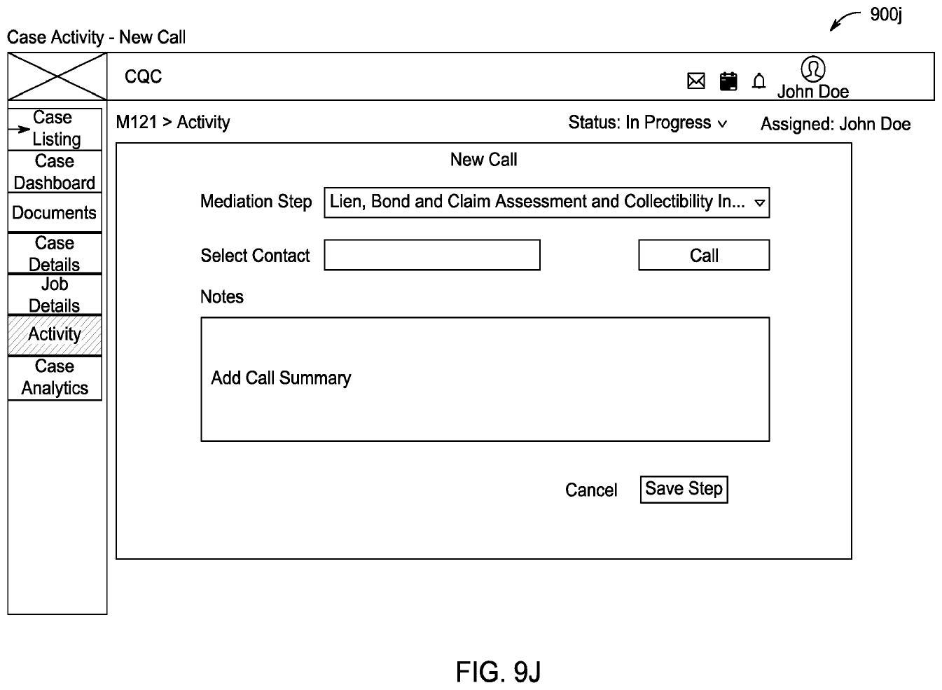

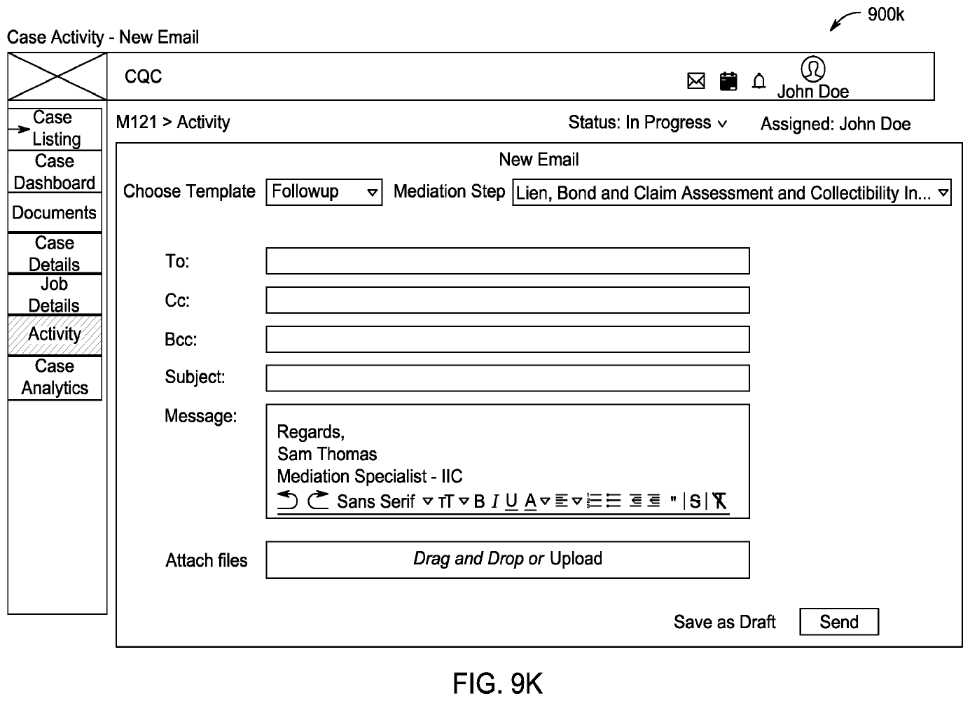

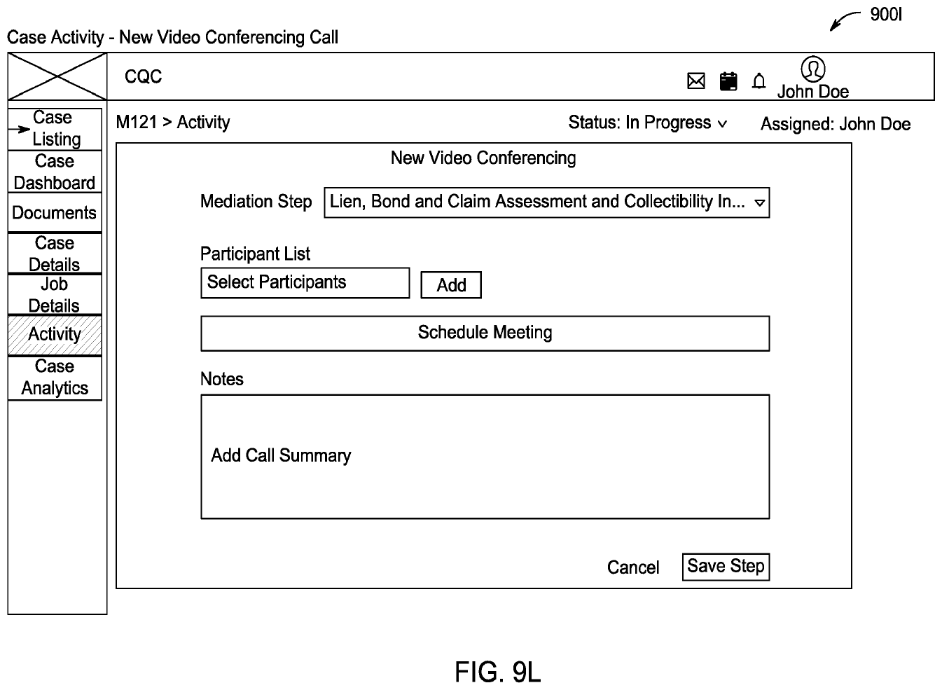

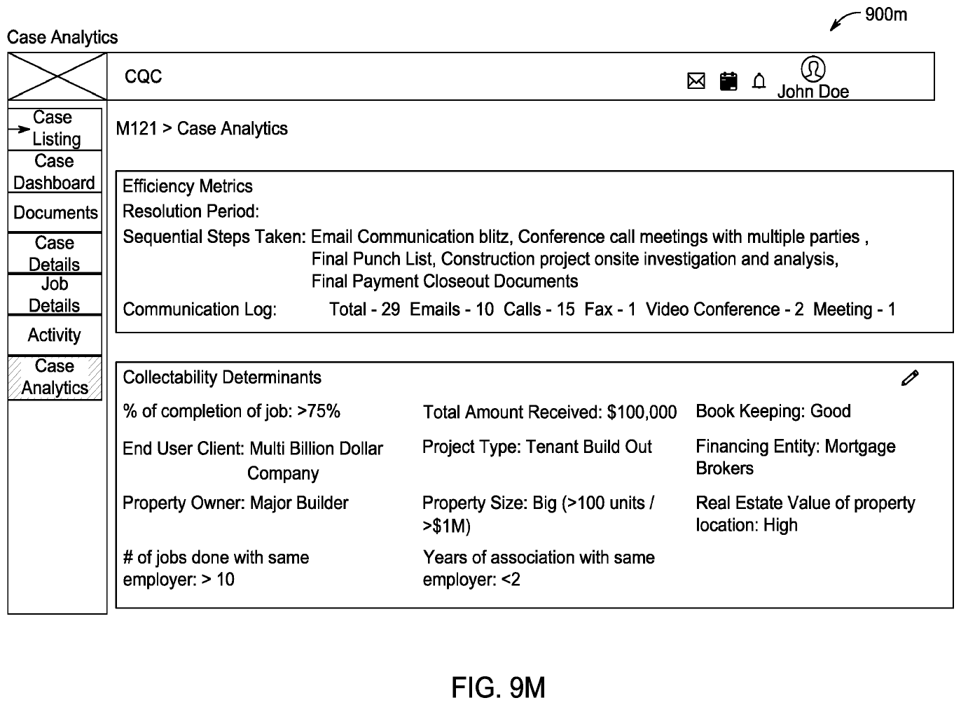

FIG. 9A illustrates a case dashboard 900a within the case management system, according to an embodiment of the present disclosure. The case dashboard 900a of the case management system includes, but may not be limited to, lien amount, total contract amount, lien filed date, case category, collectability, expected date of settlement, expected settled amount, and number of activities required. It can be noted that the case dashboard 900a may show a step analysis to the user. Further, the case dashboard 900a may show step activity to the user.

FIG. 9B illustrates the case dashboard 900b showing case documents within the case management system, according to an embodiment of the present disclosure. The case documents include files, documents, stakeholders, and the like. Further, the case dashboard 900b may show the identified documents or identified stakeholders related to a particular case.

FIG. 9C illustrates the case dashboard 900c showing document identification within the case management system, according to an embodiment of the present disclosure. The case dashboard 900c showing document identification of the case documents includes, document type, document name, page start, page end, and the like.

FIG. 9D illustrates the case dashboard 900d showing datapoint identification of the case documents within the case management system, according to an embodiment of the present disclosure. The case dashboard 900d showing datapoint identification of the case documents includes, document, lienor company name, lienor address 1, lienor address 2, lienor attorney, property address 1, property address 2, tenant, employer, labor performed, and the like.

FIG. 9E illustrates the case dashboard 900e showing stakeholder identification of the case documents inside the case management system, according to an embodiment of the present disclosure. The cash dashboard 900e showing stakeholder identification of the case documents includes, options to select category and to select contact.

FIG. 9F illustrates the case dashboard 900f showing progress in a mediation step within the case management system, according to an embodiment of the present disclosure. Further, the case dashboard 900f may display a lien amount, total contract amount, lien filed date, case category, collectability, expected date of settlement, expected settlement amount, and number of activities required. Further, the case dashboard 900f may display the step results and the step activity related to a selected case.

FIG. 9G illustrates a case overview 900g within the case management system, according to an embodiment of the present disclosure. The case overview 900g includes, but may not be limited to, lienor, lienee, employer, trade, category, contact of lienor, contact of lienee, contact of employer, reason for dispute, other stakeholders, and agreement details. In an example, let's assume the case overview details show below: 1). Lienor-tetra steep Corp., 46, old town, New York, 23482; 2). Lienee-ABC apartments 10, Brooklyn, N.Y., 234612; 3). Employer-RSC Group LLC 39, Brooklyn, N.Y., 23232; 4). Trade-Steel Distributor; 5). Category-1^{st} Tier Subcontractor; 6). Lienor contact: Mark Antony, Vice President; 7). Lienee contact: Anne Titus, Director of Construction; 8). Employer contact: Jack Sparrow, President; 9). Reason of Dispute: Change Orders include notes: RSC Group LLC has claimed that the work is not complete yet; 10). Other stakeholders: GC Attorney: Harry P, GC Principle: Susan T, Project Owner Attorney: Linda Chapman, End User Client Controller: Steve Ball; and 11). Agreement Details: Agreement Start Date: Jan. 1, 2021, retainer fees: 3000, Flat fee % of recovery: 20%, Agreement End Date: NA, and Final settlement amount: NA.

FIG. 9H illustrates job details page 900h within the case management system, according to an embodiment of the present disclosure. The job details page 900h includes, job contract agreement, job details, discharge bond, payment and performance bond, invoices, and change order details. In an example, the job contract agreement includes start date, end date, and nature of job. Further, the nature of jobs includes provision of material, provision of labour, and others. In an example, job details include start date, end date and scope of work. In an example, the discharge bond includes details regarding insurance company, bond number, bond date, and bond amount. In an example, the payment and performance bond includes details regarding insurance company, bond number, bond date, and bond amount. In an example, invoices include details regarding invoice number 1 with date and invoice number 2 with date. In an example, the change orders include details regarding change order 1 with date.

FIG. 9I illustrates a case activity page 900i within the case management system, according to an embodiment of the present disclosure. The case activity page 900i includes details related to meetings, calls, emails, and video conferencing. In an example, details regarding meeting includes venue, participants, and notes section. In an example, details regarding calls include participants and notes section. In an example, details regarding emails include email sent from i.e. name, subject, and body. Further, details regarding emails include email sent to i.e. name, subject, and body. In an example, details regarding video conferencing include meeting ID, invitees, subject, and notes section.

FIG. 9J illustrates the case activity page 900j depicting a new call feature within the case management system, according to an embodiment of the present disclosure. In an embodiment of the present disclosure, the new call feature allows the mediation manager to select mediation step and contact number along with notes section to add call summary. In an example, the mediation step selected by the mediation manager includes lien, bond and claim assessment and collectability investigation.

FIG. 9K illustrates the case activity page 900k depicting a new email feature within the case management system, according to an embodiment of the present disclosure. In an embodiment of the present disclosure, the new email feature allows the mediation manager to choose template and mediation step. The new email feature includes details regarding email to, cc, bcc, subject, message, attach files, and send button. The mediation manager may attach files using drag and drop or upload. Also, the mediation manager may save email as draft.

FIG. 9L illustrates the case activity page 900l depicting a new video conferencing feature within the case management system, according to an embodiment of the present disclosure. The new video conferencing feature allows the mediation manager to, select mediation step, add participant list, schedule meeting, and add notes.

FIG. 9M illustrates the case analytics page 900m within the case management system, according to an embodiment of the present disclosure. The case analytics page 900m includes efficiency metrics. The efficiency metrics include resolution period, sequential steps taken, and communication log. Further, the sequential steps taken includes, email communication blitz, conference call meetings with multiple parties, final punch list, construction project onsite investigation and analysis, final payment closeout documents. The case analytics page 900m includes collectability determinants. The collectability determinants include, but may not be limited to, % of completion of job: >75%, end user client, property owner, # of jobs done with same employer: >10, total amount received, project type, property size: Big (>100 units/>$1M), years of association with same employer: >10, book keeping, financial entity, and real estate value of property location.

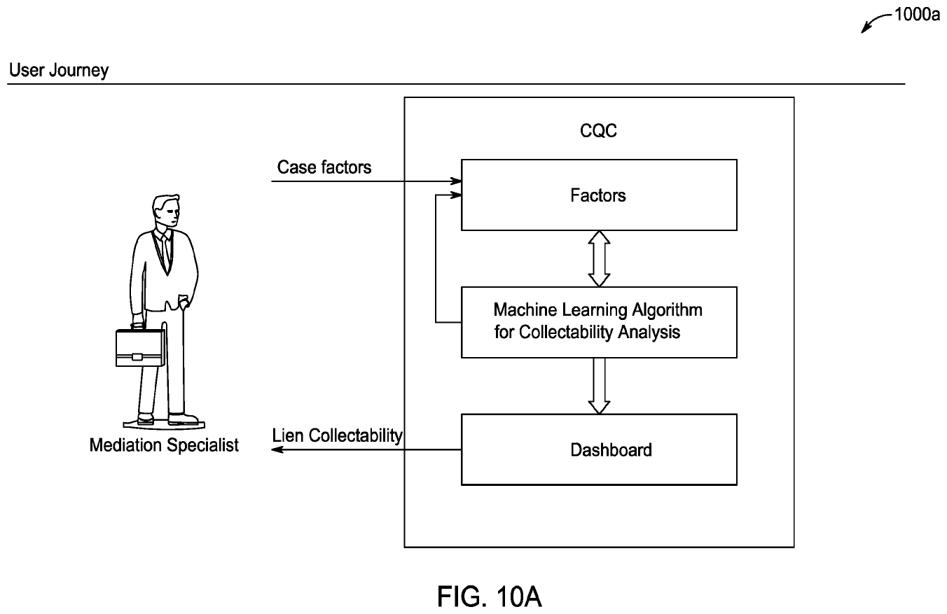

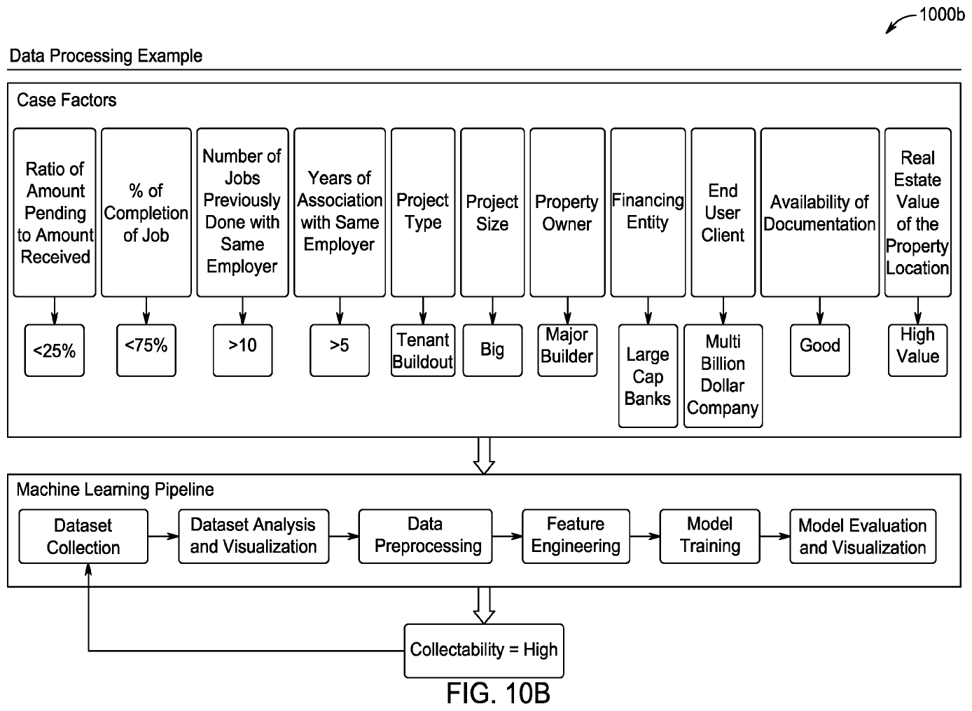

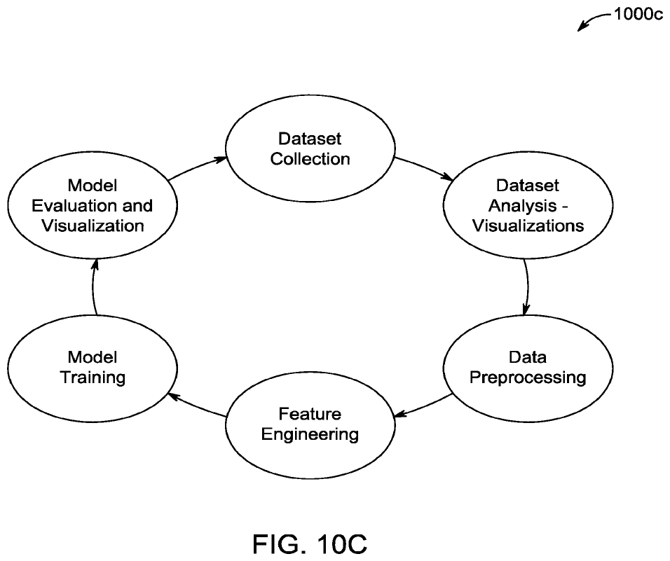

FIG. 10A illustrates an overview 1000a of a lien collectability assessment using a lien collectability algorithm, according to an embodiment of the present disclosure. The lien collectability assessment is performed by applying case factors to a machine learning algorithm for collectability analysis. The machine learning algorithm for collectability assessment renders lien collectability of a mediation specialist. Further, a dashboard, as described above may be used to deduce or obtain the lien collectability. In one embodiment, a mediation specialist may provide the case factors and finally obtain the lien collectability.

FIG. 10B illustrates another overview 1000b of the lien collectability assessment shown using data processing example, according to an embodiment of the present disclosure. The data processing example shows that the case factors are received by a machine learning pipeline. It can be noted that the case factors may include, but are not limited to the ratio of amount pending to the amount received, percentage of completion of job, number of jobs previously done with same employer, years of association with same employer, project type, property owner, project size, end user client, availability of documentation, and real estate value of the property location. Further, the machine learning pipeline performs one or more steps on the received case factors. The one or more steps include, data collection, dataset analysis and visualization, data processing, feature engineering, model training, and model evaluation and visualization.

FIG. 10C illustrates a flow diagram 1000c depicting the lien collectability assessment, according to an embodiment of the present disclosure. The lien collectability assessment helps a Mediation Specialist in identifying and prioritizing cases that have high resolution chances and thus enabling a more efficient case resolution process. In an example, the Lien Collectability is defined as the probability of a lien concluding in a resolution. The machine learning algorithms categorizes each case's collectability into either one of the three categories i.e. high, medium, and low. In one embodiment, the flow diagram 1000c may perform the steps of dataset collection, dataset analysis visualizations, data preprocessing, feature engineering, model training, model evaluation and visualization, and repeating by obtaining new dataset collection.

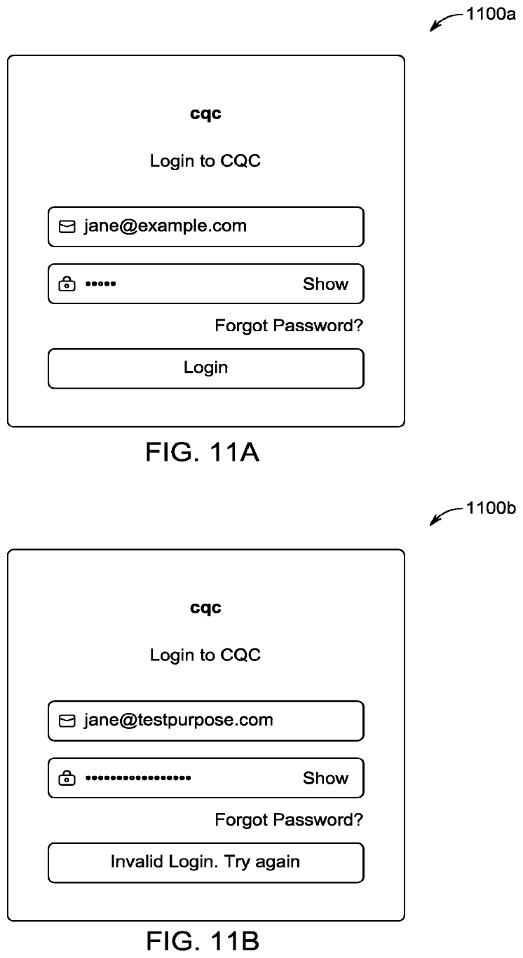

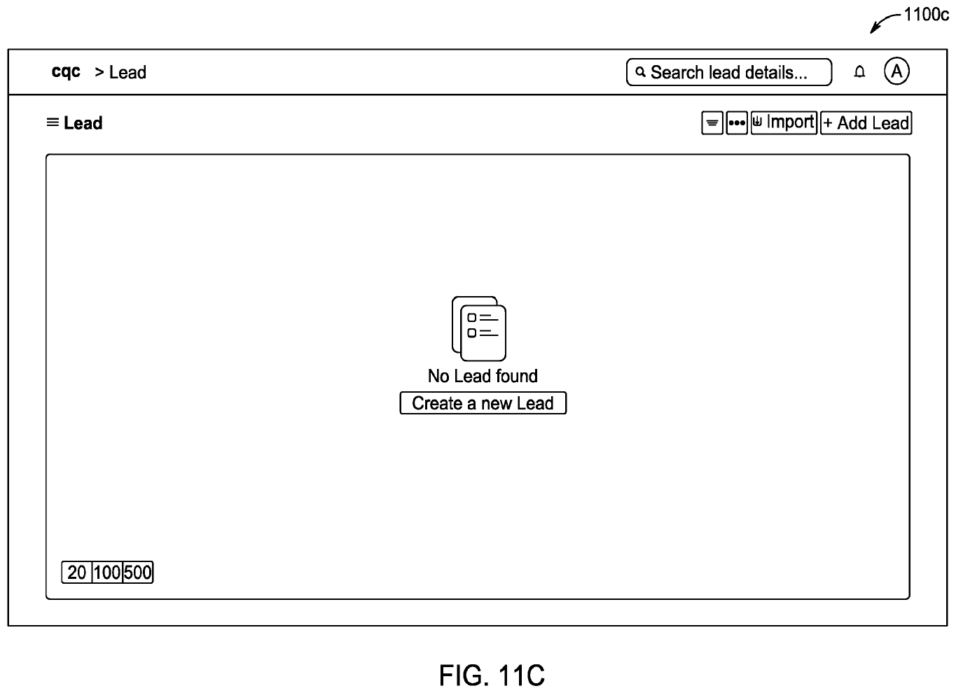

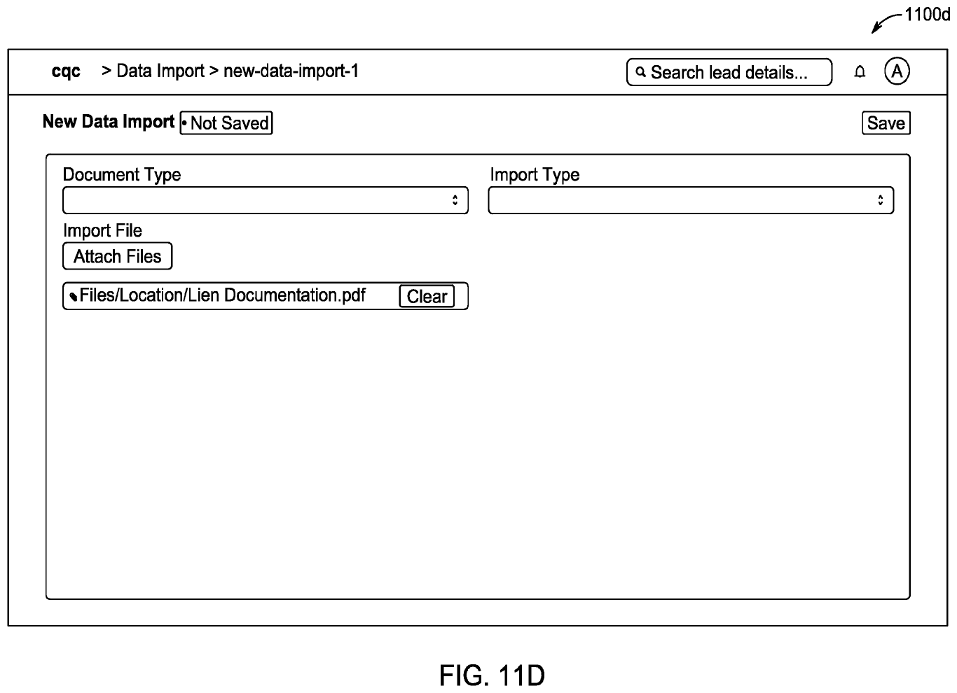

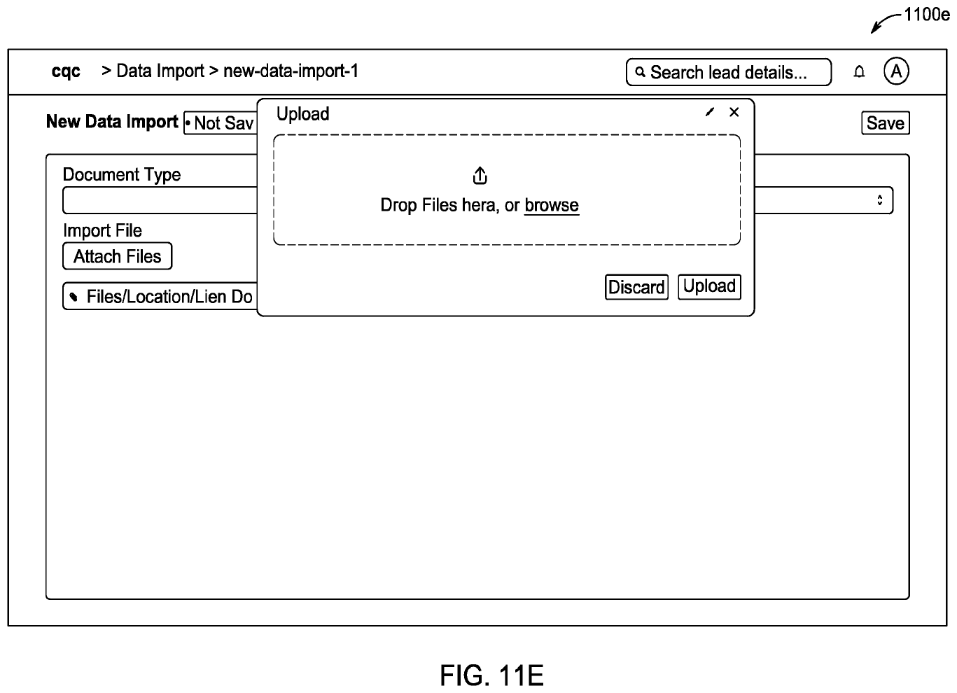

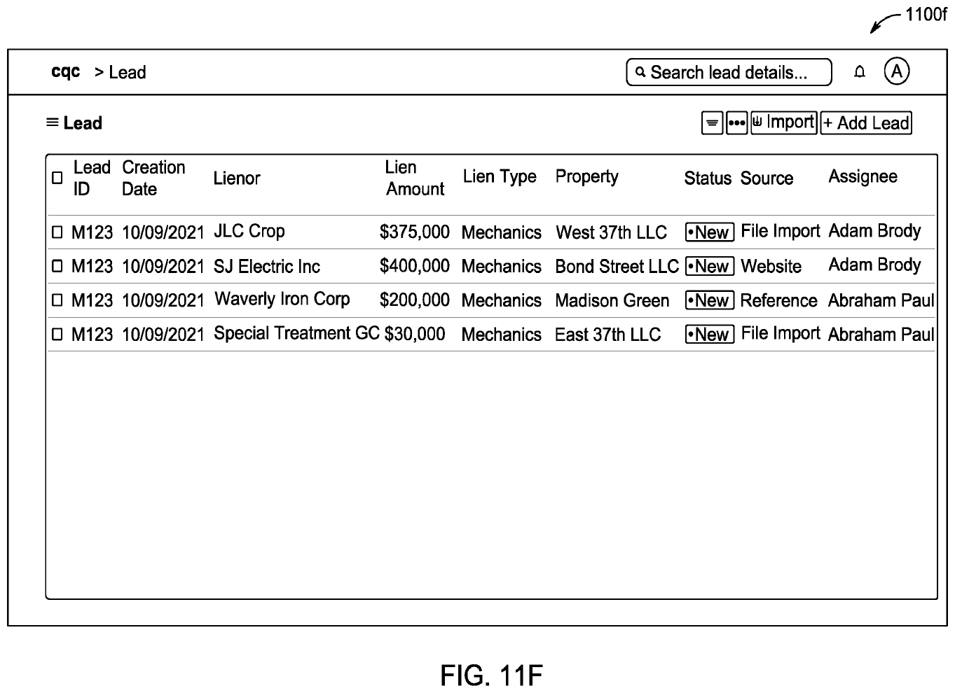

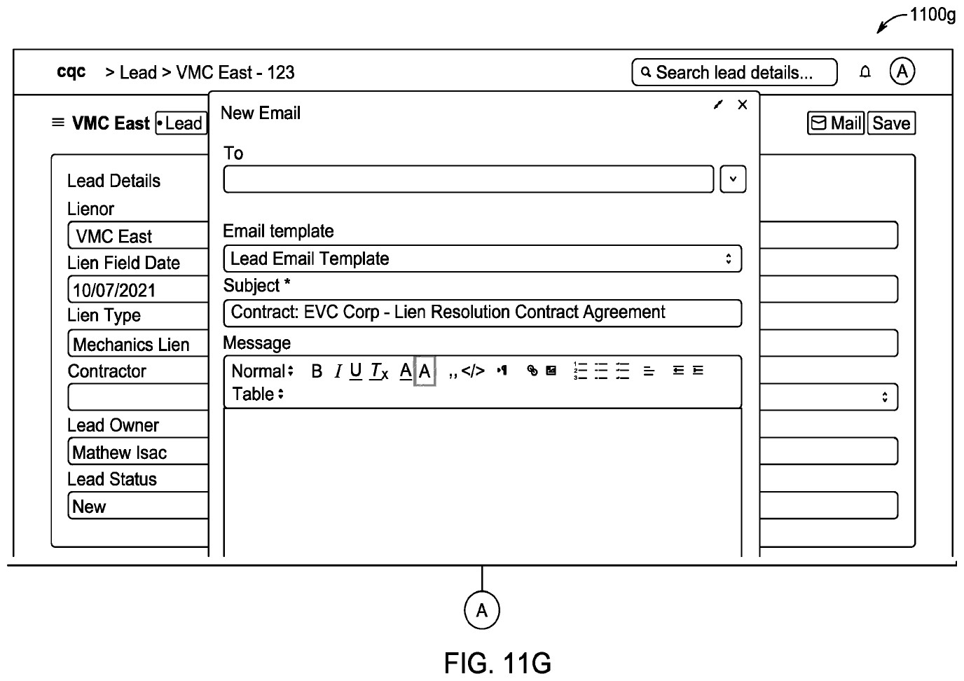

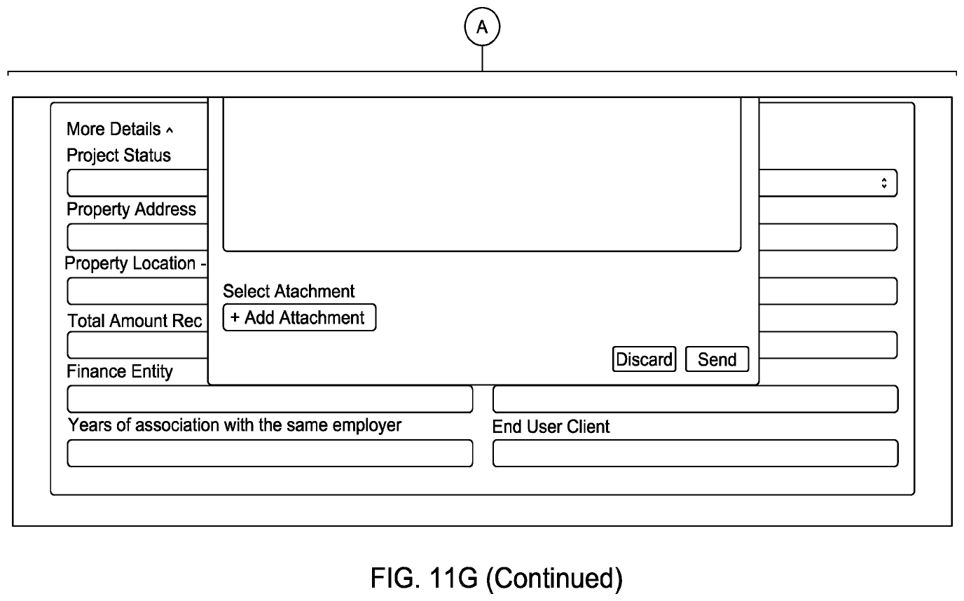

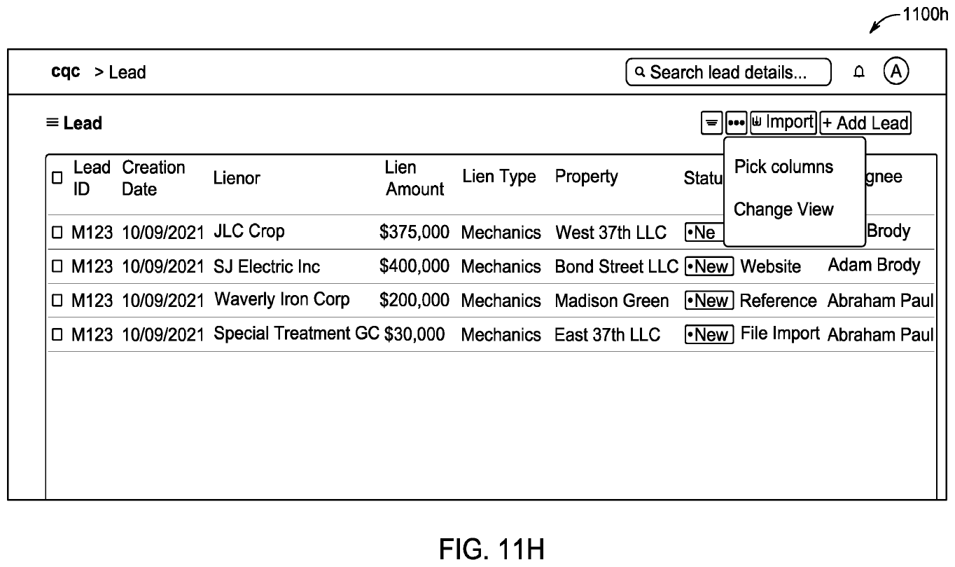

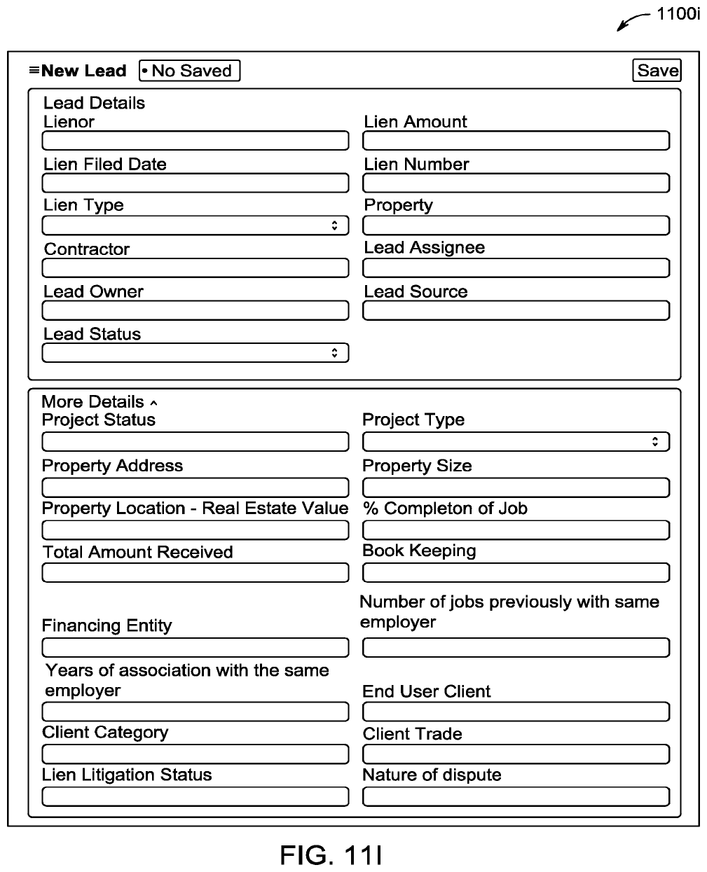

FIGS. 11A-11B illustrate a web application 1100a showing a login page, according to an embodiment of the present disclosure. In an embodiment of the present disclosure, the login page displays options regarding username and password. The username may be any valid email to be filled by a registered user along with a valid password. In one case if the registered user may forget the password, may change the password again by clicking on a “forgot password?” icon. In other case, as shown in a web application 1100b of FIG. 11B, if the user may enter invalid username or password, the invalid login page displays invalid login and asks the user to try again with valid username and password.

FIG. 11C illustrates the web application 1100c showing a lead creation page, according to an embodiment of the present disclosure. In an embodiment of the present disclosure, the lead creation page displays “create a new lead” option.

FIG. 11D illustrates the web application 1100d showing a data import page, according to an embodiment of the present disclosure. In an embodiment of the present disclosure, the new data import page displays options to select document type and import file. In other words, document may be imported by selecting the document type and attaching files.

FIG. 11E illustrates the web application 1100e showing a data uploading page, according to an embodiment of the present disclosure. In an embodiment of the present disclosure, the data uploading page displays “drop files here, or browse” option. In other words, data may be uploaded by dropping or browsing files.

FIG. 11F illustrates the web application 1100f showing a lead dashboard, according to an embodiment of the present disclosure. In an embodiment of the present disclosure, the lead dashboard includes lead ID, lead creation date, Lienor, lien amount, lien type, property details, status, source, assignee, and the like. In an exemplary embodiment of the present disclosure, let's assume the lead dashboard with lead ID: M123, creation date: Oct. 9, 2021, Lienor: JLC Corp, lien amount: $37500, lien type: Mechanics, Property: West 37^{th} LLC, status: New, source: File import, and assignee: Adam Brody. In an embodiment of the present disclosure, the lead dashboard includes import button. In another embodiment of the present disclosure, the lead dashboard includes add lead button. In an embodiment of the present disclosure, the lead dashboard includes search bar to search lead details. Also, the lead dashboard includes notification bell icon.

FIG. 11G illustrates the web application 1100g showing a new email page, according to an embodiment of the present disclosure. In an embodiment of the present disclosure, the new email page includes details regarding, email “To”, email template, subject, and message. Further, the new email page includes “add attachment” button. In an example, email template may be lead email template. In an example, subject may include EVC Corp-lien resolution contract agreement. In an embodiment of the present disclosure, the new email page includes “Discard” and “Send” button.

FIG. 11H illustrates the web application 1100h showing the lead dashboard with one or more options, according to an embodiment of the present disclosure. In an embodiment of the present disclosure, the one or more options include, but may not be limited to, pick columns and change view.

FIG. 11I illustrates the web application showing a new lead filling page 1100i, according to an embodiment of the present disclosure. In an embodiment of the present disclosure, the new lead filling page displays lead details section, more details section, follow up section, notes section, address & contact, and attachments section. The lead details section includes Lienor, lien filed date, lien type, contractor, lead owner, lead status, and the like. The more details section includes project status, project address, property location-real estate value, total amount received, financial entity, years of association with the same employer, client category, lien litigation status, and the like. The follow up section includes option related to “Next contact on”. The notes section includes message template to fill details regarding “Next contact on”.

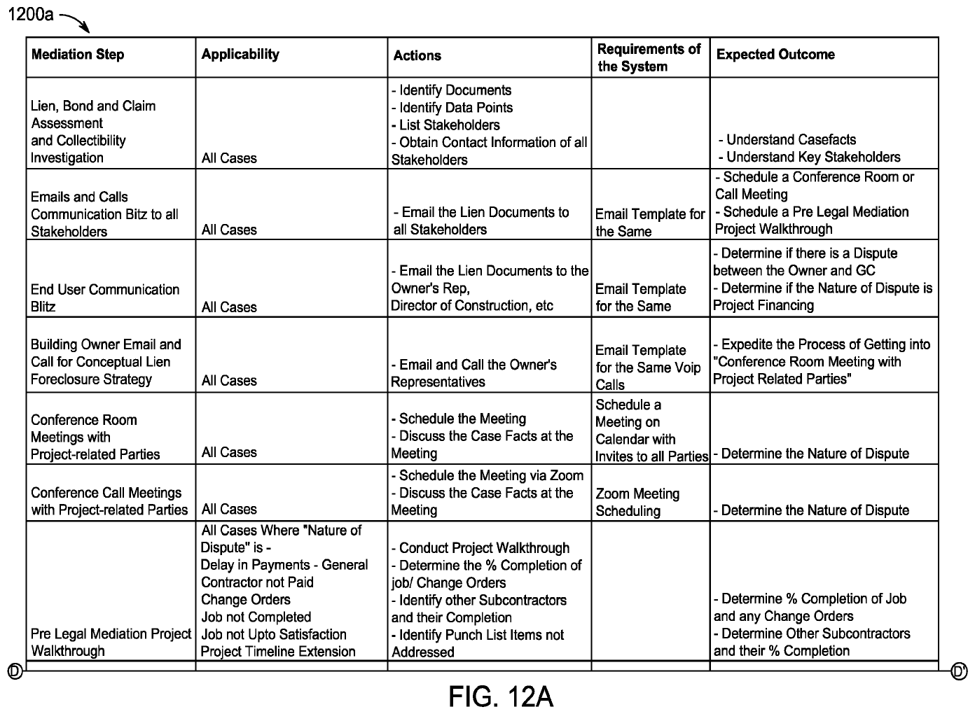

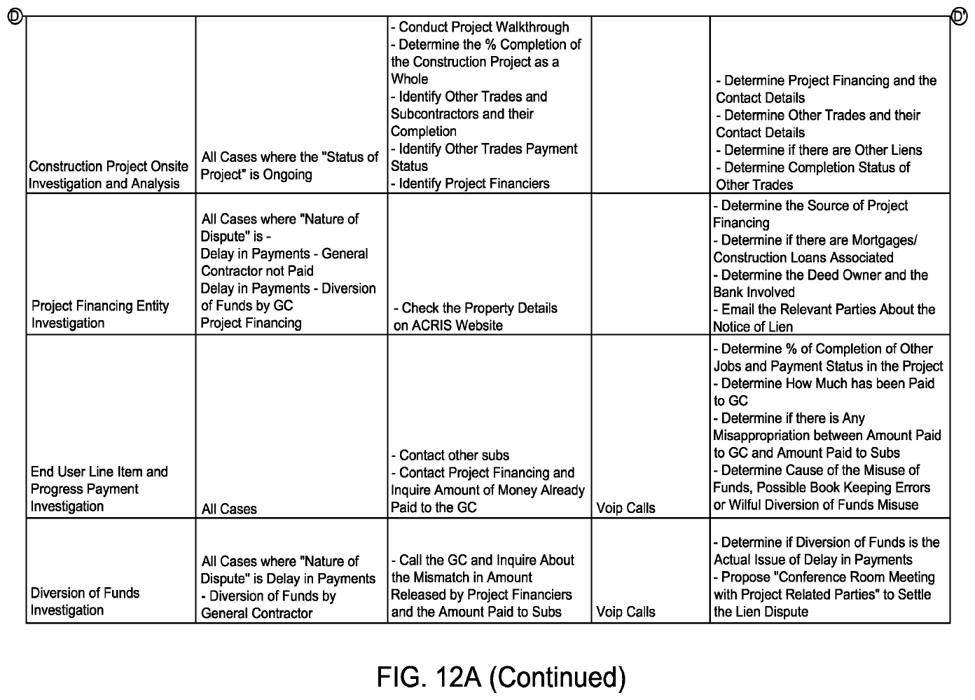

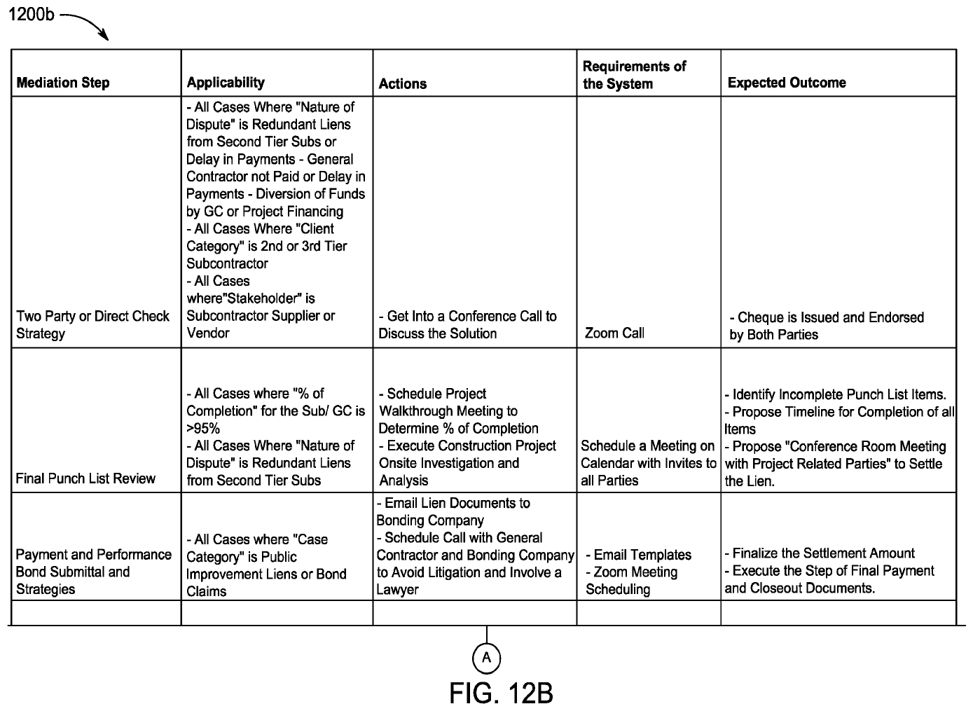

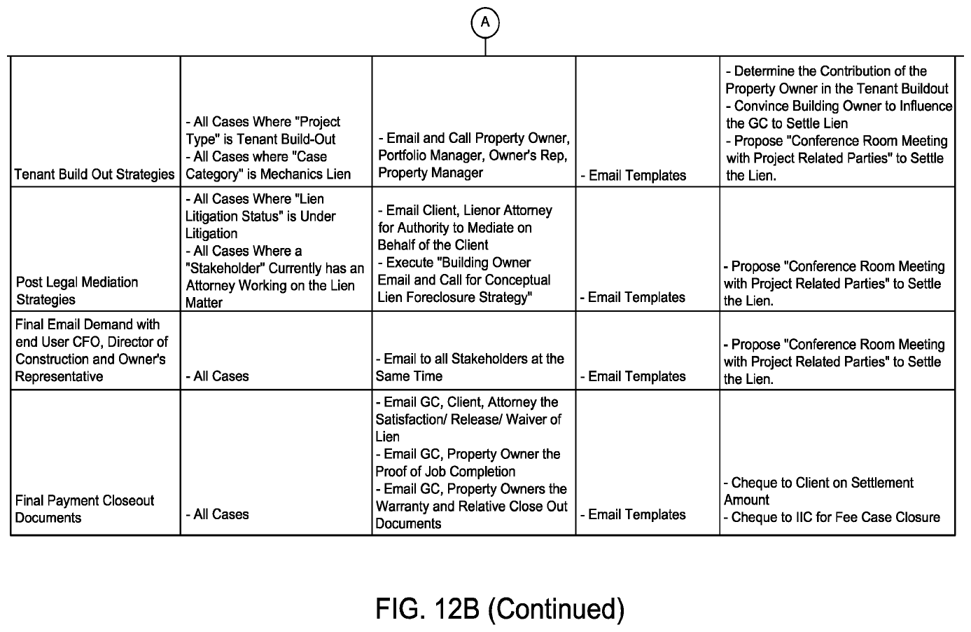

FIGS. 12A and 12B illustrate an exemplary tables 1200a and 1200b showing mediation step analyses, according to an embodiment of the present disclosure. Referring to FIG. 12A, the mediation step analysis facilitates, lien, bond and claim assessment and collectability investigation, in what follows a scenario where documents and datapoints are identified, and list and contact of stakeholders is obtained. As a result of which, it allows a mediator to understand case facts and key stakeholders. The mediation step analysis facilitates the mediator to email the lien documents to all stakeholders, which may result to schedule a conference call meeting, and to schedule a pre legal mediation project walkthrough. The mediation step analysis facilitates the mediator to email lien documents to owner's representatives, director of construction, and the like, which may result to, determine if there is a dispute between the owner and General Contractor (GC), and to determine if a nature of dispute is project financing. The mediation step analysis facilitates the mediator to email and call the owner's representatives, which may result to, expedite a process of having a “conference room meeting with project-related parties”. The mediation step analysis facilitates the mediator to schedule a meeting to discuss case factors at the meeting, which may result to, determine the nature of the dispute. The mediation step analysis facilitates the mediator to perform pre-legal mediation project walkthrough. Further, the pre-legal mediation project walkthrough helps to, determine % completion of job/change orders, identify other subcontractor and their competition, identify other trades payment status, and identify project financiers. The mediation step analysis determines all cases where the status of project is ongoing. The mediation step analysis includes construction project onsite investigation and analysis. In an embodiment of the present disclosure, the construction project onsite investigation and analysis renders to, conduct project walkthrough, determine the % completion of job/change orders, identify other subcontractors and their completion, and identify punch list items not addressed. The mediation step analysis includes project financing entity investigation. The project financing entity investigation renders the mediator to, check property details on ACRIS (Automated City Register Information System) website. The mediation step analysis includes end user line item and progress payment investigation. The end user line item and progress payment investigation renders the mediator to, contact other subcontractor, contact project financing, and inquire the amount of money already paid to General Contractor (GC). Further, the end user line item and progress payment investigation helps to, determine the % of completion of other jobs and payment status in the project, determine how much has been paid to General Contractor, determine if there is any misappropriation between the amount paid to General Contractor and amount paid to subcontractor, and determine the cause of misuse of funds, possible book keeping errors or willful diversion of funds misuse. The mediation step analysis includes diversion of funds investigation. In an embodiment of the present disclosure, the diversion of funds investigation renders the mediator to, call General Contractor (GC) and inquire about a mismatch in amount released by project financiers and amount paid to subcontractor. Further, the diversion of funds investigation helps to, determine if diversion of funds is the actual issue of delay in payments, propose the “conference room meeting with project-related parties” to settle the lien dispute.

Referring to FIG. 12B, the mediation step analysis includes two party or direct check strategy. The two party or direct check strategy renders the mediator to, set up conference call to discuss solutions. As a result of which, cheque is issued and endorsed by both parties. The mediation step analysis includes final punch list review. Further, the final punch list review renders the mediator to, schedule project walkthrough meeting to determine percentage of completion, and to execute construction project onsite investigation and analysis. In an embodiment of the present disclosure, the final punch list review helps the mediator to identify incomplete punch list items. In another embodiment of the present disclosure, the final punch list review helps the mediator to propose a timeline for completion of all items. In yet another embodiment of the present disclosure, the final punch list review helps the mediator to propose the “conference room meeting with project-related parties” to settle a lien. The mediation step analysis includes payment and performance bond submittal and strategies, in which, the mediator email lien documents to bonding company and schedule call with General Contractor and bonding company to avoid litigation by involving a lawyer. In an embodiment of the present disclosure, the payment and performance bond submittal and strategies help the mediator to finalize the settlement amount. In another embodiment of the present disclosure, the payment and performance bond submittal and strategies help the mediator to execute the step for final payment and closeout documents. The mediation step analysis includes tenant build out strategies, in which, the mediator email and call, property owner, portfolio manager, owner's representative, and property manager. In an embodiment of the present disclosure, the tenant buildout strategies help the mediator to determine contribution of the property owner in the tenant buildout. In another embodiment of the present disclosure, the tenant buildout strategies help the mediator to propose the “conference room meeting with project-related parties” to settle the lien. The mediator step analysis includes post legal mediation strategies. Further, the post legal mediation strategies allow the mediator to email client, lienor attorney for authority to mediate on behalf of the client. Furthermore, the post legal mediation strategies allow the mediator to execute “building owner email and call for conceptual lien foreclosure strategy”. In an embodiment of the present disclosure, the post legal mediation strategies help the mediator to propose “conference room meeting with project-related parties” to settle the lien. The mediation step analysis includes final email demand with end user, CFO, Director of Construction, and Owner's Representative. In an embodiment of the present disclosure, the final email demand with end user, CFO, Director of Construction, and Owner's Representative, is achieved by proposing “conference room meeting with project-related parties” to settle the lien. The mediation step analysis includes final payment closeout documents. Further, the final payment closeout documents are sent via email to General Contractor, client, attorney the satisfaction/release/waiver of lien. Furthermore, the final payment closeout documents are sent via Email to General Contractor, property owner for the proof of job completion. Moreover, the final payment closeout documents are sent via email to General Contractor, property owners for the warranty and relative close out documents. As a result of which, the cheque to client on settlement amount is presented.

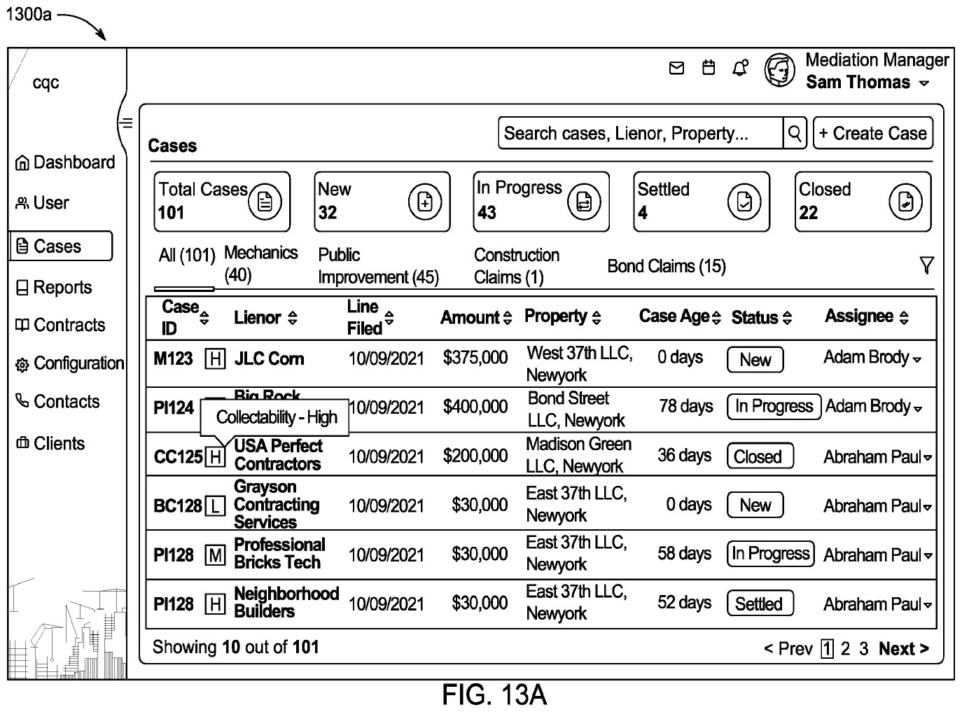

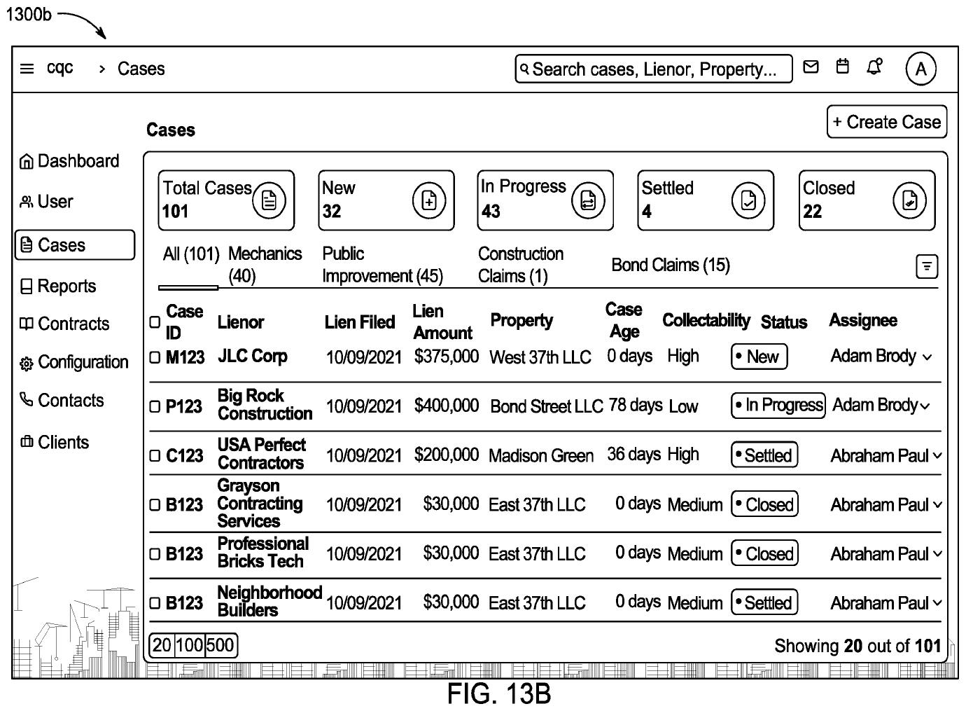

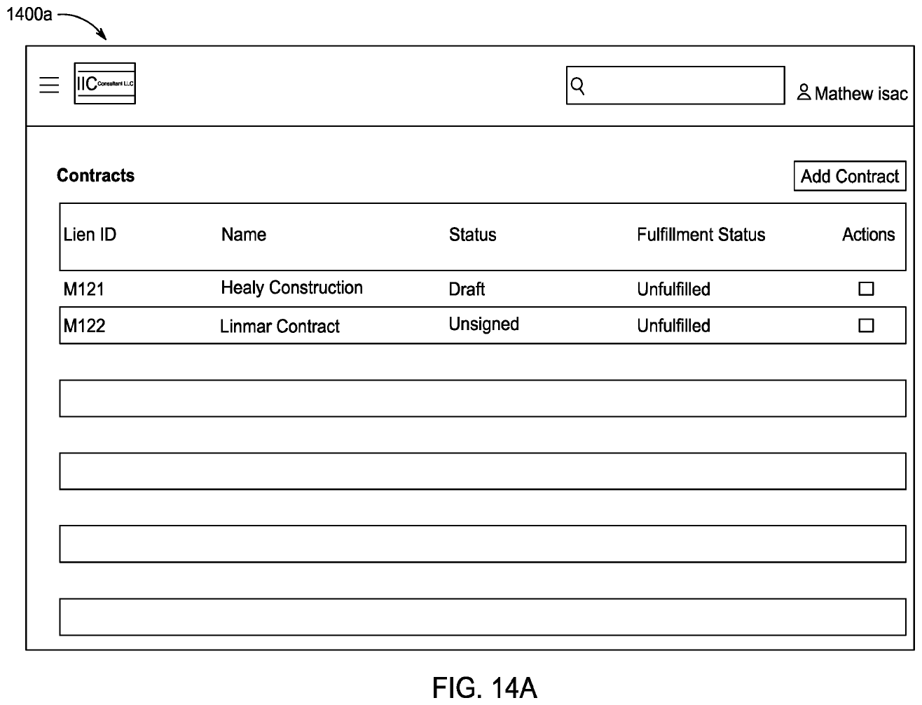

FIG. 13A illustrates a web application page 1300a showing one or more categories for each lien's cases collectability, according to an embodiment of the present disclosure. The web application page 1300a showing the one or more categories for each lien's cases collectability includes, but may be limited to, case ID, Lienor, lien filed date, amount, property, cage age, status, and assignee. Further, the web application page 1300a includes total cases, new cases, in progress, settled cases, and closed cases. Further, in the web application page 1302, case ID is shown with the one or more categories. In an embodiment of the present disclosure, the one or more categories include high (H), medium (M), and low (L).

FIG. 13B illustrates the web application page 1300b showing a detailed view of the lien's cases, according to an embodiment of the present disclosure. The web application page 1300b includes, but may be limited to, case ID, Lienor, lien filed date, amount, property, cage age, status, and assignee. Further, the web application page 1300b includes total cases, new cases, in progress, settled cases, and closed cases.

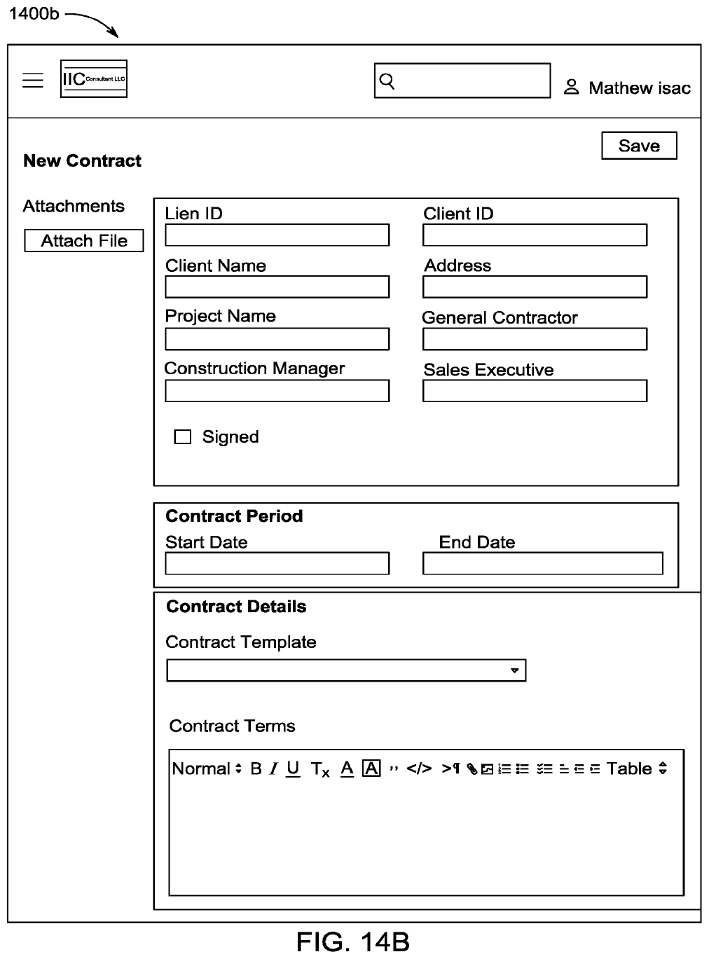

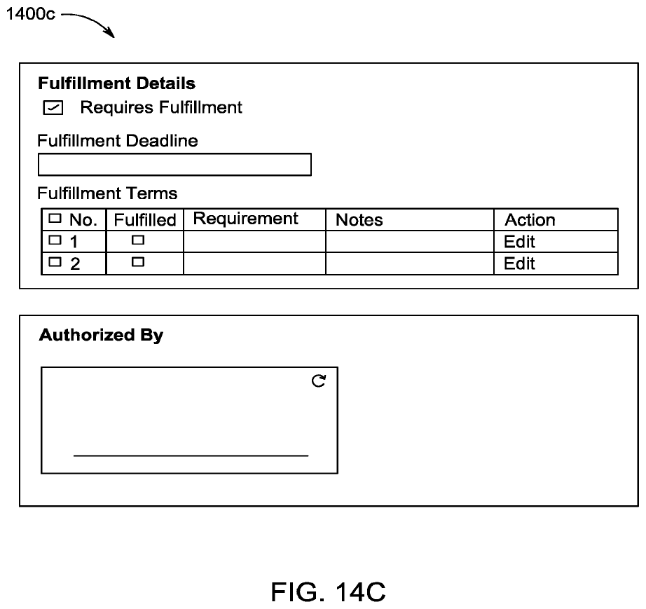

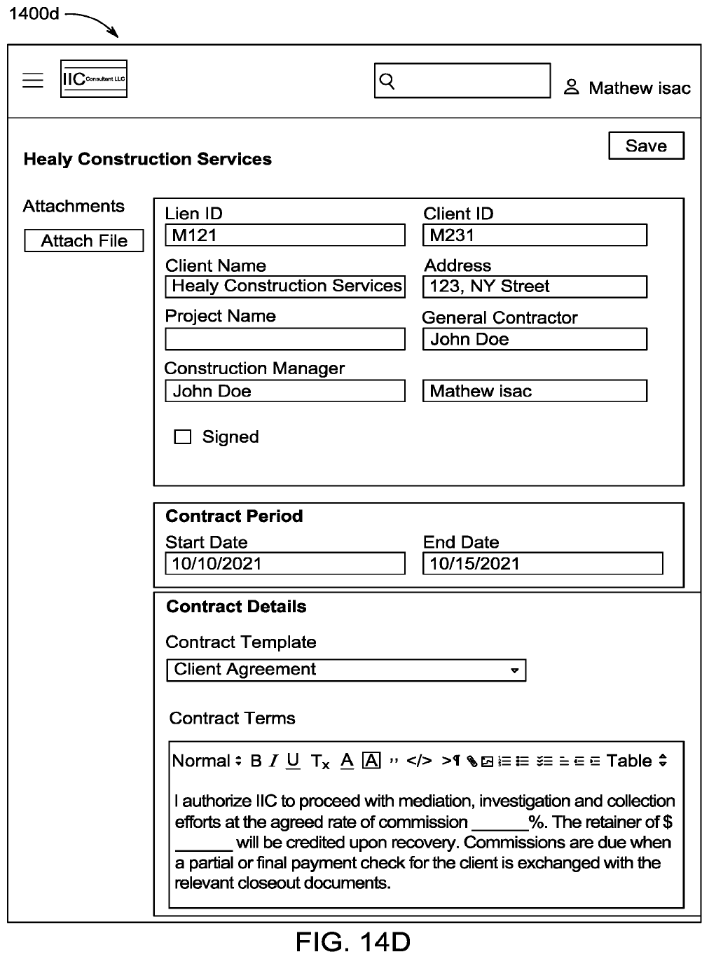

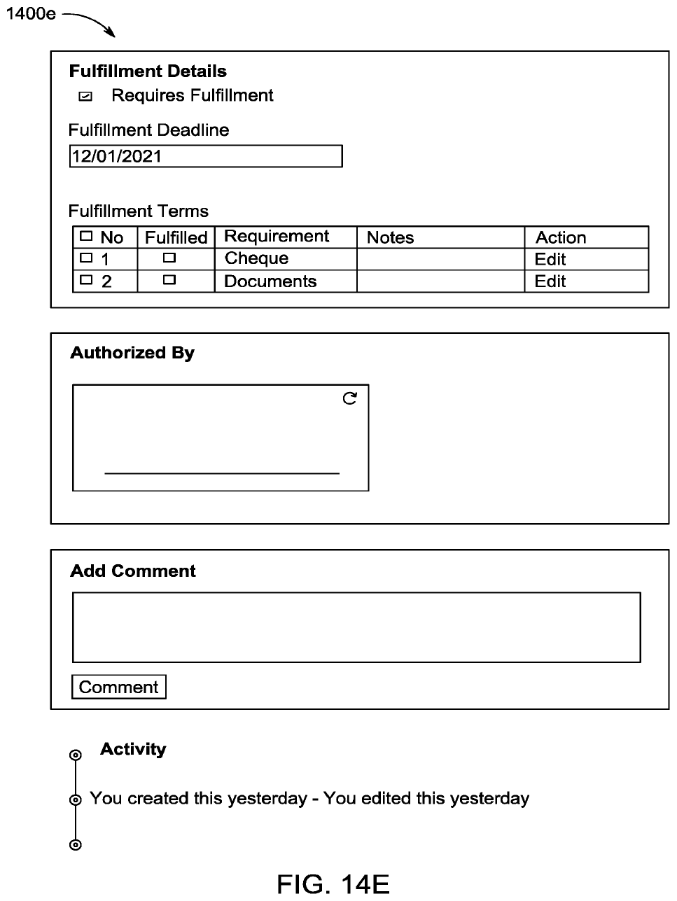

FIG. 14A illustrates contracts management wireframes 1400a showing contracts page, according to an embodiment of the present disclosure. The contract management wireframes 1402 showing contracts page includes lien ID, name, status, fulfillment status, and actions. The contracts page facilitates sale executives to see a list of contracts created in a system. Further, the sales executive may select multiple rows and take actions like edit and delete. The contracts page includes three statuses i.e. draft, signed, and unsigned. When the details of a contract are entered and saved, it gets added to the list as the draft. Further, the contract may only be submitted by a sales manager, and once submitted, further editing is not possible. Furthermore, after submission of the contract, status changes to unsigned. Moreover, the status of the contract changed to signed, when a user checks the signed checkbox in the contracts page.

FIG. 14B illustrates the contracts management wireframes 1400b showing a new contract page, according to an embodiment of the present disclosure. The new contract page includes lien ID, client ID, client name, address, project page, General Contractor, construction manager, sales executive, contract period details, and contract details. The new contract page facilitates the user to add new contract by clicking an add contract button. Further, the user may add details like client name, address, property name, general contractor, and the like. The new contract page includes a checkbox called sign. This checkbox is to be checked, once there is a confirmation that the contract has been signed by client. Also, the user may select contract period. A contract details may be added by selecting a template from a template list dropdown.

FIG. 14C illustrates the contracts management wireframes 1400c showing a fulfillment details page, according to an embodiment of the present disclosure. The fulfillment details page facilitates the user to specify items that have to be mandatorily fulfilled in order to consider the contract fulfilled. Also, the fulfillment details page includes a section for the sales manager to sign the page digitally before submitting.

FIG. 14D illustrates the contracts management wireframes 1400d showing an exemplary contract page, according to an embodiment of the present disclosure. The exemplary contract page shows contract details of heavy construction services. In an embodiment of the present disclosure, the user is redirected to view page upon clicking one of records from the exemplary contract page. Further, all details pertaining to the contracts may be viewed here. Furthermore, the sales executive may edit and save the changes related to the contracts.

FIG. 14E illustrates the contracts management wireframes 1400e showing the fulfillment details page with an add comment section, according to an embodiment of the present disclosure. The fulfillment details page may be checked if requirements are met by a client. In an embodiment of the present disclosure, the sales manager may sign the contract in an “authorized by” section. In an embodiment of the present disclosure, the user may also add comments. In an example, all activities that have happened with the contractors may be recorded in the activities section as shown at the bottom of the FIG. 14E.

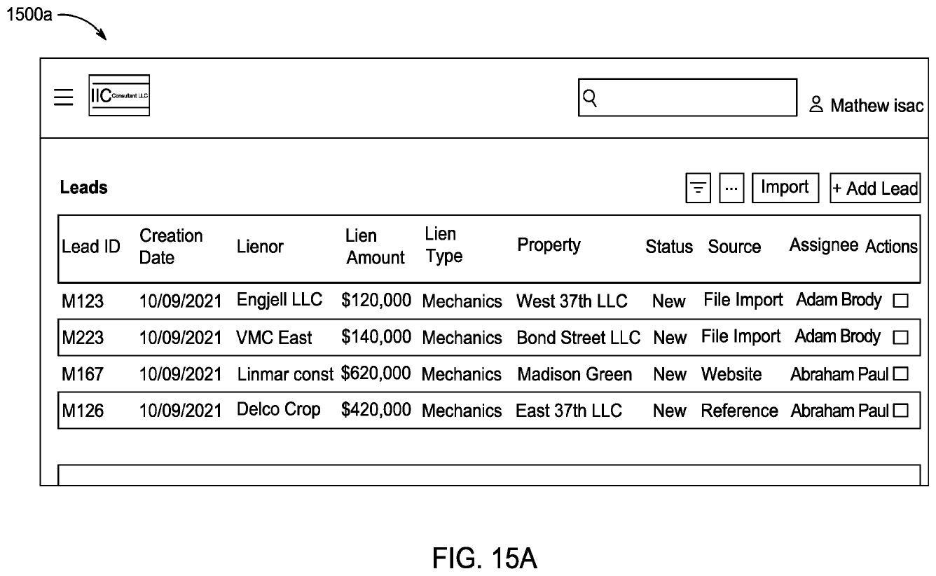

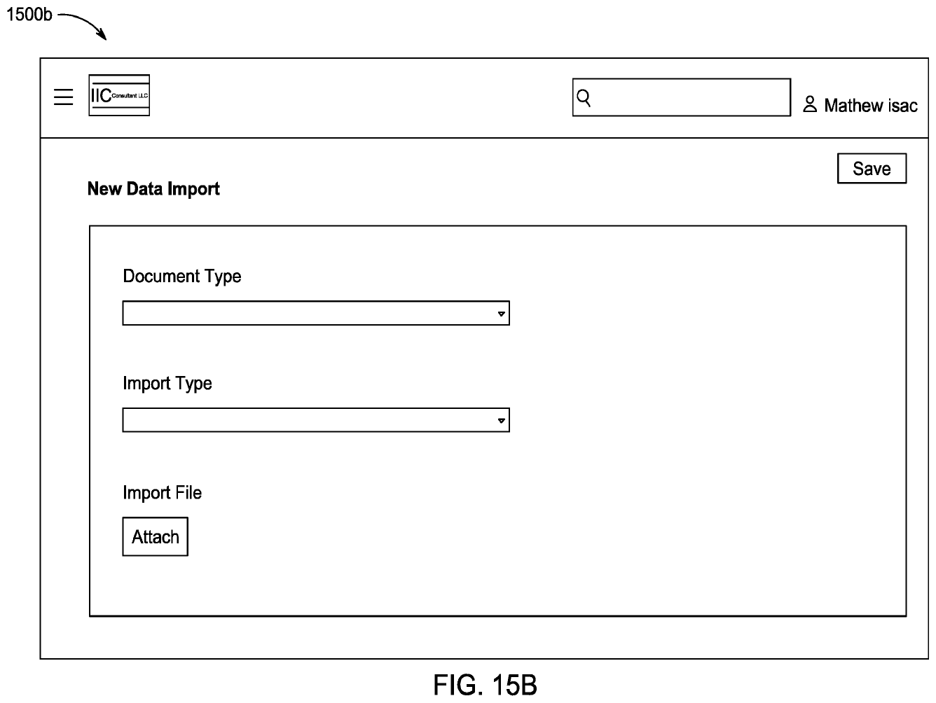

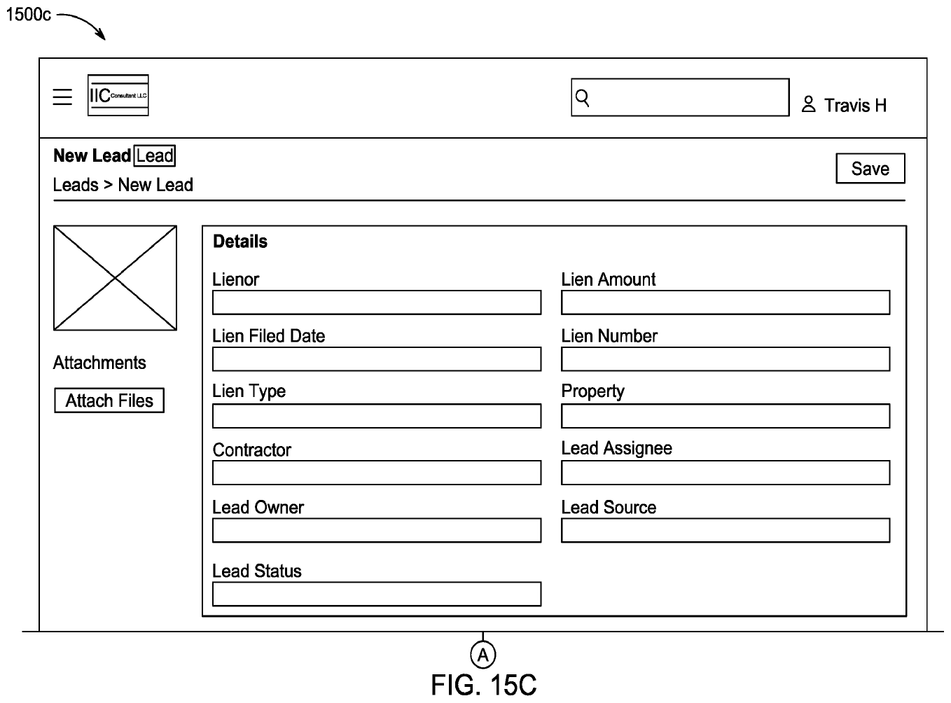

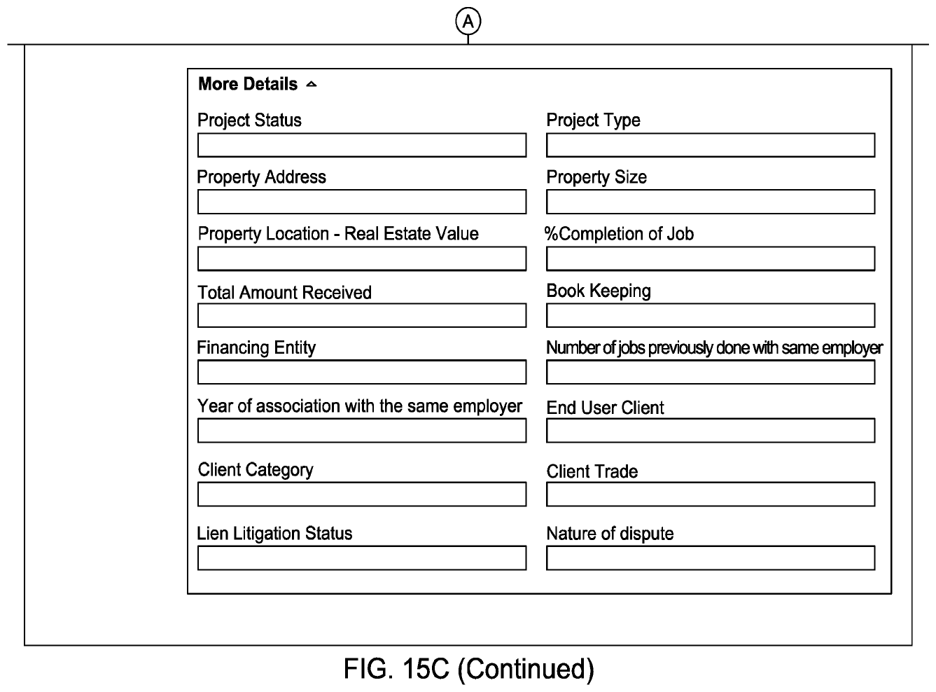

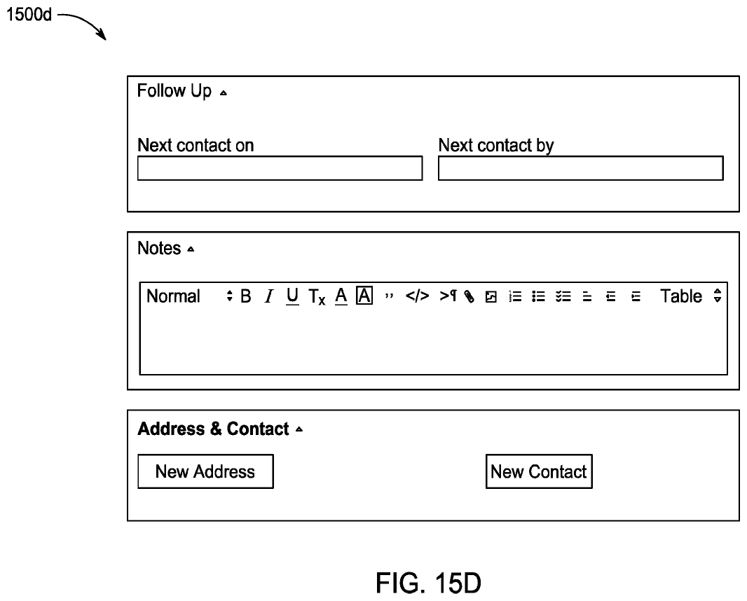

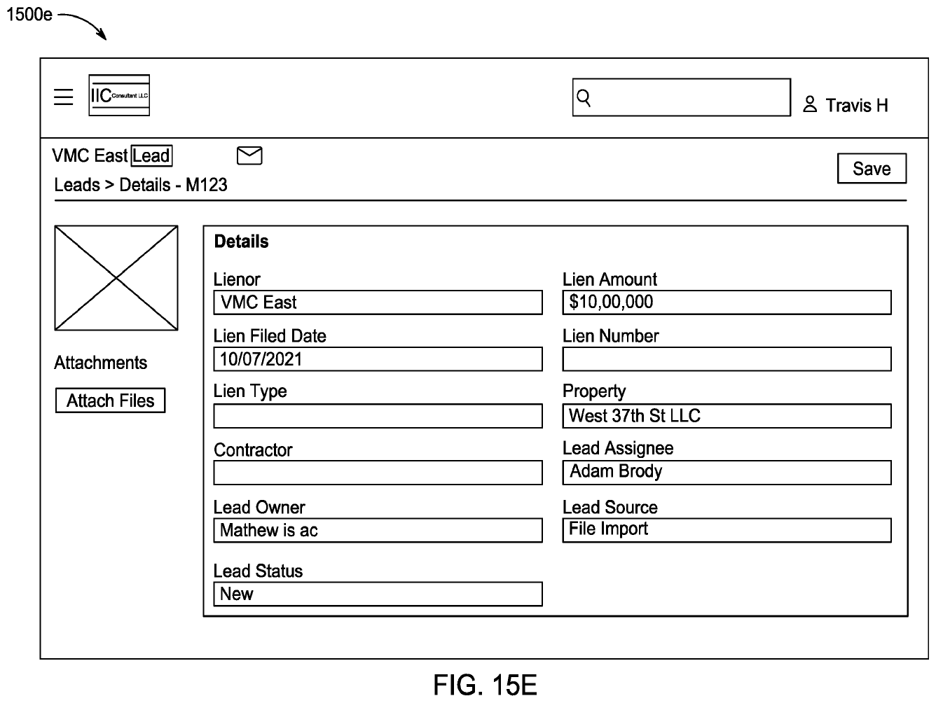

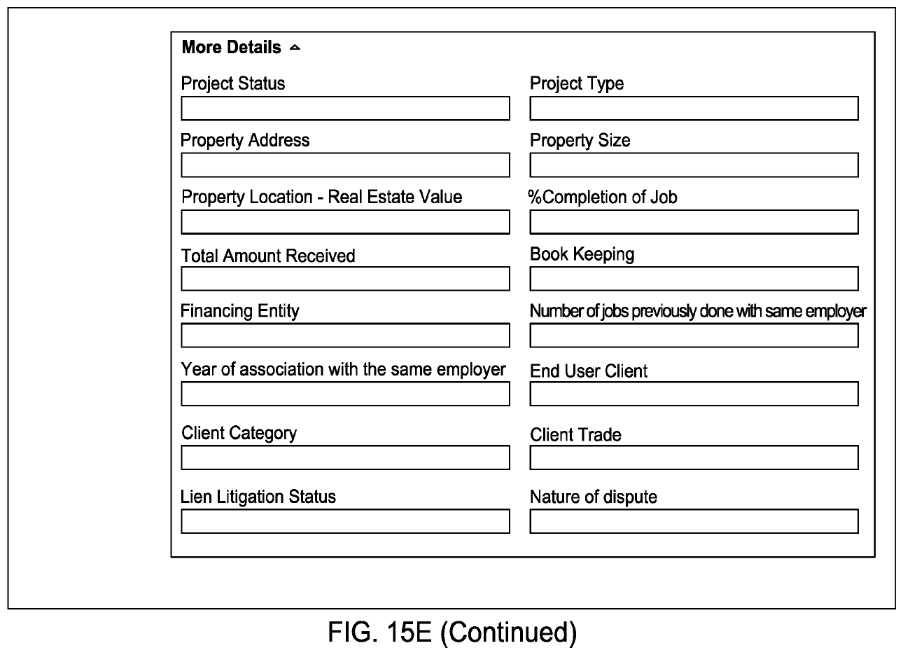

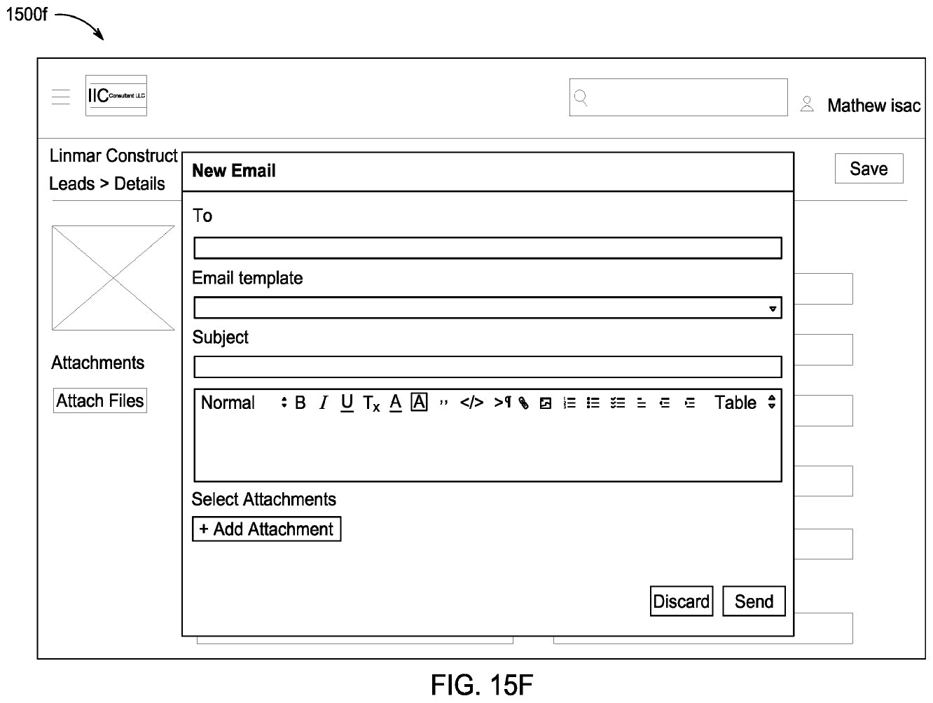

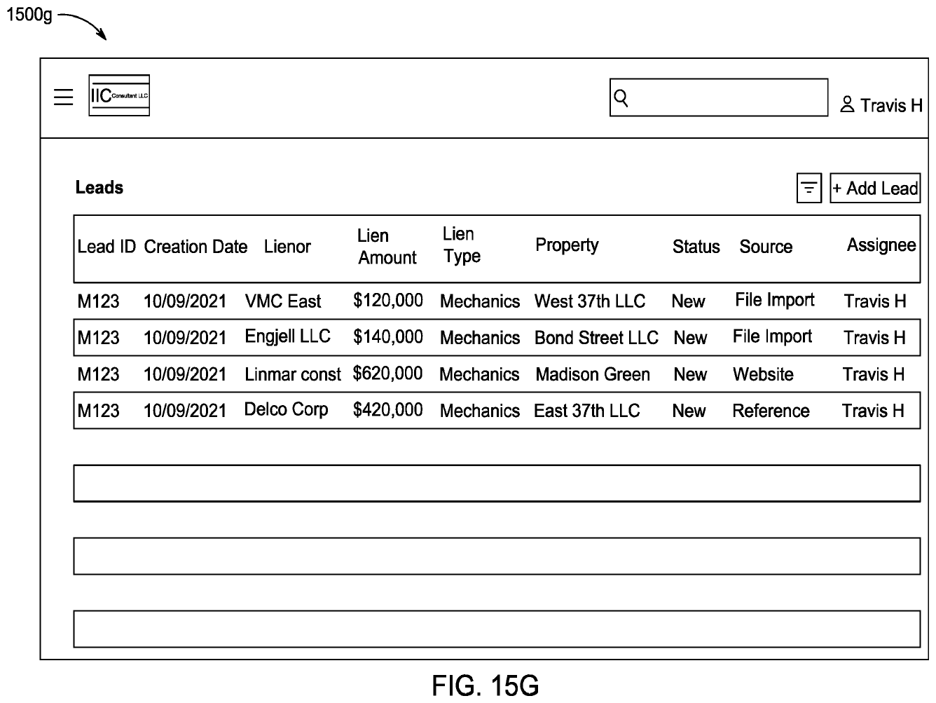

FIG. 15A illustrates leads management wireframes 1500a showing leads page, according to an embodiment of the present disclosure. The leads management wireframes 1500a showing the leads page is a listing page that is displayed to the sales manager after logging into an application. Further, the sales manager is able to import leads from the leads list pdf by clicking on import button. Furthermore, leads that are imported are listed in the leads page as shown in the FIG. 15A. In an embodiment of the present disclosure, the sales manager may also add the leads manually by clicking on an add lead button. Further, the sales manager may select rows and perform actions like bulk edit, delete, etc. Furthermore, when the leads are imported, automatically the leads are assigned to the sales executive.

FIG. 15B illustrates the leads management wireframes 1500b showing a new data import page, according to an embodiment of the present disclosure. The new data import page includes an import button. Further, the import button may navigate to the new data import page where pdf file may be attached. In an embodiment of the present disclosure, the user may select a document type from the dropdown. The document type may be, for example, mechanics lien or public improvement lien. The new data import page includes an import type. The import type specifies whether new records from document are to be added or existing records to be updated. Further, once these two steps are completed, the user may click on an attach button and a pop up comes up where a file to be attached may be selected. After this, on clicking a save button the leads are listed in the listing page.

FIG. 15C illustrates the leads management wireframes 1500c showing a new lead page, according to an embodiment of the present disclosure. The new lead page includes an add leads button. The add leads button allows the sales manager to add new lead. Further, the new lead page includes a first section (details) that contains basic details of the lead. Furthermore, the new lead page includes a section (more details) that has more fields to capture further details related to the lead.

FIG. 15D illustrates the leads management wireframes 1500d showing a follow-up page, according to an embodiment of the present disclosure. The follow up page includes a section to select when a next follow up should happen and by whom. Any leads pertaining to this lead may be entered in a notes section. Further, addresses and contacts may be entered in a section below the notes section.

FIG. 15E illustrates the leads management wireframes 1500e showing lead details page, according to an embodiment of the present disclosure. In an embodiment of the present disclosure, by default, imported data is populated in the lead details page. Further, remaining information is fetched by the sales executive and keyed in accordingly. Upon completion of the lead details page, information is stored as a record in the leads details age, by clicking on save button. Further, the information stored in the lead details page may be later accessed to view details.

FIG. 15F illustrates the leads management wireframes 1500f showing a new email page, according to an embodiment of the present disclosure. In an embodiment of the present disclosure, the user may click on an email icon on top of the lead details page (As shown in FIG. 15F) to send emails to the lead. Further, email template may be selected from dropdown. Furthermore, attachments may be sent along with the email. Additionally, the user may also be able to male calls and schedule zoom meetings from the lead details page which are currently not there in wireframe.

FIG. 15G illustrates the leads management wireframes 1500g showing another leads page, according to an embodiment of the present disclosure. The another leads page allows the sales executive to add and manage leads. Further, the sales executive does not have the ability to import leads. However, import option is available only to the sales manager.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

The detailed description section of the application should state that orders of method steps are not critical. Such recitations would later support arguments that the step order in a method claim is not critical or fixed. Features that are described and/or illustrated with respect to one embodiment may be used in the same way or in a similar way in one or more other embodiments and/or in combination with or instead of the features of the other embodiments.

While the above embodiments have been illustrated and described, as noted above, many changes may be made without departing from the spirit and scope of the example embodiments. For example, aspects of the subject matter disclosed herein may be adopted on alternative operating systems. Accordingly, the scope of the example embodiments is not limited by the disclosure of the embodiment. Instead, the example embodiments should be determined entirely by reference to the claims that follow.

What is claimed is:

1. A system (100) for mediating lien disputes, the system (100) comprising:
a user device (102) communicatively coupled to a server (104) over a cloud (106), wherein the server (104) comprises:
at least one processor (108); and
a memory (110) for storing a set of instructions configuring the at least one processor (108) to:
retrieve user data relating to one or more types of lien cases from the memory (110);
process the user data for identifying and prioritizing the one or more types of lien cases, based at least on one or more case factors; and
process the identified one or more types of lien cases for training machine learning model (112), wherein the machine learning model (112) is trained based at least on training data, the training data comprising one or more inputs and one or more predictive outputs derived from the machine learning model's processing of the one or more inputs; and
determine each lien cases metric of resolution, collectability, and resolution time parameters, using the trained machine learning model (112).

2. The system (100) according to claim 1, wherein the at least one processor (108) is configured to:
determine a nature of lien dispute, wherein the nature of lien dispute includes disputes related to, but not limited to, delay in payments, change orders, job not completed, job un-satisfaction, and project timeline extension;
calculate percentage completion of job changes orders, based at least on the determination of the nature of lien dispute; and
identify completed jobs based at least on the calculated percentage.

3. The system (100) according to claim 1 or 2, wherein the at least one processor (108) is configured to:
identify incomplete punch list items for proposing timeline for completion of all items, based at least on the calculated percentage.

4. The system (100) according to claim 1, wherein the one or more types of lien cases are identified and prioritized by performing a lien collectability assessment using a lien mediation data and a lien collectability data.

5. The system (100) according to any one of the preceding claims, wherein the lien collectability assessment categories each lien case's collectability into a high category, a medium category, and a low category based on the one or more case factors.

6. The system (100) according to any one of the preceding claims, wherein the one or more case factors comprise, a ratio of amount pending to amount received, a percentage of completion of job, a number of jobs previously done with same employer, years of association with the same employer, a project type, a property size, a property owner, a financial entity, end-user client, availability of documentation, and a real estate value of a property location.

7. The system (100) according to any one of the preceding claims, wherein each lien cases metric of resolution, collectability, and resolution time parameters, are determined by the one or more predictive outputs derived by the machine learning model (112).

8. The system (100) according to any one of the preceding claims, wherein each lien cases metric of resolution corresponds to emails to all shareholders and calls, lien bond and claim assessment and collectability investigation, end user communication blitz, building owner email and call for conceptual lien foreclosure strategy, conference room meetings with project related parties, conference call meeting with project related parties, pre-legal mediation project walkthrough, construction project onsite investigation & analysis, project financing entity investigation, end user lien item and progress payment investigation, diversion of funds investigation, diversion of funds investigation, final punch-list review, payment of performance bond submittal and strategies, past legal mediation strategies, final email demand with end user, CFO, director of construction, and owner representative, final payment close out documents, ratio of amount of pending lien balance to the amount received, % of completion of the construction project, % of completion of the construction project, type of construction project, property size, property owner, financing entity, end user client, availability and quality of lien documentation package, and real estate value of the property location.

9. The system (100) according to any one of the preceding claims, wherein the one or more types of lien cases include lien cases such as mechanic's lien, public improvement liens, bond claims, and construction claims.

10. The system (100) according to any one of the preceding claims, wherein the one or more inputs comprise total contract, change order, retention balance of lien amount in relation to the percentage of project completion, end user corporate client data rating, project type, contract start date, and project termination date.

11. The system (100) according to any one of the preceding claims, wherein the one or more predictive outputs comprise calculation of total contract, progress payment received, lien percentage of total contract, percentage of project completed, type of construction lien or claim, contract start date, length (completion date), early termination date, current filed lien status, field lien date, discharge bond filed date, lien law demand filed date, demand letter lien removal date, and lien foreclosure action filed date.

12. The system (100) according to any one of the preceding claims, wherein the one or more predictive outputs are utilized by the machine learning model (112), for creating a case study, a knowledge base summary, predictable sequential steps, an artificial intelligence summary, a machine learning efficiencies summary, and a combinational optimization sequential step summary.

13. The system (100) according to any one of the preceding claims, wherein the machine learning model (112) implements predictable sequential varied non-obvious and unique sequential varied steps during lien resolution process.

14. The system (100) according to any one of the preceding claims, wherein the machine learning model (112) comprises one or more machine learning algorithms based on at least one of support vector machine, K-Means, Neural Networks, Decision Trees, Linear Regression, and Random Forest Regression.

15. The system (100) according to any one of the preceding claims, wherein the at least one processor (108) is configured to perform project financing entity investigation, by checking property details on at least one website.

16. A method (200) for mediating lien disputes, the method (200) comprising:
retrieving user data relating to one or more types of lien cases;
processing the user data for identifying and prioritizing the one or more types of lien cases, based at least on one or more case factors; and
processing the identified one or more types of lien cases for training machine learning model (112), wherein the machine learning model (112) is trained based at least on training data, the training data comprising one or more inputs and one or more predictive outputs derived from the machine learning model's processing of the one or more inputs, and
determining each lien cases metric of resolution, collectability, and resolution time parameters, using the trained machine learning model (112).

17. The method (200) according to claim 1, further comprising:
determining a nature of lien dispute, wherein the nature of lien dispute includes disputes related to, but not limited to, delay in payments, change orders, job not completed, job un-satisfaction, and project timeline extension;
calculating percentage completion of job changes orders, based at least on the determination of the nature of lien dispute; and
identifying completed jobs based at least on the calculated percentage.

18. The method (200) according to claim 16 or 17, further comprising
identifying incomplete punch list items for proposing timeline for completion of all items, based at least on the calculated percentage.

19. The method (200) according to claim 16, wherein the one or more types of lien cases are identified and prioritized by performing a lien collectability assessment using a lien mediation data and a lien collectability data.

20. The method (200) according to any one of the preceding claims, wherein the lien collectability assessment categories each lien case's collectability into a high category, a medium category, and a low category, based at least on the one or more case factors.

21. The method (200) according to any one of the preceding claims, wherein the one or more case factors comprise a ratio of amount pending to amount received, a percentage of completion of job, a number of jobs previously done with same employer, years of association with the same employer, a project type, a property size, a property owner, a financial entity, end-user client, availability of documentation, and a real estate value of a property location.

22. The method (200) according to any one of the preceding claims, wherein each lien cases metric of resolution, collectability, and resolution time parameters are determined by the one or more predictive outputs derived by the machine learning model (112).

23. The method (200) according to any one of the preceding claims, wherein each lien cases metric of resolution corresponds to emails to all shareholders and calls, lien bond and claim assessment and collectability investigation, end user communication blitz, building owner email and call for conceptual lien foreclosure strategy, conference room meetings with project related parties, conference call meeting with project related parties, pre-legal mediation project walkthrough, construction project onsite investigation & analysis, project financing entity investigation, end user lien item and progress payment investigation, diversion of funds investigation, diversion of funds investigation, final punch-list review, payment of performance bond submittal and strategies, past legal mediation strategies, final email demand with end user, CFO, director of construction, and owner representative, final payment close out documents, ratio of amount of pending lien balance to the amount received, % of completion of the construction project, % of completion of the construction project, type of construction project, property size, property owner, financing entity, end user client, availability and quality of lien documentation package, and real estate value of the property location.

24. The method (200) according to any one of the preceding claims, wherein the one or more types of lien cases include lien case such as mechanic's lien, public improvement liens, bond claims, and construction claims.

25. The method (200) according to any one of the preceding claims, wherein the one or more inputs comprise total contract, change order, retention balance of lien amount in relation to the percentage of project completion, end user corporate client data rating, project type, contract start date and project termination date.

26. The method (200) according to any one of the preceding claims, wherein the one or more predictive outputs comprise calculation of total contract, progress payment received, lien percentage of total contract, percentage of project completed, type of construction lien or claim, contract start date, length (completion date), early termination date, current filed lien status, field lien date, discharge bond filed date, lien law demand filed date, demand letter lien removal date, and lien foreclosure action filed date.

27. The method (200) according to any one of the preceding claims, wherein the one or more predictive outputs are utilized by the machine learning model (112), for creating a case study, a knowledge base summary, predictable sequential steps, an artificial intelligence summary, a machine learning efficiencies summary, and a combinational optimization sequential step summary.

28. The method (200) according to any one of the preceding claims, wherein the machine learning model (112) implements predictable sequential varied non-obvious and unique sequential varied steps during lien resolution process.

29. The method (200) according to any one of the preceding claims, wherein the machine learning model (112) comprises one or more machine learning algorithms, based on at least one of support vector machine, K Means, Neural Networks, Decision Trees, Linear Regression, and Random Forest Regression.

30. A non-transitory computer-readable medium including instructions for causing a processor (108) to perform functions including:
retrieving user data relating to one or more types of lien cases;
processing the user data for identifying and prioritizing the one or more types of lien cases, based on one or more case factors; and
processing the identified one or more types of lien cases for training machine learning model (112), wherein the machine learning model (112) is trained based at least on training data, the training data comprising one or more inputs and one or more predictive outputs derived from the machine learning model's processing of the one or more inputs, and
determining each lien cases metric of resolution, collectability, and resolution time parameters, using the trained machine learning model (112).
